(19) United States
(12) Patent Application Publication
(10) Pub. No.: US 2021/0026508 A1
(43) Pub. Date: Jan. 28, 2021

(54) METHOD, DEVICE AND COMPUTER PROGRAM FOR OVERLAYING A GRAPHICAL IMAGE

(71) Applicant: INVENTRANS BVBA, Bilzen Limburg (BE)

(72) Inventor: Lambert JACOBS, Bilzen Limburg (BE)

(21) Appl. No.: 16/650,048

(22) PCT Filed: Sep. 24, 2018
(86) PCT No.: PCT/EP2018/075836

§ 371 Date: Mar. 24, 2020

(30) Foreign Application Priority Data
Sep. 29, 2017 (BE) 2017/5694
Sep. 29, 2017 (BE) 2017/5695
Dec. 4, 2017 (BE) 2017/5891
Dec. 4, 2017 (BE) 2017/5892
Dec. 4, 2017 (BE) 2017/5893
Dec. 4, 2017 (BE) 2017/5895
Jan. 25, 2018 (BE) 2018/5041
Jan. 25, 2018 (BE) 2018/5045
Aug. 7, 2018 (EP) 18187882.8
Sep. 18, 2018 (BE) 2018/5637

(51) Int. Cl. G06F 3/0484; G06F 3/0481; G06F 9/54; G06T 1/20

(52) U.S. Cl. CPC G06F 3/0484; G06T 1/20; G06F 9/543; G06F 3/04812

(57) ABSTRACT

A computer implemented method (referred to herein as “compensated screenshot”) for overlaying a graphical image in a computing device, the method comprising the steps of: a) providing a semi-transparent overlay window having an alpha-transparency value α in the range from 1% to 99%, and comprising a first bitmap; b) taking a screenshot, thereby obtaining a second bitmap; c) calculating a third bitmap so as to compensate the effect of the graphical overlay, based on said first bitmap and said second bitmap and said alpha-transparency value α; d) optionally storing the third bitmap in a non-volatile memory or a storage device; e) optionally copying the third bitmap to a clipboard of the operating system.

### FIELD OF THE INVENTION

The present invention relates in general to the field of graphical overlaying in a computer system. More particularly, the present invention relates to a computer-implemented method of providing a graphical overlay in a computer device or in a display device. The present invention also relates to a computer device configured for performing such a method, and to a computer-program product for carrying out such a method in a computer device or in a display device. The present invention also relates to a portable computing device and to a display device.

### BACKGROUND OF THE INVENTION

FIG. 1 shows a schematic block diagram of a classical computer system 100 comprising a computer device 101 (e.g. a desktop computer), having a keyboard input connected to a keyboard device 102, and a mouse input connected to a mouse device 103, and a video output connected to a display or monitor or screen 104. The computer device 101 comprises a central processing unit CPU running a multi-tasking operating system O/S with a graphical user interface GUI, and one or more software applications such as e.g. a text viewer or a text editor. Input from the keyboard device 102 and mouse device 103 are typically handled by “device drivers” receiving information from one or more input port(s). Such computer systems and application programs are known in the art.

In the specific example of FIG. 1, the computer device 101 generates a graphical image which is rendered on the display 104 as indicated by the rectangular area 109 (shown with rounded corners and slightly offset from the display borders for illustrative purposes). The graphical image 109 of FIG. 1 comprises image portions related to a “desktop window” (visible on the left side of the screen 104), and related to an “application window” showing a text document (visible on the right side of the screen 104).

About two or three decades ago, when the internet was still in its infancy, many people preferred to read (or study) textual information printed on paper rather than directly from screen, which at that time was typically a Cathode Ray Tube (CRT) screen. At that time most information, for example technical information, datasheets, product catalogs, manuals, computer magazines, etc. were distributed primarily in printed form and less information was available in electronic form.

In contrast, nowadays (anno 2017), vast amounts of information are provided or made available in electronic form, and many readers prefer to read directly from a screen, rather than first printing the information on paper and then reading the paper version. This change is likely due to the advent of LCD screens (stable image, high resolution), the growth and speed of the internet, the increasing amount of information that is electronically available, the growing awareness to “save trees” by reducing printing, the availability of tools to manage (e.g. scan, edit, annotate, search) documents electronically, the increasing size of storage devices (e.g. hard disk, memory stick), the ability and speed to search electronically, the trend towards a paper-less office, and the advent of portable devices (like smartphones, tablets, etc.).

Technology has evolved considerably in the last few decades. On the one hand, printing has become easier, and with the advent of laser printers and inkjet printers, printer speed and printer quality have considerably increased (as compared to for example a matrix printer). On the other hand, display quality has also increased considerably, and high-resolution LCD panels (e.g. with 1920×1080 pixels or even 3840×2160 at 60 Hz frame rate) are ubiquitous. Computers have become faster, with multiple processor cores running at high speed (e.g. at 2 GHz), with more RAM (e.g. at least 4 or at least 8 Gigabytes of RAM) allowing multiple applications to run simultaneously.

For portable devices, notably smartphones, the same trend can be seen: high screen resolution (for example 1920×1080 pixels, or 2560×1440 pixels, or 3840×2160 or 4096×2160 pixels are very common), multiple processor cores running at high clock speed (e.g. 1.5 GHz or more), large memory size (e.g. 4 Gbytes of RAM and 32 Gbytes of flash), etc. But printing from these devices is also very easy, e.g. using a wireless connection (e.g. Wi-Fi) rather than cables.

Thus, people still have a choice between “reading on screen” versus “printing and reading on paper”. However, these technological advances may make it more difficult for people to read information on a screen.

While a higher image resolution usually means a sharper image, it also typically means that the font size is smaller, and that more text can be shown on the screen. Smaller letters and more information by itself does not always make it easier to actually “read” that information, and may rather increase the difficulty of reading information.

A first problem encountered when reading textual information on screen, is that many people find it difficult to stay concentrated when required to attentively read (e.g. study) large amounts of text, especially when the text does not contain a lot of formatting (such as bold or underlined characters, titles, different colors, different fonts, blank lines, etc.). This is for example the case when reading or studying published patent documents.

This first problem is recognized in the field, and is for example addressed by a tool known as “LineReader”, which at the time of writing this document is commercially available on the internet. This tool provides a graphical overlay window 483 with a semi-transparent line 310 that follows the mouse pointer 399, as schematically illustrated in FIG. 3. In FIG. 3 the line 310 is colored gray because patent documents still need to be filed in black and white, but in reality the line 310 can for example be colored red or blue, which is more noticeable and easier to distinguish than the native mouse pointer or mouse cursor 399 typically provided by an Operating System (such as e.g. Mac O/S from Apple Inc. headquartered in Cupertino or Windows from Microsoft Corporation, Redmond), especially on high resolution screens. People can use this tool to “underline” textual information they are reading on screen. The line may increase the ability of a user to maintain focus or concentration.

However, as far as is known to the inventors, there is no tool available on the market that makes it easier for a user to find or edit or verify data in a table or worksheet, or to locate a particular cell. Although there have been literally hundreds of millions of people using spreadsheets and worksheets every day for at least two decades, no obvious solution has been found.

Another problem encountered when reading or studying documents on screen, or in general, when spending many hours per day in front of a computer screen, is that many people experience eye strain, especially when reading large amounts of text on a bright background (e.g. when reading black text on a white background). Unfortunately, many programs (e.g. PDF viewers, text editors, etc.) and many webpages provide a bright white background, probably because these programs are designed to display the information in the way it will be printed (like the acronym WYSIWYG meaning “what you see is what you get”). Screens showing images having relatively large portions of black text on a white background transmit relatively large amounts of light energy towards the eyes, which is highly inconvenient to many people. This inconvenience typically increases as people spend more hours in front of a computer screen, as the size of the screen increases, as the distance from the screen decreases, or combinations hereof, and is typically worse in a poorly lit room.

This problem is also recognized in the field, and one of the tools available in the market to address this problem is known as “F.Lux”, which provides a full-screen semi-transparent graphical overlay, schematically illustrated in FIG. 5. This tool can also be used to dynamically change the so called “color temperature” during the course of the day. Relevant for the present invention is that tools like F.Lux can reduce the brightness of the graphical image generated by the computer device, and thereby reduce eye strain. The tool is not ideal however, inter alia because the overlay does not take into account the actual brightness of underlying windows, and/or because a user can no longer take a screenshot without the yellowish color which severely distorts the colors of the original images, and/or because the tool does not allow to underline or highlight textual information.

U.S. Pat. No. 6,333,753, issued Dec. 21, 2005, discloses a technique for implementing an on-demand display widget through controlled fading initiated by user contact with a touch sensitive input device. The document describes a semi-transparent Tool Glass, optionally making use of a graphics accelerator. Fading-in and Fading-out can be achieved by dynamically changing an alpha-transparency value. This document is incorporated herein by reference in its entirety, especially FIG. 8 thereof, together with the corresponding description.

U.S. Pat. No. 5,798,752, issued Aug. 25, 1998, discloses a technique in which a user can move a semi-transparent overlay window containing a so called workpiece with the non-dominant hand, and can move the mouse pointer with the dominant hand.

Many people read books on an eReader-device, but it is difficult to stay concentrated. Some people use their finger to underline the text being read, but when the device is put aside, the location is lost. There is a need for a more practical way to stay focused.

Many professional users make use of websites to find content they are looking for, for example translators searching for the right terminology. A problem with many free websites is that they show advertisements (“ads”), which may be distracting. It would be nice to make use of the websites without being distracted by the ads, and stay focused.

### SUMMARY OF THE INVENTION

It is an object of the present invention to provide a computer implemented method of overlaying a graphical image generated by a computer device with an overlay image.

It is an object of particular embodiments of the present invention to provide an overlay window comprising at least one semi-transparent visual object covering only a minor portion of the underlying graphical image, and being movable in accordance with movements of an input device connected to the computer device.

It is an object of particular embodiments of the present invention to provide such a method, which is particularly suited for assisting a user when reading textual information on a screen.

It is an object of particular embodiments of the present invention to provide such a method, which is particularly suited for assisting a user when extracting information from a table or spreadsheet, or when editing a table or spreadsheet.

It is an object of particular embodiments of the present invention to provide such a method, wherein the overlay image further comprises at least a second semi-transparent object covering a major portion of the underlying graphical image.

It is an object of particular embodiments of the present invention to provide such a method with at least a first and a second semi-transparent object, wherein the second semi-transparent object has a higher transparency than the first semi-transparent object.

It is an object of particular embodiments of the present invention to provide such a method, wherein the transparency of the first, movable object is sufficiently low, so that this object can easily be distinguished from the background, and wherein the transparency of the second object is sufficiently high, so that the underlying textual or alphanumerical information maintains good readability.

It is an object of particular embodiments of the present invention to provide such a method, further comprising at least a third semi-transparent object, which is also movable in accordance with movements of the input device.

It is an object of particular embodiments of the present invention to provide such a method, wherein a substantially monochrome background color of an underlying image is transformed into a background with a texture pattern, preferably without significantly deteriorating the readability of the original textual information, and/or preferably with more aesthetically attractive background.

It is also an object of embodiments of the present invention to provide an overlay application that converts bright images into dark images.

It is also an object of the present invention to provide a computer device adapted for performing said method.

It is also an object of the present invention to provide a computer program product for providing a graphical overlay, which computer program product, when being executed on at least one processing unit of said computer device, performs said method of overlaying.

It is also an object of the present invention to provide a portable computing device providing an overlay image.

It is also an object of the present invention to provide a display device providing an overlay method.

It is also an object of embodiments of the present invention to provide a method of overlaying that adjusts itself dynamically, depending on visual characteristics of underlying windows.

It is an object of particular embodiments of the present invention to provide a method of overlaying for darkening the screen, which dynamically adjusts itself depending on the brightness of the underlying windows.

It is also an object of embodiments of the present invention to provide a method of overlaying that allows a screenshot to be taken of the underlying windows (as if the overlay was not there), but without deactivating the overlay application.

It is also an object of particular embodiments of the present invention to provide a method that allows to prevent ads from being shown to the user.

These and other objectives are accomplished by a method and a computer device and a computer program product and a computer system and a portable computing device and a display device according to embodiments of the present invention.

According to a 1st aspect (with nickname “frozen line”), the present invention also provides a computer implemented method for overlaying a graphical image in a computing device, the method comprising the steps of: a) providing an overlay window; b) providing a first visible object in the form of a vertical line; c) providing a second visible object in the form of a horizontal line segment located either on the left side or the right side of the vertical line; the second visible object being movable in accordance with movements of a pointer device; * repeatedly performing the following steps: d) obtaining position information of a mouse pointer or mouse cursor; e) testing whether the mouse cursor or pointer is located on or over the vertical line, and if the outcome of the test is positive, continue with step f), otherwise continue with step h); f) if the overlay window is not already configured in non-click-through mode, configuring the overlay window in non-click-through mode; g) testing if a mouse button is pressed down, and if the outcome of this test is true, dragging the vertical line; going to step d); h) if the overlay window is not already configured in click-through mode, configuring the overlay window in click-through mode; i) adjusting a position of the horizontal line segment based on said position information of the mouse pointer or mouse cursor.

This embodiment provides a line segment that “freezes” when the mouse cursor is located or moving on the right side of the vertical line, and that “moves along with the mouse cursor” when the mouse cursor is on the left side of the vertical line, or vice versa. Moreover, this embodiment allows to drag the vertical line in a very intuitive way. This embodiment is particularly suitable for translators and proofreaders.

In an embodiment, step i) comprises: testing whether the mouse pointer or mouse cursor is located on the same side of the vertical line as the horizontal line segment, and if the outcome of this test is true, adjusting a vertical position of the horizontal line segment in accordance with a vertical position of the mouse pointer or mouse cursor, and if the outcome of this test is false, maintaining a position of the horizontal line.

In an embodiment, the horizontal line segment comprises a bitmap comprising: * a first plurality of pixels which are fully transparent pixels, and a second plurality of pixels being opaque pixels or semi-transparent pixels; the first plurality of pixels and the second plurality of pixels being interleaved.

In an embodiment, the first plurality of pixels and the second plurality of pixels of the bitmap are organized in a pseudo-random pattern; or the first plurality of pixels and the second plurality of pixels of the bitmap are organized in a regular pattern.

In an embodiment, the first plurality of pixels and the second plurality of pixels of the bitmap are organized in a regular pattern according to one of the following options: i) the regular pattern is a 2×2 pattern, and exactly one out of four pixels is fully transparent; ii) the regular pattern is a 2×2 pattern and exactly two out of four pixels are fully transparent, the two fully transparent pixels preferably being located diagonally opposite each other; iii) the regular pattern is a 2×2 pattern and exactly three out of four pixels are fully transparent.

According to a 2nd aspect (with nickname “perforated bitmap”), the present invention provides a computer implemented method for overlaying a graphical image in a computing device, the method comprising the steps of: a) providing an overlay window; b) providing at least one visible object in said overlay window, the at least one visible object comprising a bitmap having: a first plurality of pixels which are fully transparent pixels, and a second plurality of pixels being opaque pixels or semi-transparent pixels; the first plurality of pixels and the second plurality of pixels being interleaved; c) configuring the overlay window in click-through mode.

The overlay window may be configured as an opaque window, meaning that this window can have non-transparent pixels or fully transparent pixels but not semi-transparent pixels. (The same visual effect would be obtained with a semi-transparent window with an alpha transparency of 100%).

Alternatively, the overlay window may be configured as a semi-transparent window having an alpha-transparency a in the range from 1% to 99% or from 2% to 98% or from 5% to 95%, meaning that his window can have fully transparent pixels or semi-transparent pixels but not opaque pixels.

The bitmap with the fully transparent pixels interleaved with opaque or semi-transparent pixels is referred to herein as a “perforated bitmap” (in analogy with a perforated plate where one can “see through” the openings).

With “graphical image” is meant the image formed by the underlying layers associated with underlying applications. The “graphical image” may comprise or may be composed of a layered stack of partial images, at least some of which being provided by an application window associated with a computer application, such as a text editor, a PDF document viewer, a web browser, a spreadsheet, etc. The lowest image (so called “desktop image”) may be generated by an operating system, the optionally other images of the stack may be generated by applications such as a text-editor, PDF document viewer or editor, a web-browser, a spreadsheet, a drawing program, etc.

Preferably the overlay window extends substantially the entire graphical area, for example (in a Windows environment) it may span the so called “work area”, which is the entire “desktop area” minus the area occupied by a so called “taskbar”.

The concept of “fully transparent pixel” is well known in the art. In practice it is typically implemented by assigning a predefined pseudo color value to these pixels.

The bitmap may contain at least one row and/or at least one column containing at least one fully transparent pixel located between two opaque or between two semi-transparent pixels, preferably at least two rows and at least two columns.

The bitmap may contain at least one row and/or at least one column containing at least one opaque or semi-transparent pixel located between two fully transparent pixels, preferably at least two rows, more preferably each row.

The bitmap may contain at least one row and/or at least one column containing a plurality of odd and even numbered sets of pixels, wherein an odd numbered set is composed of only one or at least one fully transparent pixel, and wherein an even numbered set is composed of only one or at least one opaque or semi-transparent pixel.

In an embodiment, the at least one visible object comprising the bitmap occupies a major portion of the area of the graphical image to be overlaid, for example at least 75%, or at least 80% or at least 85% or at least 90% of the graphical image.

Stated in simple terms, in this embodiment the semi-transparent object may for example form a film layer over the graphical image, which can be used to change the average color and/or the average light intensity of the graphical image.

The at least one visible object may be substantially stationary, in the sense that it does not move in accordance with movements of an input device.

In an embodiment, the method further comprises step d) providing at least a second visible object which is movable in accordance with movements of at least one pointer device, and occupies only a minor portion of the area of the graphical image to be overlaid.

In an embodiment, the at least one visible object comprising the bitmap is movable in accordance with movements of a pointer device and occupies only a minor portion of the area of the graphical image to be overlaid, for example at most 25%, or at most 20%, or at most 15%, or at most 10% or at most 5%.

Stated in simple terms, in this embodiment the semi-transparent object may form a relatively small object, such as a small line, or a large line (extending the full width of the screen), or a small cross, or a large cross (extending full width and full height of the screen), which moves in accordance with movements of a pointer device, for example a mouse device, a trackball, a touchpad, etc. Such an object is ideally suited for highlighting or underlining textual information in a text document, or alphanumerical information in a worksheet.

In an embodiment, the method further comprises the steps of: repeatedly performing the following step: f) obtaining position information (X,Y) related to a position of a mouse pointer or mouse cursor; or obtaining movement information (dx,dy) related to a movement of the at least one pointer device; and repeatedly performing the following step: g) adjusting a position of the at least one object which is movable and/or of the at least one second object which is movable, using said obtained position information or using said movement information.

Configuring the overlay window in click-through mode can for example be implemented (in an MS Windows environment) using one of the following function calls, or equivalent function calls:
SetWindowLong(Handle, GWL_EXSTYLE, WS_EX_TRANSPARENT or WS_EX_LAYERED);
SetWindowLong(Handle,GWL_EXSTYLE,GetWindowLong(Handle,GWL_EXSTYLE) or WS_EX_TRANSPARENT);

As an example, “obtaining position information” may comprise requesting the operating system and GUI what the position of the native mouse cursor is, for example (in an MS Windows environment) using the function GetCursorPos( ).

As an example, “obtaining movement information” may comprise: configuring the O/S to send raw input messages, for example by registering the application with the O/S for receiving raw input data, e.g. in the form of input messages known as WM_INPUT messages, for example using the WinAPI function RegisterRawInputDevices( ). It is noted that by default applications do not receive raw input messages.

Step f) is preferably performed each time a new message arrives. Step g) may be based on a timer, for example having a period in the range from 1 ms to 100 ms, preferably in the range from 1 ms to 60 ms. Thus, step g) need not be performed at the same rate as step f).

In an embodiment, the at least one object which is movable and/or the at least one second object which is movable has an elongated shape, for example a substantially rectangular shape, for example a rectangle with sharp edges, or a rectangle with truncated edges, or a rectangle with rounded edges, or a rectangle with rounded corners. Such a visible object can easily be generated or modified (size and/or color) on the fly, and (by choosing an appropriate height and width) is ideal for underlining text, without distracting a user.

In an embodiment, the at least one second movable object comprises a first movable element having an elongated shape oriented horizontally, and comprises a second movable element having an elongated shape oriented vertically; and wherein step g) comprises adjusting a position of the first movable element and adjusting a position of the second movable element.

Or stated in simple terms: the first movable element and the second movable element form “a cross”. It is an advantage of overlaying with a cross that it can clearly indicate a particular cell in a spreadsheet or table.

In an embodiment, the first movable element extends over an entire width of the overlay window, and the second movable element extends over an entire height of the overlay window.

It is an advantage of overlaying with a cross which spans the entire width and height of the screen, that not only the desired cell is clearly indicated, but also the corresponding row header and column header of the selected cell is clearly indicated.

In an embodiment, the first plurality of pixels and the second plurality of pixels of the bitmap are organized in a pseudo-random pattern.

In an embodiment, the first plurality of pixels and the second plurality of pixels of the bitmap are organized in a regular pattern.

In an embodiment, the first plurality of pixels and the second plurality of pixels of the bitmap are organized in a regular pattern according to one of the following options:
i) the regular pattern is a 2×2 pattern, and exactly one out of four pixels is fully transparent;
ii) the regular pattern is a 2×2 pattern and exactly two out of four pixels are fully transparent, the two fully transparent pixels preferably being located diagonally opposite each other;
iii) the regular pattern is a 2×2 pattern and exactly three out of four pixels are fully transparent.

It is an advantage of using a 2×2 pattern that it is “small” relative to the entire screen size, and that the human eye tends to integrate the color and intensity of the four pixel values. Depending on how many pixels of the pattern are fully transparent (1 or 2 or 3 out of four), the overall intensity (or darkening) can be coarsely adjusted. If the second group of pixels are alpha-blended, both the color of these pixels and the alpha-blending value can be used to fine-tune the overall intensity (or darkening).

In an embodiment, the method further comprises the step of: repeatedly adjusting a position of the object containing the bitmap or of the bitmap such that pixels of the underlying graphical image are overlaid by a fully transparent pixel of the first plurality of pixels at a first moment in time, and are overlaid by an opaque or by a semi-transparent pixel of the second plurality of pixels at a second and optionally third and fourth moment in time.

Preferably the adjustment is made each frame (e.g. at 60 Hz), or every two frames (e.g. at 30 Hz) or every 3 frames (e.g. at 20 Hz), or every 4 frames (e.g. at 15 Hz). The adjustment can for example be as simple as shifting the second object or the entire overlay window with 1 pixel to the right or to the left or up or down. This can be seen as a kind of time-division-multiplex. In an alternative embodiment a second bitmap is provided which is shifted relative to the first bitmap of the object, and the method further comprises overlaying with the first bitmap at a first moment in time, and overlaying with the second bitmap at a second and optionally third and fourth moment in time.

In an embodiment, step b) comprises: providing a bitmap wherein the second group of pixels are extracted or derived from a texture bitmap.

The texture bitmap may be a predefined bitmap or a selectable bitmap, or an alteration thereof.

In the context of the present invention, a “texture bitmap” is preferably a bitmap that does not contain a graphical representation of easy recognizable letters or numbers, but rather contains a regular or irregular or pseudo-random pattern, an example of which is shown in FIG. 27, another example is a picture of a foggy sky.

The texture bitmap may be much smaller than the bitmap of the at least one object in the overlay window, in which case it is repeated and/or tiled and/or mirrored and/or rotated at least once. Extracting pixel values from a smaller texture bitmap offers the advantage of saving memory. Using non-constant values for the second group of pixels can provide a “paper-look” to the user, which is more enjoyable to read than a bright white “plastic-look”.

In an embodiment, the overlay window is configured as a semi-transparent window having an alpha-transparency (α) in the range from 1% to 99% or from 2% to 98% or from 5% to 95%, and the method further comprises the step of: adjusting pixel values of the second plurality of pixels extracted or derived from said texture bitmap, as a function of an alpha-transparency value of the overlay window.

Preferably the adjustment is performed such that a “contrast level” of the texture remains substantially the same, despite variations of the alpha-transparency value.

In an embodiment, the pixel values comprise three color components, for example Red, Green and Blue, and each pixel value is adjusted by using a linear expression of the respective color component itself, and optionally clipping the result of that linear expression to the range from 0 to 255.

As an example, the Red-component can be adjusted according to the following formula, or an equivalent formula: R:=round((R−Ravg)*Fcontrast+newR; clipped to [0 . . . 255], where R is the original red-value of a pixel extracted from the texture bitmap, Fcontrast is a predefined or selectable contrast-factor (a floating point number). This value preferably changes as a second order function (e.g. as the square) of the transparency level T, where T=100%−α, newR is a desired or selected average value for the red-components of the overlay image, which may be different than the average red-value of the stored texture bitmap.

It is an advantage if each component value (e.g. Red) is calculated solely as a function of the original component value (in the example Red) and not of the other component values of that pixel (in the example: Blue and Green), because this saves computation time, and may be implemented by means of a one-dimensional look-up table.

In an embodiment, the graphical image is generated as a layered composition of a desktop image and one or more images associated with said one or more applications; and the semi-transparent overlay window is created by an overlay application.

The at least one processor would typically furthermore be running an operating system (O/S) with a graphical user interface (GUI) providing only a single mouse pointer, and one or more applications selected from the group consisting of: a web browser application, a spreadsheet application, a PDF document viewer, a PDF document editor, a text viewer and a text editor.

According to a 3rd aspect (with nickname “large cross”), the present invention also provides a computer implemented method for overlaying a graphical image in a computing device, the method comprising the steps of: a) providing an overlay window; b) providing at least a first visible object in said overlay window, the first object having an elongated shape, being oriented horizontally, and occupying a minor portion of the overlay window; c) providing at least a second visible object in said overlay window, the second object having an elongated shape, being oriented vertically, and occupying a minor portion of the overlay window; d) configuring the overlay window in click-through mode; repeatedly performing the following step: f) obtaining position information (X,Y) related to a position of a mouse pointer or mouse cursor; or obtaining movement information (dx,dy) related to a movement of the at least one pointer device; and repeatedly performing the following step: g) adjusting a position of the first visible object and adjusting a position of the second visible object based on said obtained position information or using said movement information.

The first and second object together form a “cross”. Such an overlay is particularly useful when extracting data from a table, or when editing a spreadsheet.

In an embodiment, the first object extends over at least 80% of a width of the overlay window; and the second object extends over at least 80% of a height of the overlay window.

Preferably the overlay window extends over substantially the entire screen, or over the entire “work area” of the screen (in the context of a Windows environment this means the entire area minus the area occupied by the “taskbar”).

Preferably the first object has a rectangular shape having a width of at least 80% or at least 85% or at least 90% or at least 95% or equal to 100% of the width of the screen.

Preferably the second object has a rectangular shape having a height of at least 80% or at least 85% or at least 90% or at least 95% or equal to 100% of the height of the screen.

Preferably the height of the horizontal object and the width of the vertical object is the same.

In an embodiment, the method further comprises step b) of: configuring the overlay window as a semi-transparent overlay window having an alpha-transparency in the range from 5% to 95% or from 10% to 90% or from 20% to 80%.

In an alternative embodiment, the method further comprises step b) of: configuring the overlay window as a non-semi-transparent window, also referred to herein as an opaque window.

In an embodiment, the first and second object comprise a monochrome bitmap of pixels.

In an embodiment, the first and second object comprise a bitmap having: a first plurality of pixels which are fully transparent pixels, and a second plurality of pixels being opaque or being semi-transparent pixels to be alpha-blended with pixels of windows underlying the overlay window; the first plurality of pixels and the second plurality of pixels being interleaved.

The first and second plurality of pixels may be arranged in a checkerboard pattern.

According to a 4th aspect (with nickname “texture bitmap”), the present invention also provides a computer implemented method of overlaying a graphical image in a computing device, the method comprising the steps of: a) providing a semi-transparent overlay window having an alpha-transparency in the range from 5% to 95% or from 10% to 90% or from 20% to 80%; b) providing at least one bitmap in said overlay window, the bitmap occupying at least 50% or at least 60% or at least 70% or at least 80% or at least 90% or about equal to 100% of the area of the overlay window, the bitmap containing a texture bitmap; c) configuring the overlay window in click-through mode.

Using a texture bitmap transforms glossy or shiny e.g. plastic-like white background into a matt e.g. paper-like background, which allows to create a nice aesthetic effect, which makes it enjoyable to read a document on screen.

According to an 5th aspect (with nickname “automatic darkening”), the present invention also provides a computer implemented method for overlaying a graphical image in a computing device, the method comprising the steps of: a) providing a semi-transparent overlay window having an alpha-transparency value in the range from 1% to 99% or in the range from 5% to 95% or in the range from 10% to 90%, and comprising a first bitmap; repeatedly performing the following steps: b) taking a screenshot, thereby obtaining a second bitmap; d) determining at least one characteristic of the second bitmap; e) adjusting the alpha-transparency value of the overlay window and/or adjusting one or more pixel values of the first bitmap, based on said at least one determined characteristic.

It is an advantage of this method (where steps b) to e) are executed repeatedly) that the overlay can be “dynamically adjusted” based on actual characteristics of the underlying image(s), rather than merely being based on time-of day and the geographical location where the computing device is located (as seems to be case for F.Lux). This is particularly useful for users experiencing eye strain.

Thanks to this method, users suffering from eye strain need not manually adjust the overlay parameters (for example alpha-transparancy and/or darkness of the overlay bitmap), but this is handled automatically using the actual image content. For example, if the underlying images are bright images (e.g. having a white background as seems to be case for many text-editors or slideshow applications or worksheet applications today), then more darkening may be used, whereas in case the underlying image(s) are less bright (e.g. certain webpages), then less darkening may be used.

The loop may be iterated periodically, for example based on a timer having a period in the range from 0.25 s to 10 s, or in the range from 0.5 s to 5 s, for example equal to about 1 second or about 2 seconds. The smaller this period, the higher the responsiveness of the computing device but the more processing power is required. The higher this period, the slower the system reacts, but the less processing power is required. The skilled person implementing this function can find a suitable compromise. Optionally this period can be selected by a user.

The first bitmap does not consist of only fully-transparent pixels, thus the first bitmap contains at least one semi-transparent pixel, typically about 50% of semi-transparent pixels in case the first bitmap is perforated, or typically about 100% of semi-transparent pixels in case the first bitmap is not perforated.

In an embodiment, the first bitmap is a monochrome bitmap, which may be a perforated monochrome bitmap or a non-perforated monochrome bitmap.

It is an advantage that such a bitmap can be easily generated from a single color value (e.g. having three color components R,G,B).

In a particular embodiment, the first bitmap contains only black pixels, or only gray scale pixels with (R,G,B) values equal to (x,x,x), where x is a value lower than 93, or lower than 65, or lower than 49, or lower than 33, or lower than 17. Such images are ideally suited for “darkening” the screen, without changing the tint.

In other embodiments, the first bitmap contains a monochrome color bitmap with pixels having (R,G,B) values equal to (x,y,z), where each of x,y,z are lower than 93 or lower than 65, or lower than 49, or lower than 33, or lower than 17. Such images are very well suited for “darkening” the screen, while changing the tint.

In another embodiment, the first bitmap contains a color gradient, for example a horizontal color gradient, or a vertical color gradient, or a diagonal color gradient.

The color gradient may be based on only two colors, for example a left and right color, a top and bottom color, an upper left color and a bottom right color. It is an advantage that such a bitmap can be easily generated from only two color values (each having e.g. three color components R,G,B).

In an embodiment, the characteristic is determined using a subsampled image, for example by considering only 1 pixel out of every 2×2=4 pixels, or by considering only 1 pixel out of every 4×4=16 pixels, or by considering only 1 pixel out of every 8×8=64 pixels, or by considering only 1 pixel out of every 16×16=256 pixels. In this way, computation time can be dramatically reduced, while in most cases the effect is largely the same.

In an embodiment, step c) comprises: determining an average intensity and/or a maximum intensity and/or an intensity histogram of the pixels of the second bitmap; and step e) comprises: adjusting the alpha-transparency level such that the average intensity or the maximum intensity or the intensity histogram satisfies a predefined criterium.

The criterium may for example be that the average or maximum intensity should be lower than a certain threshold value. The threshold value may be a predefined value, or may be user-selectable.

It is advantage that in this way, the average or maximum intensity can be forced to be below a certain threshold value.

It is an advantage of this method that only a single value (namely the transparency value) needs to be adjusted, which does not require a high CPU load. The target transparency value that satisfies the predefined criterium may be calculated at once, or may be gradually approached over several iterations. The latter may cause less flickering.

In an embodiment, step c) comprises determining average color component values Ravg, Gavg, Bavg and/or color component histograms of the pixels of the second bitmap; and step e) comprises: adjusting one or more pixel values of the first image (e.g. about 50% of the pixel values in case the bitmap is perforated, or about 100% of the pixel values in case the bitmap is not perforated) such that the average color component or the color component histogram satisfies a predefined criterium.

The target pixel values may be calculated at once, or may be approached gradually. The latter may cause less flickering. It is an advantage of adjusting the pixel values of the first bitmap that there is a lot more flexibility, because for example any of the color component values, or all of the component values may be adjusted.

In an embodiment, the method further comprises step d) of determining a brightness value indicative of a brightness in a room; and the adjustment of step e) further takes into account said brightness value.

In an embodiment, the brightness value may be determined using a light sensor, or using a webcam. It is an advantage of this embodiment that a poorly lit room can be overlaid differently than a bright room, even for the same underlying images.

In an embodiment, step a) further comprises: providing at least one vertical line or bar in said first bitmap for defining at least two regions comprising a first region and a second region; and step c) comprises determining at least a first characteristic of the first region and a second characteristic of the second region; and step e) comprises: adjusting one or more pixel values of the first region such the first characteristic satisfies a first predefined criterium, and adjusting one or more pixel values of the second region, such that the second characteristic satisfies a second criterium.

It is an advantage of this embodiment that it allows the screen to be split in two regions, allowing a first application (e.g. a web-browser) to be located in the first region (e.g. on the left side of the vertical line or bar) and allowing a second application (e.g. a text editor) to be located in the second region (e.g. on the right side of the vertical line). The overlay application would automatically adjust a first characteristic of the first region, (e.g. a first brightness and/or a first color), depending on the graphical information present on the left side of the vertical line, which is mainly based on the web-page being visited, and the overlay application would adjust a second characteristic of the second region, which may be the same or a different characteristic than the first characteristic, e.g. a second brightness and/or a second color, depending on the graphical information present on the right side of the vertical line, which in this example is mainly dependent on the background color of the text editor). In case a relatively dark web-page is visited, while the text document has a bright white background color, the right side of the first bitmap may be assigned darker pixels than the left side of the first bitmap.

Or stated in other words: It is an advantage of this embodiment that the overlay bitmap can be adjusted with several regions, which may be independently darkened. This allows for much more sophisticated screen adjustments, which is especially useful in a multi-tasking environment.

In an embodiment, one of the regions contains fully black pixels with (R,G,B)=(0,0,0), and the other bitmap is monochrome containing gray scale pixels with (R,G,B)=(x,x,x), the value of x being dynamically adjusted. The first and/or the second region may be perforated. Since the first and second region are located in the same overlay window, they have the same alpha-blending value.

In an embodiment the alpha-blending value is predefined (for example about 50% or about 60% or about 70% or about 80%), and the gray-scale of the pixels of the second region is dynamically adjusted, or vice versa, or both the alpha-blending value and the gray scale level x may both be adjusted.

According to an 6th aspect (with nickname “compensated screenshot”), the present invention also provides a computer implemented method for overlaying a graphical image in a computing device, comprising the steps of: a) providing a semi-transparent overlay window having an alpha-transparency value α in the range from 1% to 99%, and comprising a first bitmap; b) taking a screenshot, thereby obtaining a second bitmap; c) calculating a third bitmap for substantially compensating the effect of the graphical overlay, based on said first bitmap and said second bitmap and said alpha-transparency value. With substantially compensating is meant for example that the average difference between the color components of the original image pixels underlying the overlay window and the corresponding color components of the reconstructed image is less than a predefined value (for less than 32 or less than 16 on a scale of 256), but other criteria may also be used, such as RMS distance.

Step b) may be initiated by a button being clicked upon by a mouse pointer, or by a key of the keyboard being pressed.

It is an advantage of this method that it allows to take a realistic screenshot of the underlying windows, as if the overlay was not there, and without de-activating the overlay.

The inventors surprisingly realised that it is possible to calculate back the underlying image, because they realised that the captured image is in fact an alpha-blended image of the stack of underlying images associated with the underlying applications and the bitmap of the overlay window, taking into account the alpha-transparency of the overlay window, both of which are known to the overlay application.

It is an advantage of providing an overlay application with a built-in “print-screen function”, because the overlay application is capable of compensating the alpha-blending due to the semi-transparent overlay. This offers the huge advantage to the user that a screenshot can be taken of the underlying applications without temporarily de-activating the overlay application, thus typically avoiding a light flash which typically occurs when a darkening overlay is temporarily de-activated. This flash may cause temporal blinding and/or eye strain.

In an embodiment, the method further comprises step d) of: storing the third bitmap in a non-volatile memory or in a storage device, optionally after format conversion and/or after image compression.

It is an advantage that the overlay application allows to save the screenshot thus taken to a storage device, for example by a mere click on the button. In preferred embodiments, the third image is stored as a compressed image file, for example as a JPEG-file. The overlay application may allow the user to choose the directory location, and/or the compression ratio. The overlay application may assign an automatically generated filename, for example based on a counter value, or based on time and date. This is all extremely convenient for a user.

Preferably the overlay application also allows the user to choose whether or not the entire screen needs to be captured, or only the work area (thus omitting the taskbar).

In an embodiment, the method further comprises step e) of: copying the third bitmap to a clipboard of an operating system running on said computing device.

This is comparable to the “print-screen” button found on many keyboards, but with the important difference that the image is compensated for the alpha-blending with the overlay bitmap. The bitmap in the clipboard can subsequently be used in manners known per se in the art, for example for being edited in a graphical application (e.g. Paint.Net) or for being pasted in a PowerPoint document, etc.

In an embodiment, step c) comprises making use of the following set of formulas, or an equivalent set of formulas: T=1−α, and R3[x,y]=[R2[x,y]−R1[x,y]*(1−T)]/T, and G3[x,y]=[G2[x,y]−G1[x,y]*(1−T)]/T, and B3[x,y]=[B2[x,y]−B1[x,y]*(1−T)]/T, wherein (R1,G1,B1) are color components of a pixel at a location (x,y) of the first bitmap being overlaid, and wherein (R2,G2,B2) are color components of a pixel at the corresponding location (x,y) of the second bitmap which was taken as the screenshot, and wherein (R1,G1,B1) are color components of a pixel at the corresponding location (x,y) of the third bitmap, and wherein a is the alpha-transparency value, and T is a transparency value.

According to a 7th aspect (with nickname “inverted colors”), the present invention also provides a computer implemented method of overlaying a graphical image in a computing device, the method comprising the steps of: a) providing a semi-transparent overlay window comprising a first bitmap with a plurality of semi-transparent pixels and having a transparency level in the range from 5% to 45%; b) configuring the overlay window in click-through mode; Repeatedly performing the following steps: c) taking a screenshot, thereby obtaining a second bitmap; d) updating the pixel values of the first bitmap, such that the color values of the pixels of the bitmap underlying the overlay window are substantially inverted after being alpha-blended by the overlay window.

In an embodiment, the transparency level T is selected from the group consisting of 4/256, 8/256, 16/256, 32/256 and 64/256.

In an embodiment, the alpha-transparency value α is selected from the group consisting of 252/256, 248/256, 240/256, 224/256 and 192/256.

In an embodiment, step d) comprises: i) estimating the pixel values of the underlying bitmap based on the pixel values of the second bitmap and based on the pixel values of first bitmap; ii) inverting the estimated pixel values, thereby obtaining target pixel values; iii) adjusting the pixel values of the first bitmap based on at least the target pixel values.

In an embodiment, step i) comprises: estimating the pixel values of the bitmap underlying the overlay window based on the following set of formulas or an equivalent set of formulas:

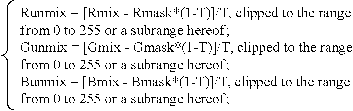

where (Runmix, Gunmix, Bunmix) are the estimated Red, Green and Blue value of the pixels of the underlying bitmap, and (Rmask, Gmax, Bmask) are the Red, Green and Blue value of the pixels of the first bitmap that was applied when taking the screenshot of step e), and wherein T is the transparency level.

In an embodiment, step iii) comprises: calculating the pixel values of the first bitmap as a function of only the target pixel values.

In an embodiment, step iii) comprises: setting the pixel values of the first bitmap based on the following set of formulas or an equivalent set of formulas:

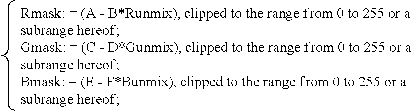

where (Rmask, Gmask, Bmask) are the Red, Green and Blue color component of the pixels of the first bitmap (bmp_mask), and wherein A, B, C, D, E, F are predefined constants.

In an embodiment, A, C and E are integer values in the range from 190 to 255.

In an embodiment, each of the values B, D and F are values in the range from 0.20 to 2.0.

In an embodiment, each of the values B, D and F is selected from the group consisting of 1/2, 3/4, 5/8, 6/8, 7/8, 9/16, 10/16, 11/16, 12/16, 13/16, 14/16, 15/16, and 1.

It is an advantage of this embodiment that the multiplications in the formula can be performed by shift operations and/or addition operations and/or subtraction operations without having to use a multiplication or division operation. For example, “Runmix*7/8” can be implemented as: Runmix−(Runmix shr 3), which may be executed much faster than an actual multiplication or division operation.

In an embodiment, at least one of the values B, D and F is equal to 1, and at least one of the values B, D and F is different from 1.

In an embodiment, each of the values B, D and F is equal to 1.

In an embodiment, step iii) comprises: setting the pixel values of the first bitmap as a function of the target pixel values and the pixel values of the second bitmap, or as a function of the target pixel values and the estimated pixel values of the underlying bitmap.

In an embodiment, the first bitmap occupies more than 80% of the area of the overlay window.

In an embodiment, the first bitmap occupies less than 95%, or less than 90% or less than 80%, or less than 60%, or less than 45%, or less than 40% of the area of the overlay window

In an embodiment, the overlay window further comprises a third bitmap comprising a first plurality of fully transparent pixels and a second plurality of semi-transparent pixels, which are interleaved. It is an advantage of this embodiment that the screen can be substantially darkened, where one part of the screen has inverse colors (e.g. resulting in a black background with bright characters) and another part of the screen is overlaid by a perforated bitmap with about 50% fully transparent pixels (where the colors are darkened, but not inverted). This is extremely helpful to reduce eye-strain, while allowing to easily recognize the real color of a portion of the screen.

In an embodiment, the overlay window further comprises a fourth bitmap consisting of fully transparent pixels.

In an embodiment, the first bitmap occupies substantially the entire area of the window, but in the case of a Windows Operating System running on the computing device, preferably not the windows task bar.

According to an 8th aspect, the present invention provides a computer device, comprising: at least one central processing unit, and a first memory connected to the at least one central processing unit storing computer executable instructions therein; computer executable instructions comprising code fragments for performing an overlay method according to any of the 1st to 7th aspect.

The computer executable instructions may furthermore comprise computer executable instructions configured for generating a graphical image in response to the operating system and/or one or more applications.

The computer executable instructions may furthermore comprise an operating system (O/S) with a graphical user interface (GUI) providing only a single mouse pointer, and one or more applications selected from the group consisting of: a web browser application, a spreadsheet application, a PDF document viewer, a PDF document editor, a text viewer and a text editor.

With computer device is not only meant a personal computer or a desktop computer or a laptop or a tablet computer, but also portable devices, such as a PDA (Personal Digital Assistant) or a smartphone or an eReader device.

In an embodiment, the computer device further comprises a graphics processing unit (GPU) with alpha blending capabilities, and a second memory connected to the graphics processing unit for storing graphical information therein; and wherein the overlay code fragments are configured for making use of the graphical processor for performing at least alpha-blending, and optionally also time-multiplexing.

According to a 9th aspect, the present invention also provides a computer system comprising: a computer device according to the 8th aspect; at least one pointer device connected to the computer device, the pointer device being movable by a user, the computer executable instructions being further configured for receiving input data indicative of movements of the pointer device; at least one display device connected to an output the computer device, for displaying the graphical image mixed with the overlay image.

The pointer device may for example be a mouse device, or a trackball or a touchpad.

Preferably the display device has a screen resolution of at least 1920×1080 pixels, or at least 2560×1440 pixels, or at least least 3840×2160 pixels.

The executable instructions for receiving mouse input data are typically referred to as a “mouse device driver”.

According to a 10th aspect, the present invention is also related to a computer-program product for carrying out a method according to any of the 1st to 7th aspect on a computer device according to the 8th aspect or a computer system according to the 9th aspect.

Or stated in other words, according to the 10th aspect, the present invention also provides a computer program product for providing a graphical overlay, the computer program product containing executable instructions which, when being executed on at least one central processing unit (CPU) of a computer device according the 8th aspect, or a computer system according to the 9th aspect, cause the computer device to perform a method according any of the 1st to 7th aspect.

According to an 11th aspect (with nickname “eReader”), the present invention also provides a portable computing device comprising: a touchscreen; at least one central processing unit, and a first memory connected to the at least one central processing unit storing computer executable instructions therein; the computer executable instructions being configured for generating a graphical image containing textual information and for showing that graphical image on said touchscreen; the computer executable instructions being further configured for generating a line or elongated object (e.g. a rectangular object with sharp or rounded edges or with sharp or rounded corners) overlaying said textual information; wherein the line or elongated object contains a plurality of semi-transparent pixels having a transparency-level in the range from 1% to 99% or from 2% to 98% or from 5% to 95%, or wherein the line or elongated object contains a first plurality of fully transparent pixels and a second plurality of opaque or semi-transparent pixels, which are interleaved; the computer executable instructions being further configured for sensing a contact position on the touchscreen, and for adjusting a position of the line or elongated object in accordance with the sensed position.

The device may for example be an eReader or a smartphone device.

In an embodiment, the first plurality of pixels and the second plurality of pixels of the bitmap are organized in a pseudo-random pattern; or the first plurality of pixels and the second plurality of pixels of the bitmap are organized in a regular pattern.

In an embodiment, the first plurality of pixels and the second plurality of pixels of the bitmap are organized in a regular pattern according to one of the following options: i) the regular pattern is a 2×2 pattern, and exactly one out of four pixels is fully transparent; ii) the regular pattern is a 2×2 pattern and exactly two out of four pixels are fully transparent, the two fully transparent pixels preferably being located diagonally opposite each other; iii) the regular pattern is a 2×2 pattern and exactly three out of four pixels are fully transparent.

According to a 12th aspect, the present invention also provides a display device for rendering a graphical image provided by a computer device, the display device comprising: a display panel for generating a visual image; an input port (e.g. video input port) for receiving said graphical image data from said computer device; an input buffer for storing said graphical image received at the input port, and a texture buffer for storing a texture bitmap, and a frame buffer for storing image data to be shown on said display panel; a processor adapted for generating said image data to be shown on the display panel; wherein the texture bitmap comprises a first plurality of pixels which are fully transparent pixels, and a second plurality of pixels being semi-transparent pixels, preferably with a transparency level from 1% to 99% or from 2% to 98% or from 5% to 95%, the first plurality of pixels and the second plurality of pixels being interleaved; the processor being adapted for generating said image data to be displayed by copying image data from the input buffer in case the corresponding pixel of the texture bitmap is a fully transparent pixel, and by alpha-blending image data from the input buffer in case the corresponding pixel of the texture bitmap is a semi-transparent pixel.

Preferably the display device is an LCD device or an LCD monitor.

In an embodiment, the first plurality of pixels and the second plurality of pixels of the bitmap are organized in a regular pattern according to one of the following options: i) the regular pattern is a 2×2 pattern, and exactly one out of four pixels is fully transparent; ii) the regular pattern is a 2×2 pattern and exactly two out of four pixels are fully transparent, the two fully transparent pixels preferably being located diagonally opposite each other; iii) the regular pattern is a 2×2 pattern and exactly three out of four pixels are fully transparent.

In an embodiment, the processor is further adapted for repeatedly adjusting a position of the texture bitmap such that pixels of the underlying graphical image are overlaid by a fully transparent pixel of the first plurality of pixels at a first moment in time, and are overlaid by a semi-transparent pixel of the second plurality of pixels at a second and optionally third and fourth moment in time.

According to a 13th aspect, the present invention also provides a display device for rendering a graphical image provided by a computer device, the display device comprising: a display panel for generating a visual image; an input port for receiving said graphical image data from said computer device; an input buffer for storing said graphical image received at the input port, and a texture buffer for storing a texture bitmap, and a frame buffer for storing image data to be shown on said display panel; a processor adapted for generating said image data to be shown on the display panel; wherein the processor being adapted for generating said image data as follows: i) at even moments in time copying computer image data from the input buffer at pixel locations for which the sum of the row index and the column index is odd, and by alpha-blending computer image data from the input buffer with corresponding pixel data from the texture bitmap at pixel locations for which the sum of the row index and the column index is even; and ii) at odd moments in time copying computer image data from the input buffer at pixel locations for which the sum of the row index and the column index is even, and by alpha-blending computer image data from the input buffer with corresponding pixel data from the texture bitmap at pixel locations for which the sum of the row index and the column index is odd.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiments described hereinafter.

### BRIEF DESCRIPTION OF THE DRAWINGS

FIG. 1 shows a schematic block diagram of a classical computer system.

FIG. 2 is a schematic representation of a so called “Z-order” of three windows or image planes as may be used in the computer system of FIG. 1.

FIG. 3 shows a schematic block diagram of a computer system similar to that of FIG. 1, when running an operating system and two applications: a text editor and a specific overlay application known in the art as “LineReader”, the latter showing a semi-transparent line over the text editor window, which line can be moved by the user to underline text fragments.

FIG. 4 is a schematic representation of a so called “Z-order” of four windows or image planes as may be used in the computer system of FIG. 3.

FIG. 5 shows a schematic block diagram of a computer system similar to that of FIG. 1, when running an operating system and two applications: a text editor and a specific overlay application known in the art as “F.Lux”, the latter showing a semi-transparent full screen overlay image over the desktop window and the text editor window.

FIG. 6 is a schematic representation of a so called “Z-order” of four windows or image planes as may be used in the computer system of FIG. 5.

FIG. 7 shows a schematic block diagram of an embodiment of a computer system according to the present invention. The computer system of FIG. 7 contains a specific overlay application for implementing a specific overlay method. The overlay application, when running in the computer system of FIG. 7 shows a semi-transparent overlay comprising at least two semi-transparent elements: (i) a horizontal line or bar extending over substantially the entire width of the screen, and (ii) a vertical line or bar extending over substantially the entire height of the screen. The horizontal and vertical line are movable in accordance with movements of the input device.

FIG. 8 is a schematic representation of a “Z-order” of four windows or image planes as may be used in the computer system of FIG. 7.

FIG. 9 shows a schematic block diagram of another computer system according to an embodiment of the present invention. The computer system of FIG. 9 contains a specific overlay application configured for overlaying at least two semi-transparent elements: i) a line, and ii) a so called perforated bitmap. The line is movable in accordance with movements of the input device.

FIG. 10 is a schematic representation of a “Z-order” of four windows or image planes as may be used in the computer system of FIG. 9.

FIG. 11 shows a variant of the computer system of FIG. 9.

FIG. 12 is a schematic representation of a “Z-order” of four windows or image planes as may be used in the computer system of FIG. 11.

FIG. 13 shows a plurality of exemplary screenshots. Each row shows a series of five images corresponding to an alpha-transparency or “alpha blending value” a of 100%, 80%, 60%, 40% and 20% respectively. Each of these images contains a text fragment overlaid by two lines and/or a monochrome bitmap. Two lines are used for illustrative purposes, to illustrate both “highlighting” and “underlining” of text in the same drawing.

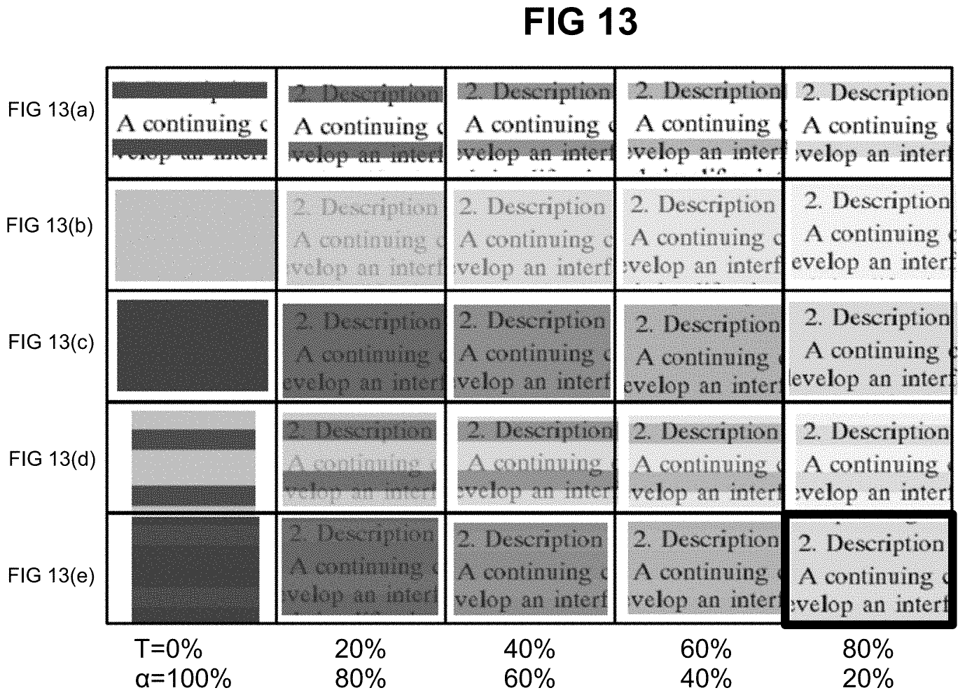

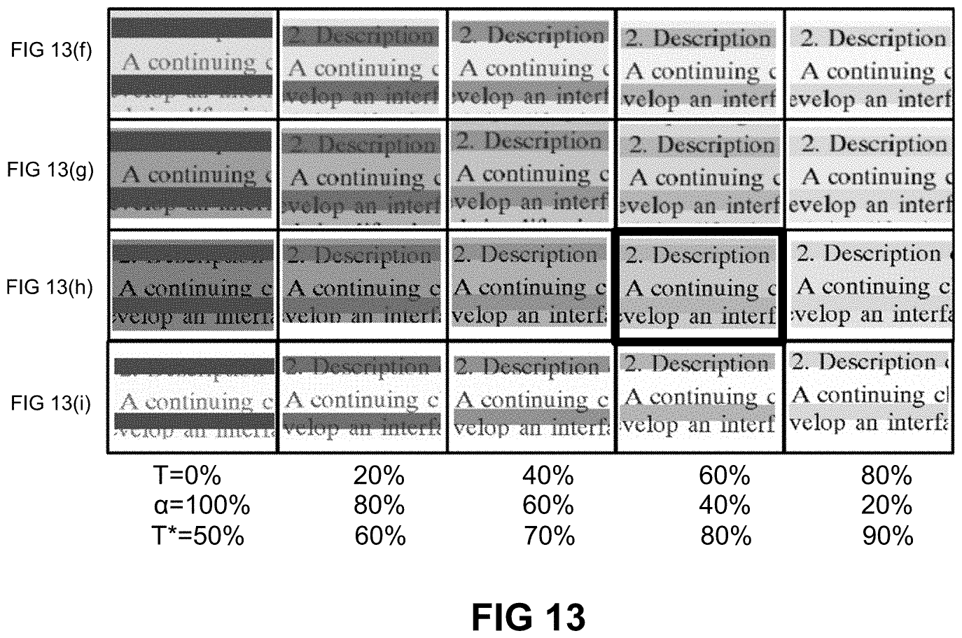

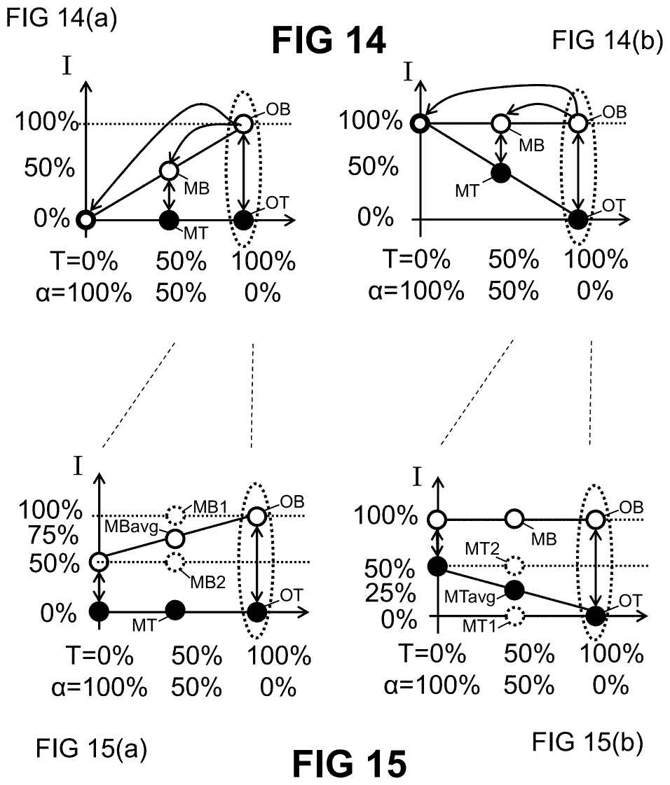

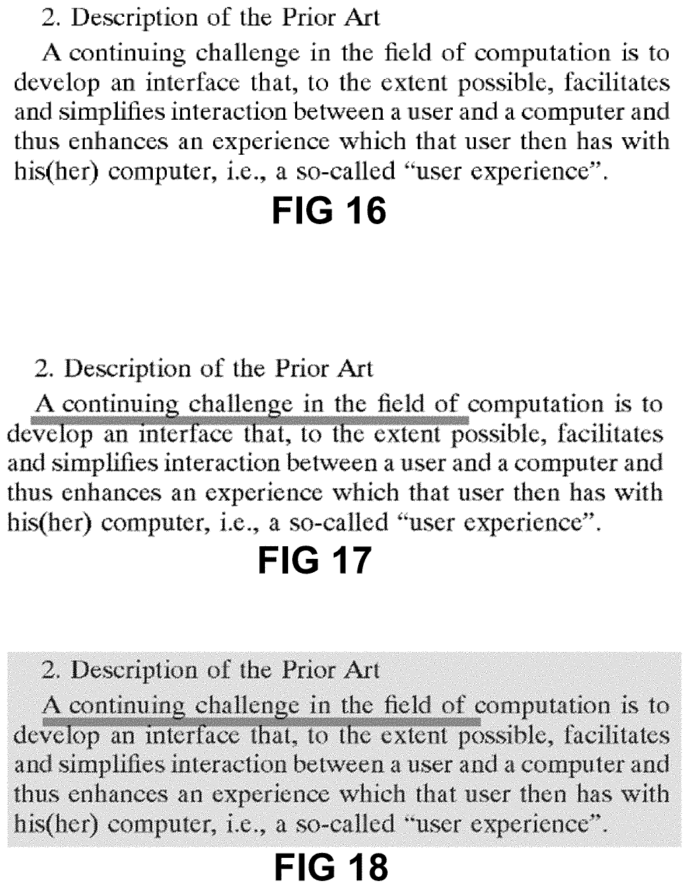

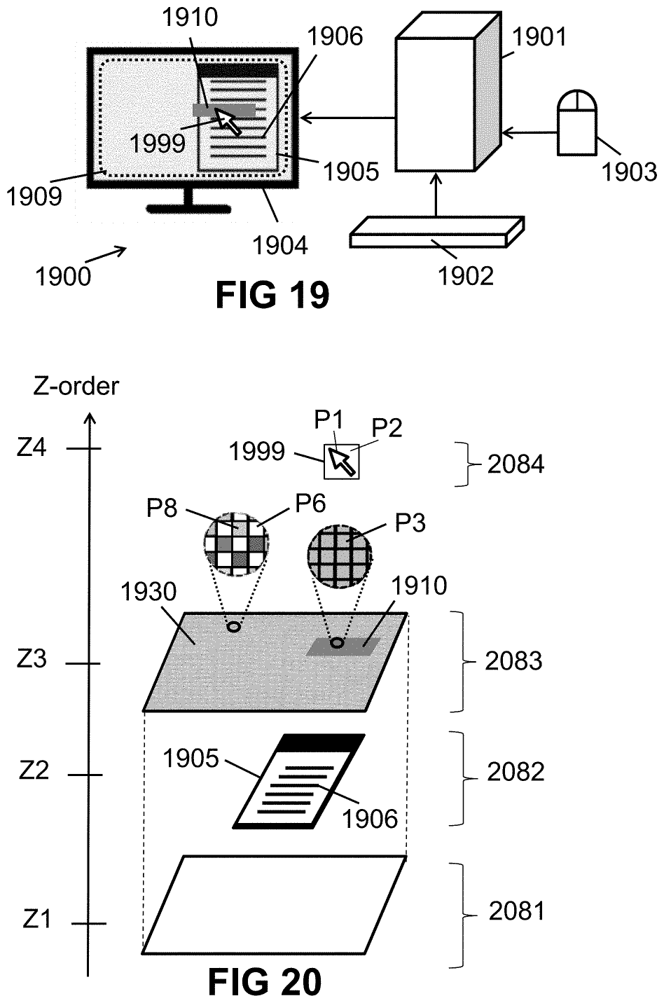

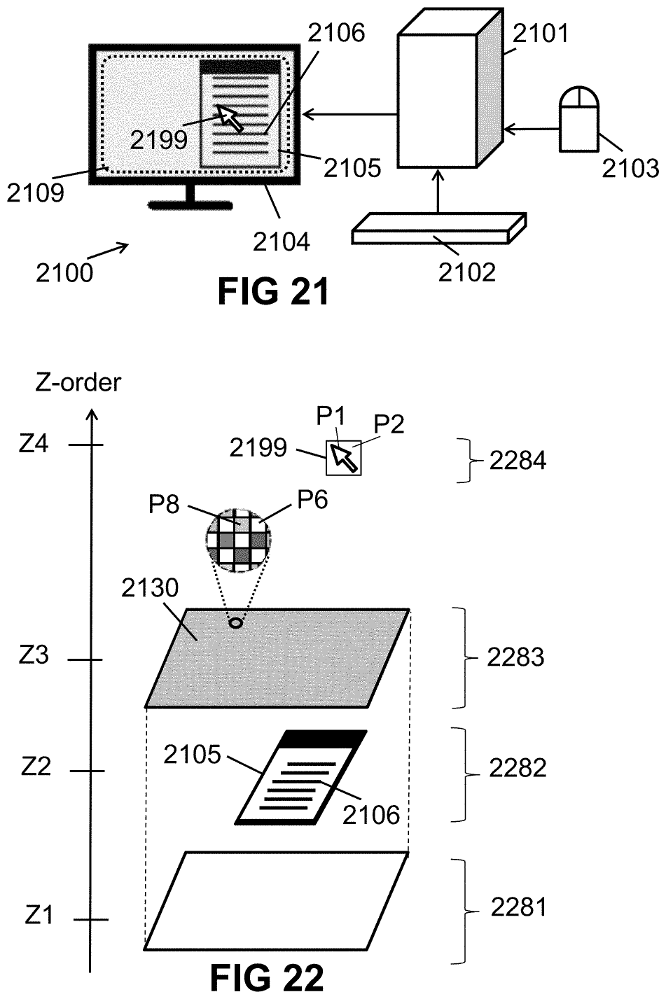

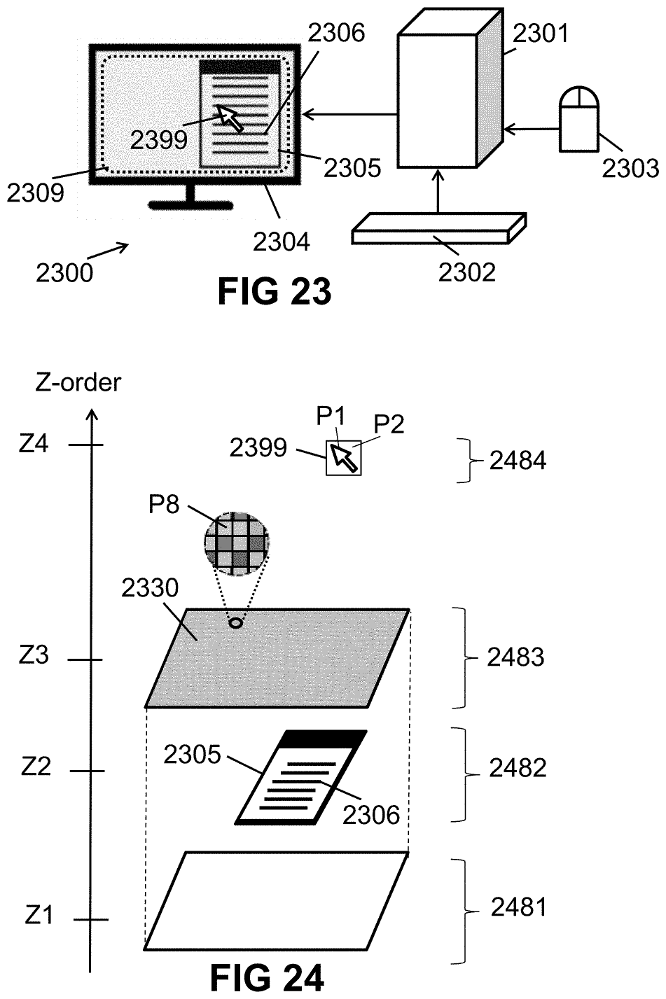

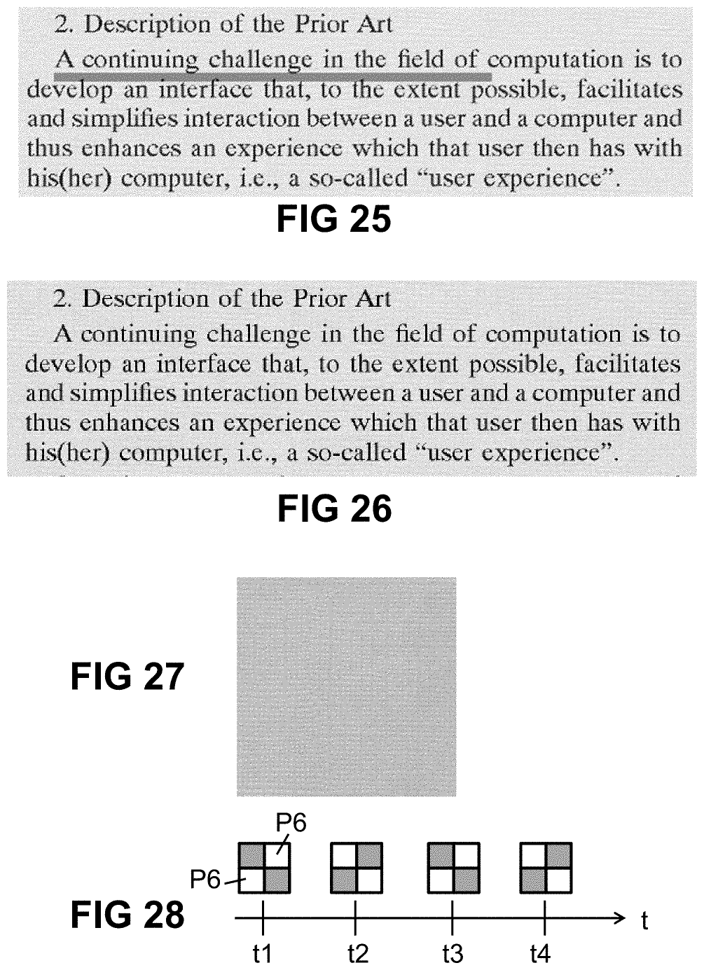

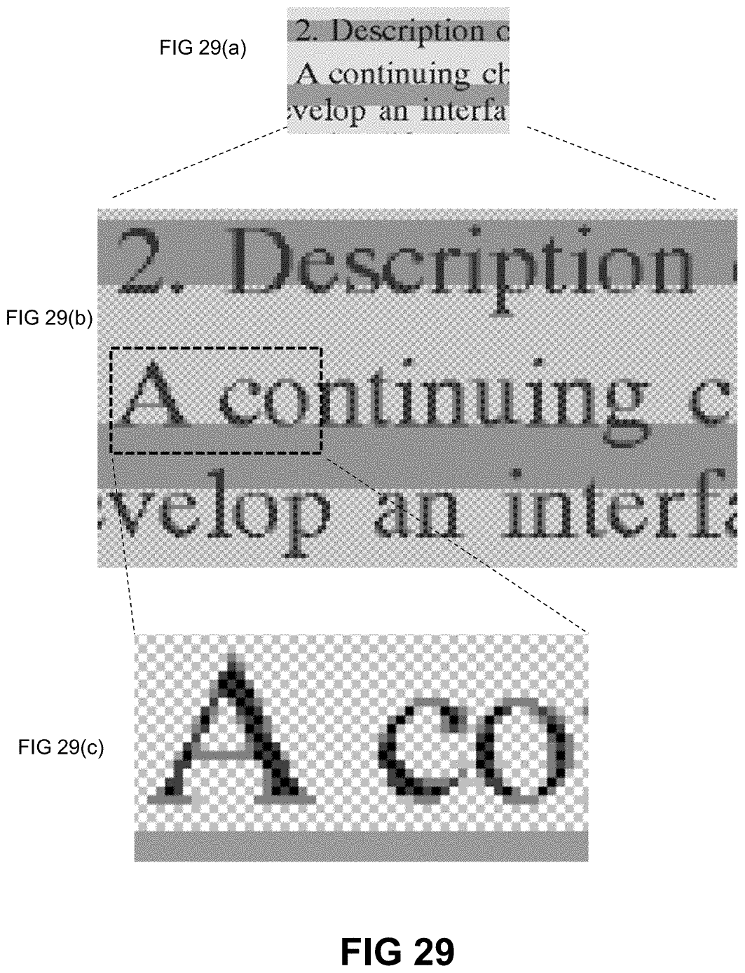

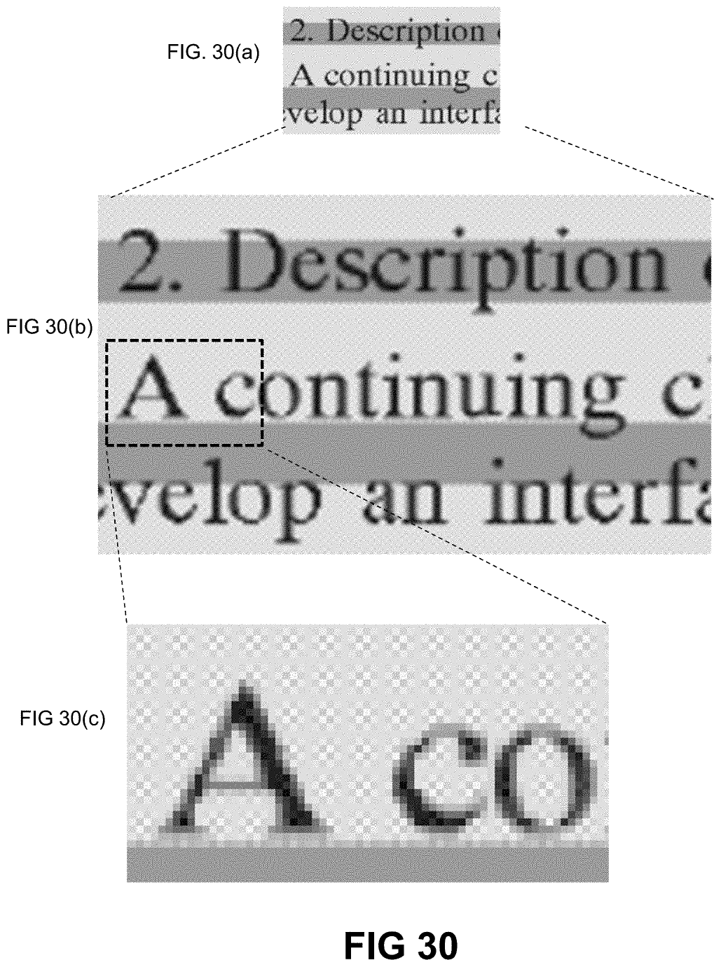

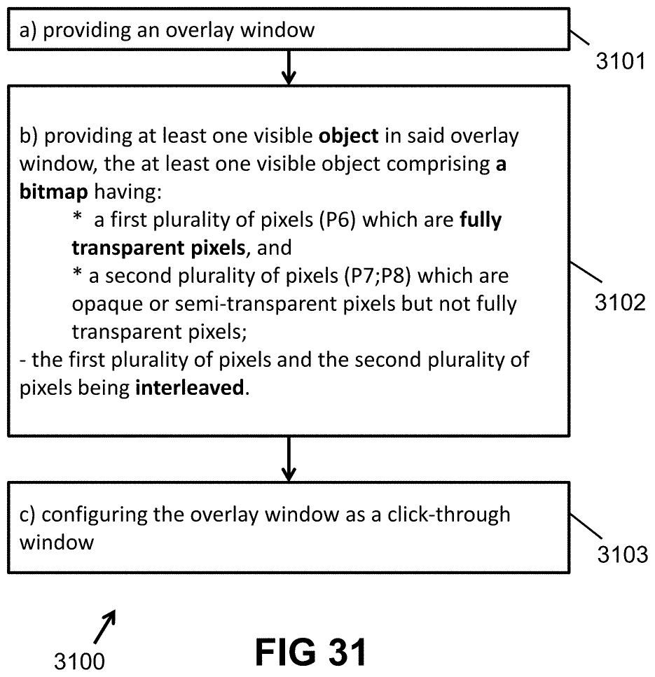

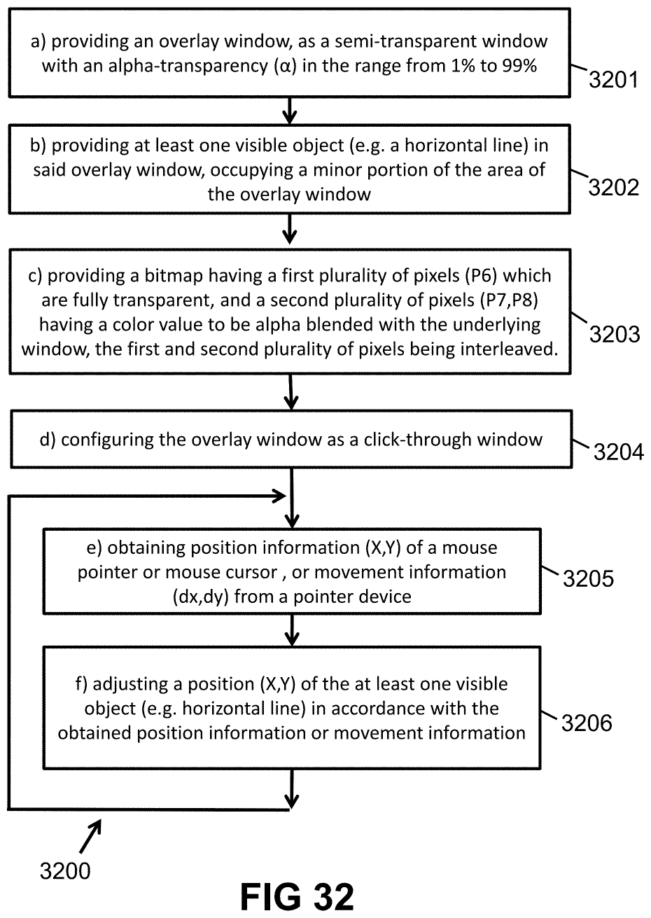

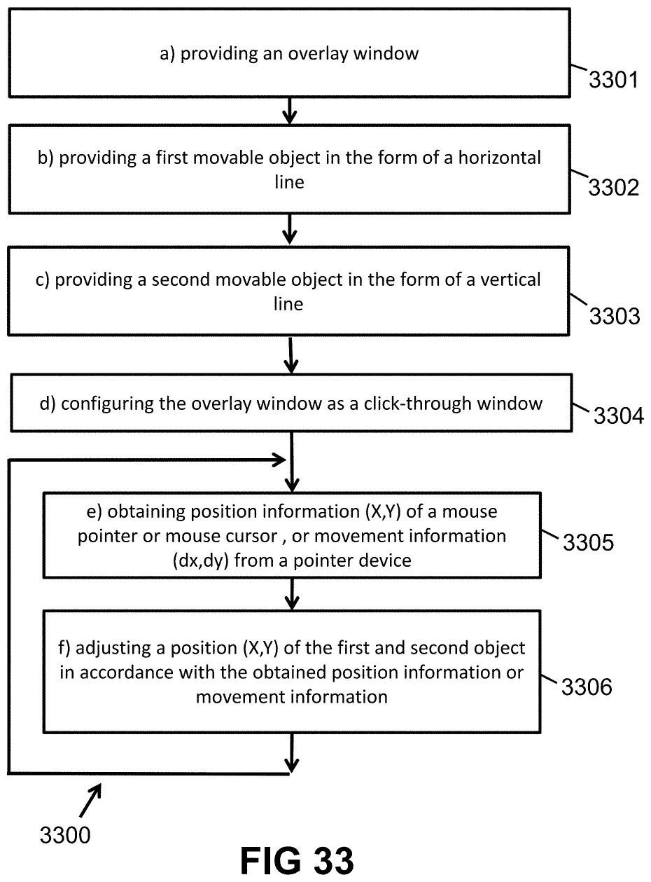

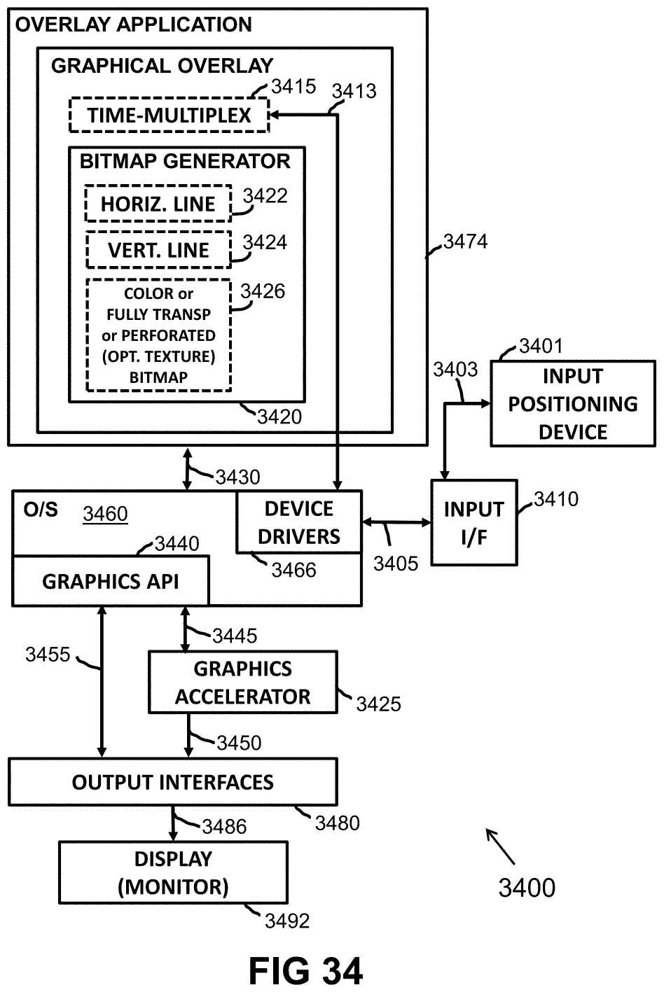

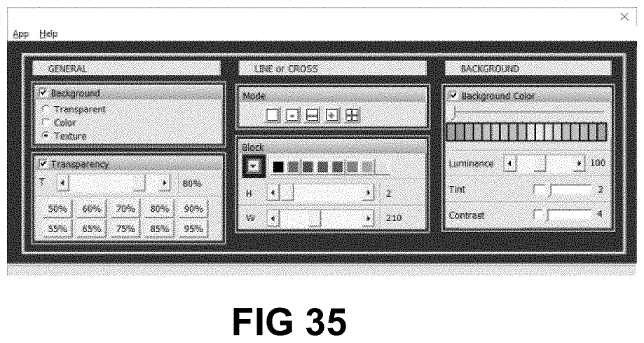

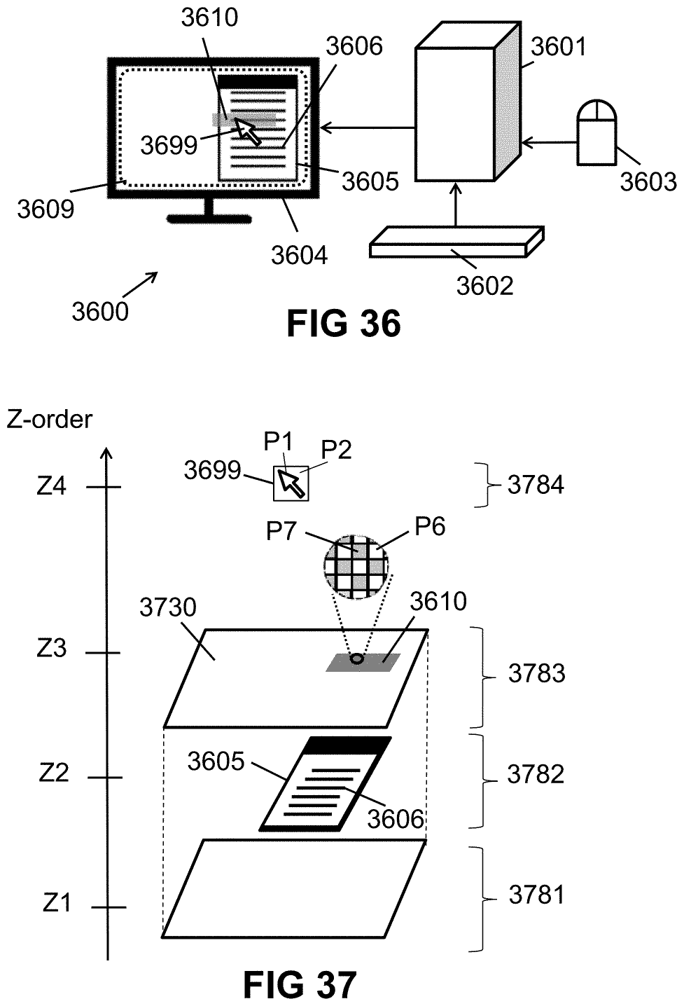

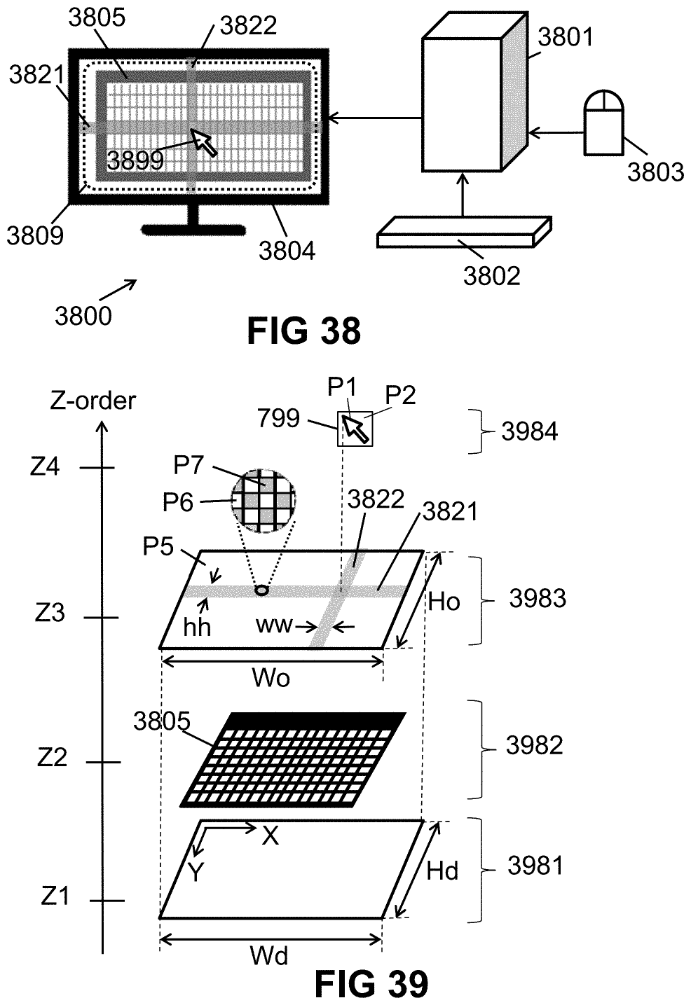

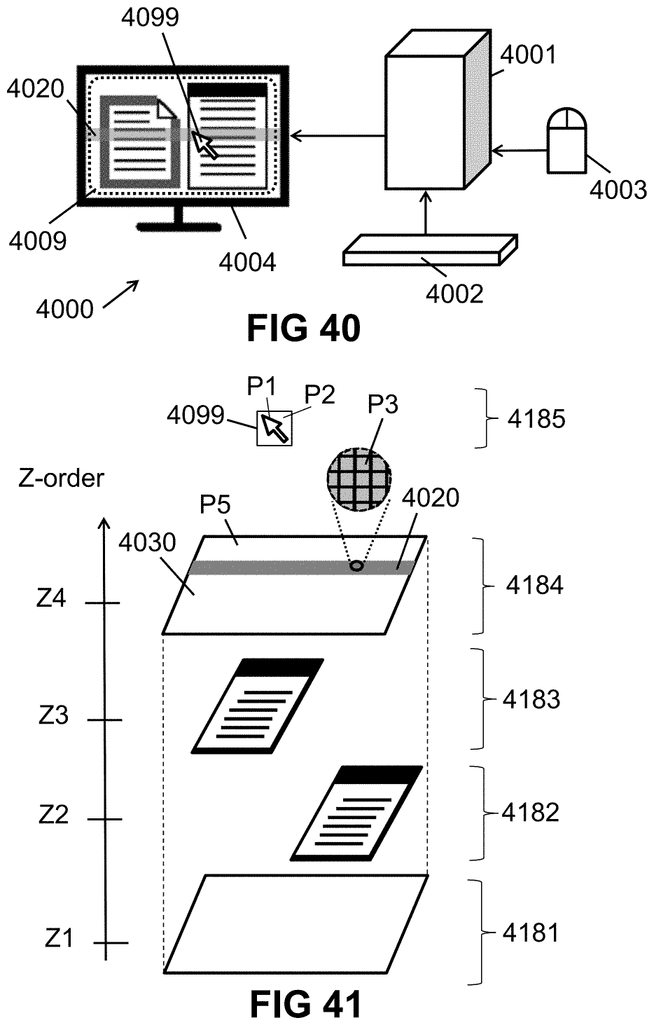

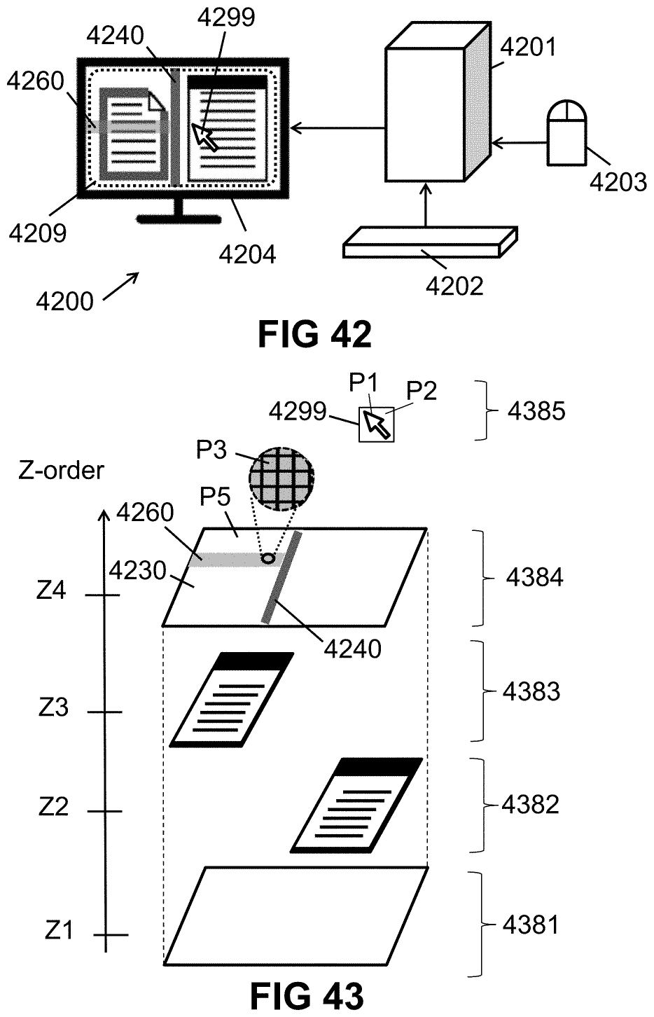

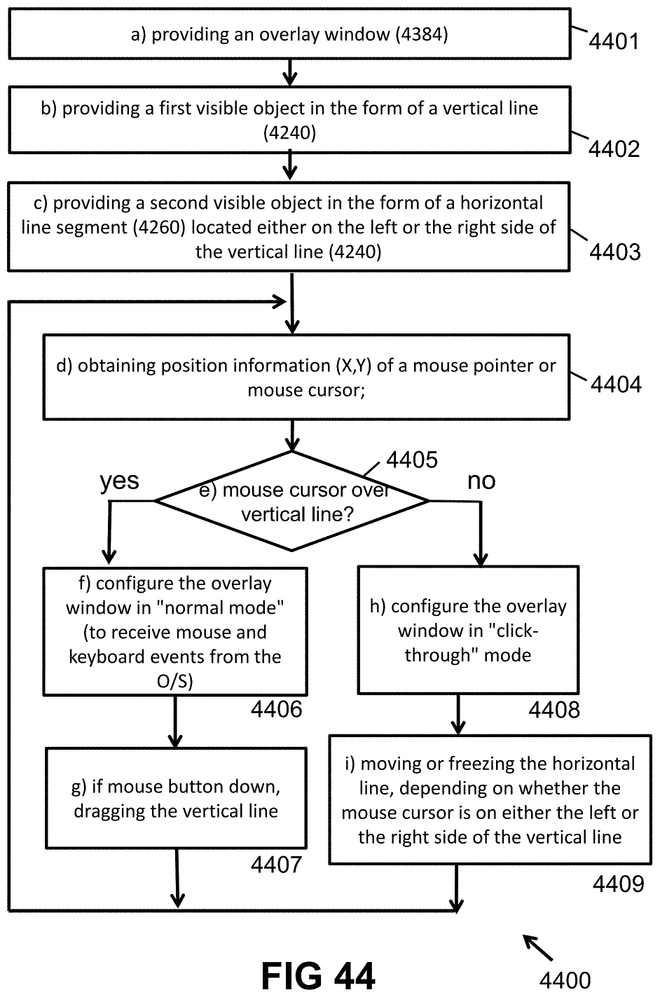

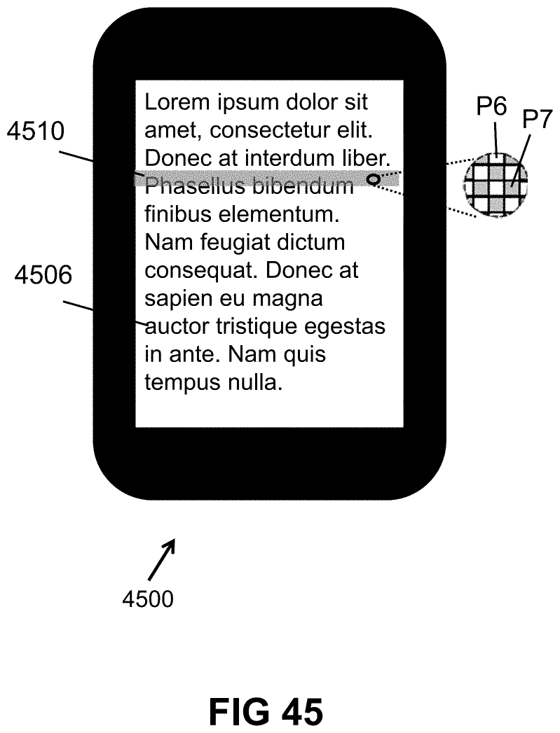

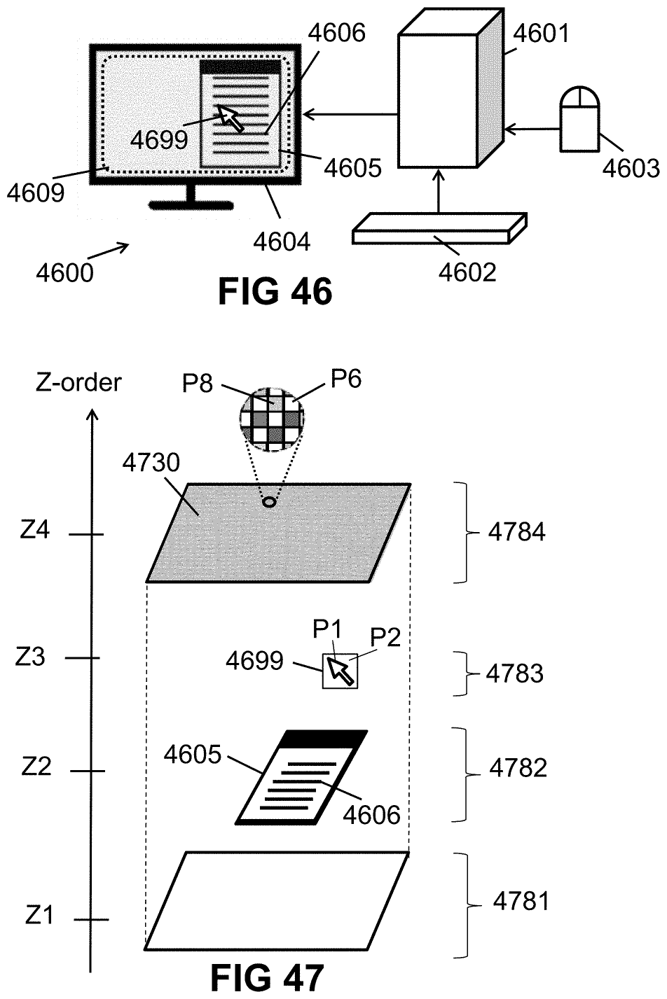

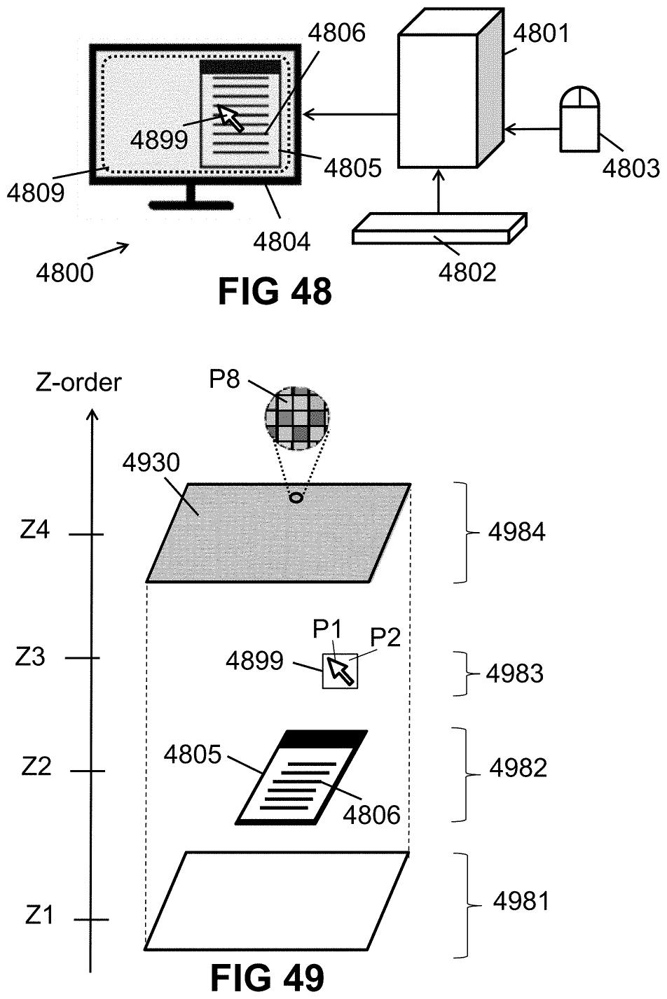

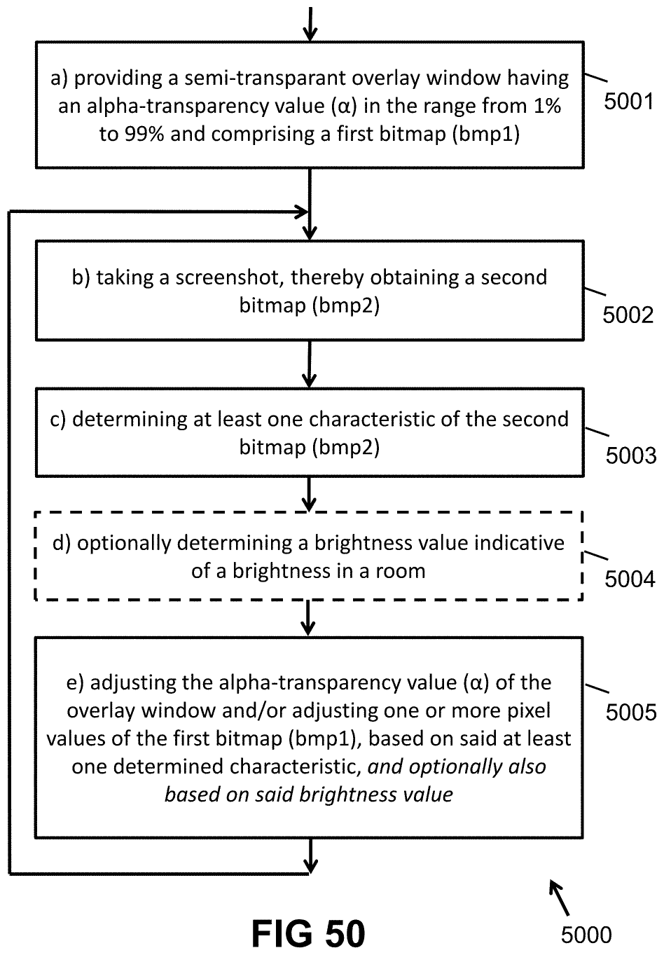

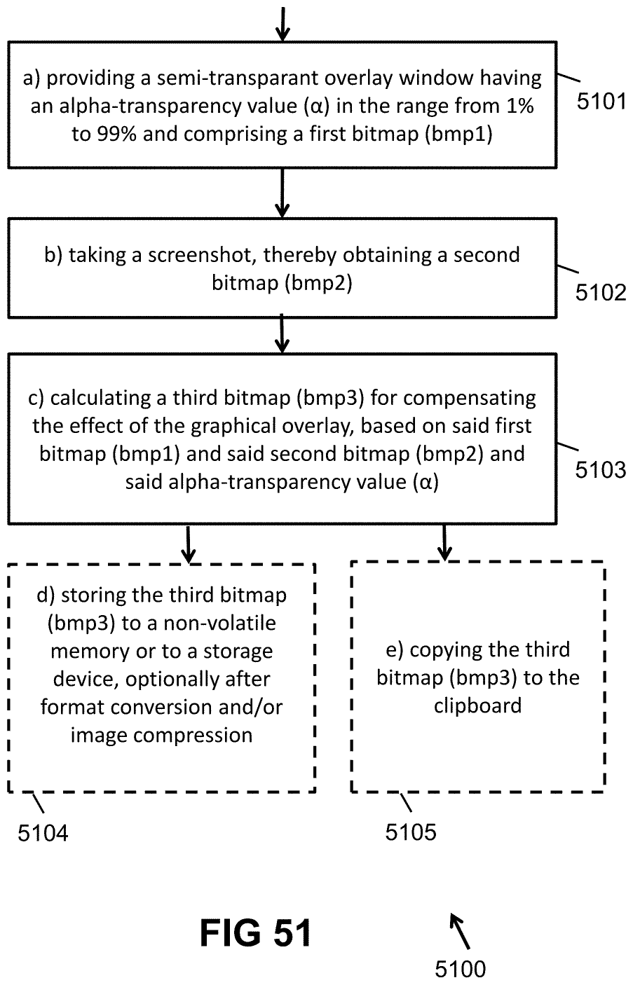

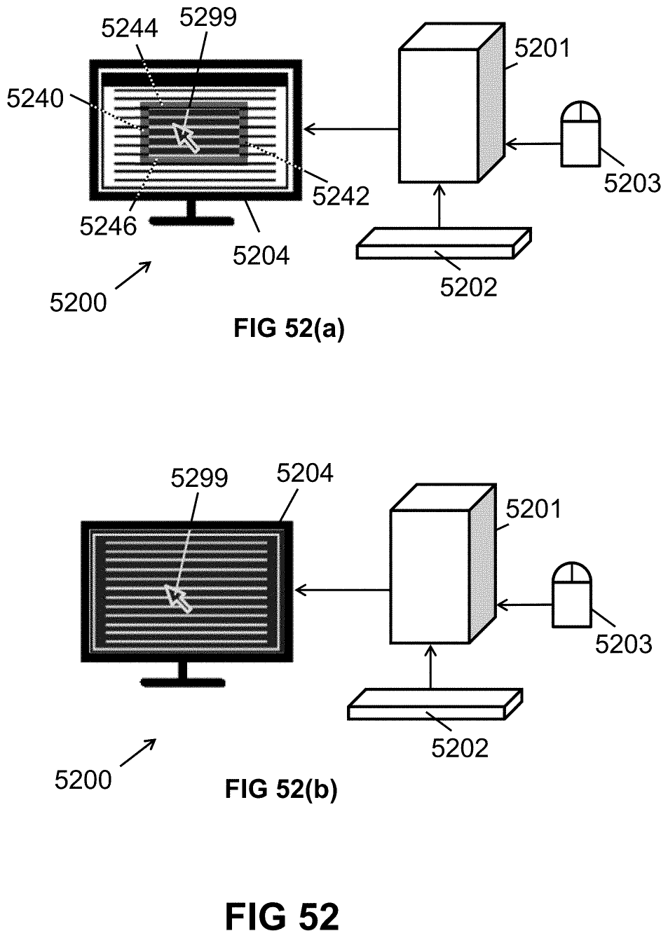

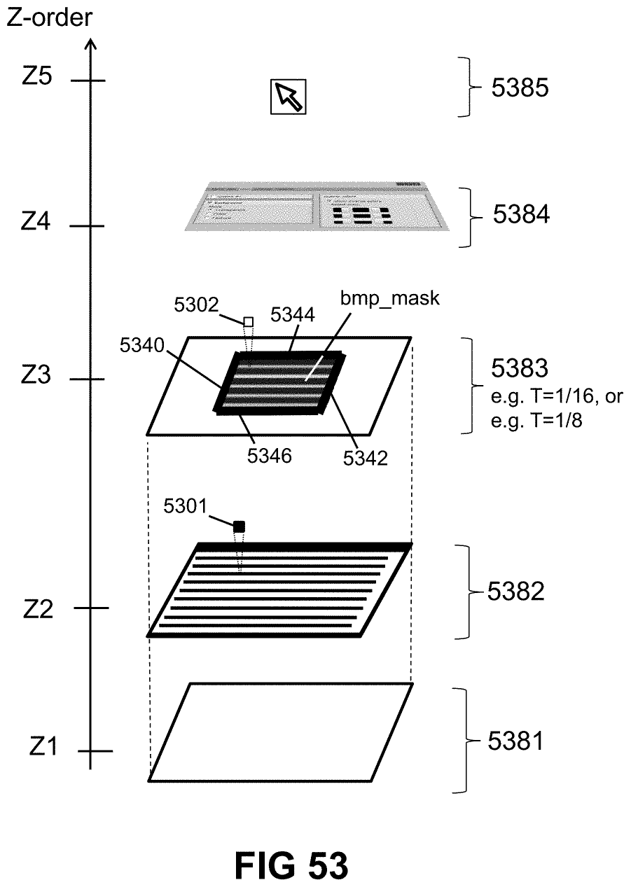

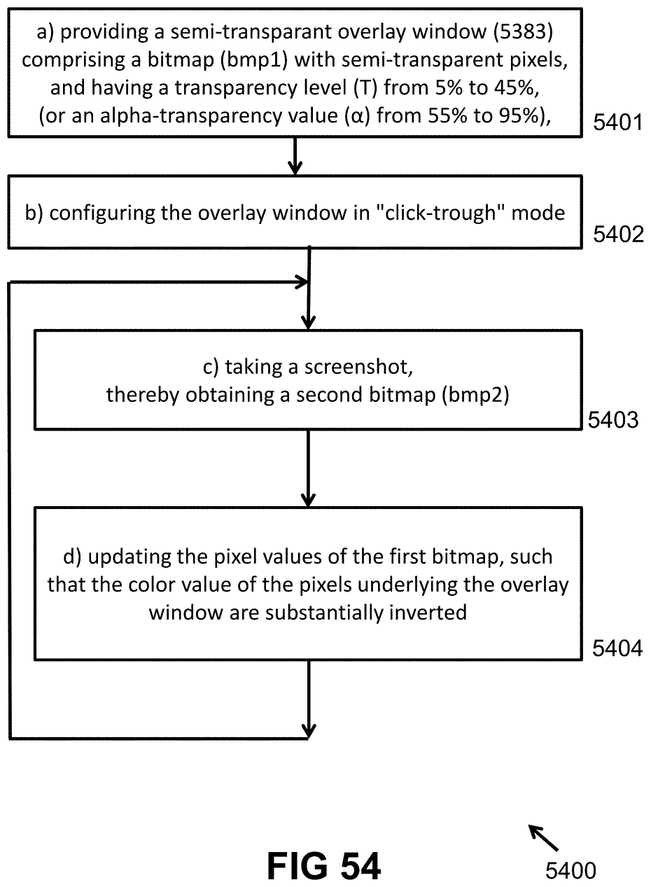

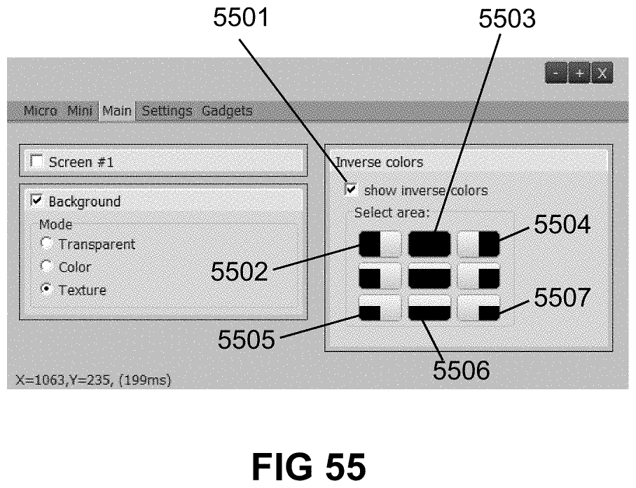

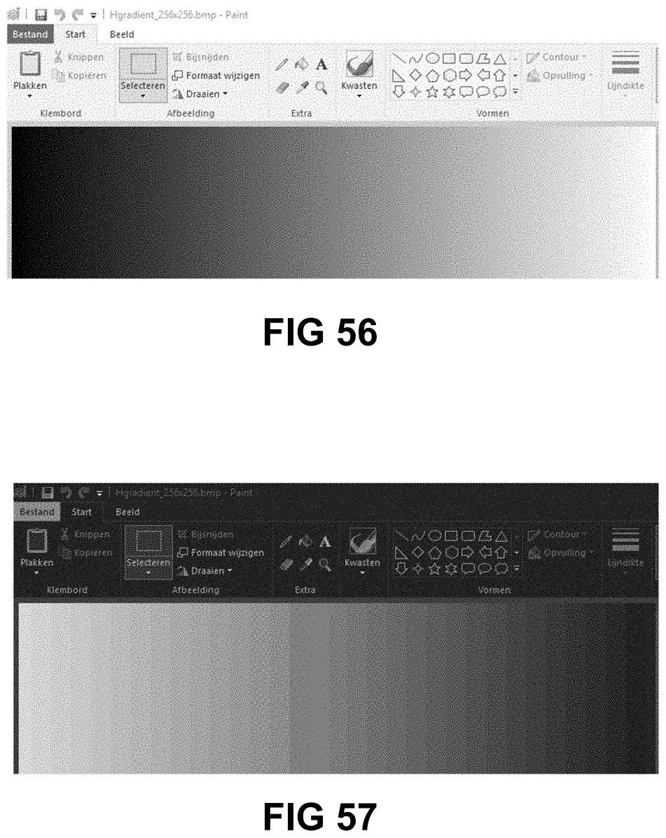

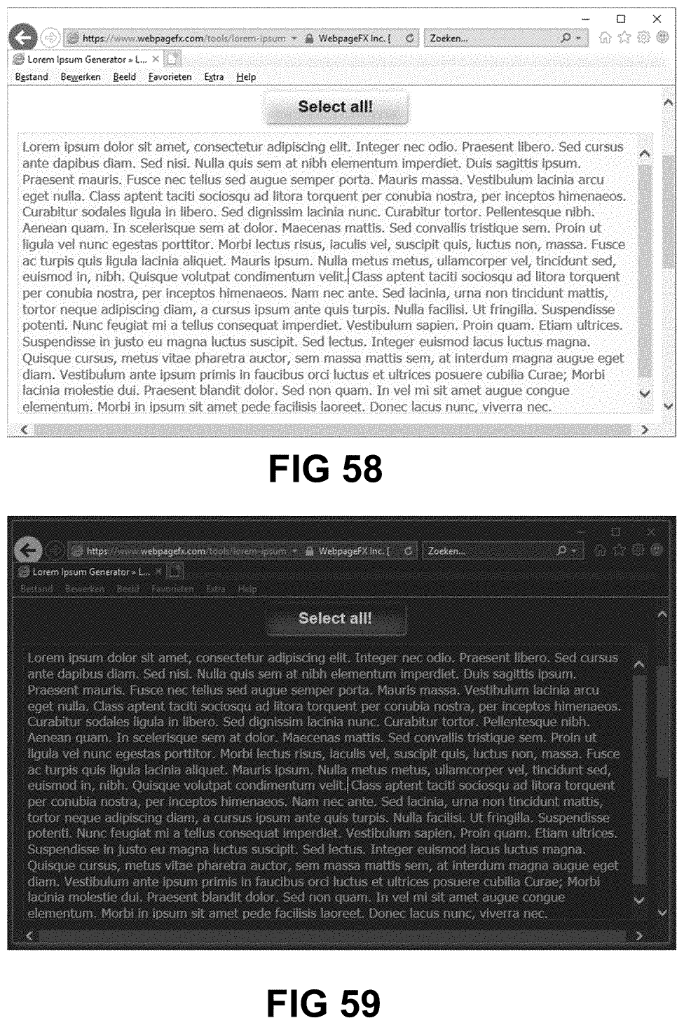

In FIG. 13(a) each text fragment is overlaid by two lines of red color with (R,G,B)=(255,0,0). The remainder of the overlay window is fully transparent.

In FIG. 13(b) each text fragment is overlaid by a bitmap containing light grey pixels with (R,G,B)=(192,192,192).

In FIG. 13(c) each text fragment is overlaid by a bitmap containing dark grey pixels with (R,G,B)=(64, 64, 64).

In FIG. 13(d) each text fragment is overlaid by a mere combination of the two red lines as in FIG. 13(a) and by a light gray bitmap as in FIG. 13(b).

In FIG. 13(e) each text fragment is overlaid by a mere combination of the two red lines as in FIG. 13(a) and by a dark gray bitmap as in FIG. 13(c).

In FIG. 13(f) to FIG. 13(i) each text fragment is overlaid by two red lines as in FIG. 13(a) and the remainder area is overlaid by a so called “perforated bitmap” as illustrated in FIG. 12, where 50% of the pixels are fully transparent pixels arranged in a chessboard pattern, and the other 50% of the pixels are light gray pixels with (R,G,B)=(192,192,192), as can be provided by overlay methods according to embodiments of the present invention.

In FIG. 13(g) each text fragment is overlaid by two red lines as in FIG. 13(a) and by a so called “perforated bitmap” as illustrated in FIG. 12, where 50% of the pixels are fully transparent pixels arranged in a chessboard pattern, and the other 50% of the pixels are dark gray pixels with (R,G,B)=(64, 64, 64), as can be provided by overlay methods according to embodiments of the present invention.

In FIG. 13(h) each text fragment is overlaid by two red lines as in FIG. 13(a) and by a so called “perforated bitmap” as illustrated in FIG. 12, where 50% of the pixels are fully transparent pixels arranged in a chessboard pattern, and the other 50% of the pixels are black pixels with (R,G,B)=(0, 0, 0), as can be provided by overlay methods according to embodiments of the present invention.

In FIG. 13(i) each text fragment is overlaid by two red lines as in FIG. 13(a) and by a so called “perforated bitmap” as illustrated in FIG. 12, where 50% of the pixels are fully transparent pixels arranged in a chessboard pattern, and the other 50% of the pixels are white pixels with (R,G,B)=(255, 255, 255), as can be provided by overlay methods according to embodiments of the present invention.

FIG. 14(a) schematically illustrates what happens with text information composed of originally black text pixels and originally white background pixels, when these pixels are overlaid with a bitmap containing 100% of black pixels with (R,G,B)=(0, 0, 0), for three different alpha-blending-values.

FIG. 14(b) schematically illustrates what happens with text information composed of originally black text pixels and originally white background pixels, when these pixels are overlaid with a bitmap containing 100% of white pixels with (R,G,B)=(255, 255, 255), for three different alpha-blending-values.

FIG. 15(a) schematically illustrates what happens with text information composed of originally black text pixels and originally white background pixels, when these pixels are overlaid with a bitmap containing 50% of fully transparent pixels and 50% of black pixels with (R,G,B)=(0, 0, 0), arranged in a checkerboard pattern, for three different alpha-blending-values.

FIG. 15(b) schematically illustrates what happens with text information composed of originally black text pixels and originally white background pixels, when these pixels are overlaid with a bitmap containing 50% of fully transparent pixels and 50% of white pixels with (R,G,B)=(255, 255, 255), arranged in a checkerboard pattern, for three different alpha-blending-values.

FIG. 16 to FIG. 19 show four examples of a larger text fragment.

FIG. 16 shows the text fragment containing black text on a white background as it may be rendered by a classical PDF viewer.

FIG. 17 shows the text fragment of FIG. 16 overlaid with a blue line segment containing pixels having the color (R,G,B)=(0,0,255), and with the transparency level of the overlay-window set to 50%.

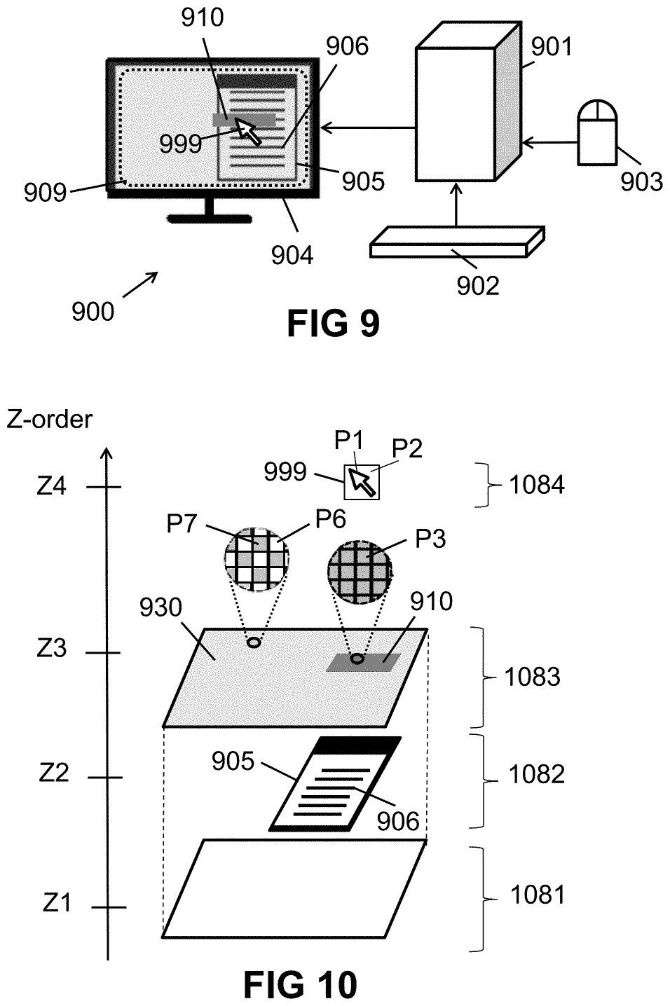

FIG. 18 shows the text fragment of FIG. 16, overlaid in a manner as described in FIG. 9 and FIG. 10, in particular, using a perforated bitmap with 50% fully transparent pixels, and 50% of gray pixels with color value (128, 128, 128) arranged in a checkerboard pattern.

FIG. 19 shows a schematic block diagram of another computer system according to an embodiment of the present invention, where the computer system contains a specific overlay application providing an overlay window comprising at least two semi-transparent elements: i) a line, and ii) a so called “perforated texture bitmap”. The line is movable in accordance with movements of an input device.

FIG. 20 is a schematic representation of a “Z-order” of four windows or image planes as may be used in the computer system of FIG. 19.

FIG. 21 shows a schematic block diagram of another computer system according to an embodiment of the present invention, where the computer system contains a specific overlay application providing an overlay window comprising at least one semi-transparent object in the form of a so called “perforated texture bitmap”.

FIG. 22 is a schematic representation of a “Z-order” of four windows or image planes as may be used in the computer system of FIG. 21.

FIG. 23 shows a schematic block diagram of another computer system according to an embodiment of the present invention, where the computer system contains a specific overlay application providing an overlay window comprising at least one semi-transparent object in the form of a so called “texture bitmap”.

FIG. 24 is a schematic representation of a “Z-order” of four windows or image planes as may be used in the computer system of FIG. 23.

FIG. 25 shows the text fragment of FIG. 16, overlaid in a manner as described in FIG. 19 and FIG. 20, adding a semi-transparent blue line with color (0,0,255) and using a perforated bitmap with 50% fully transparent pixels and 50% of gray pixels organized in a checkerboard pattern, the gray pixels being obtained from a texture bitmap.

FIG. 26 shows the text fragment of FIG. 16, overlaid in a manner as described in FIG. 19 and FIG. 20, using a perforated bitmap with 50% fully transparent pixels, and 50% of gray pixels obtained from a texture bitmap chosen such that the resulting overlaid image has a background with an average color value of about (128, 128, 128), to allow comparison with FIG. 16 (the contrast of the texture is adjustable, and may be slightly exaggerated for illustrative purposes).

FIG. 27 shows the exemplary texture bitmap which was used to generate the image of FIG. 25 and FIG. 26, before perforation, before optional color adjustment and before optional contrast adjustment.

FIG. 28 schematically illustrates how overlaying with a perforated bitmap which is shifted back and forth by one single pixel, can be used for time-multiplexing or time-averaging.

FIG. 29(a) to (c) show examples of an image fragment obtained by overlaying a graphical image containing black text on a white background, using a method of the present invention, rendered on a display device with native resolution of 3840×2160 configured at a resolution of 2560×1440, with a scaling factor for text and apps of 100%.

FIG. 29(a) shows a portion of the image of FIG. 18, seen from a relatively large distance at which the human eye does not discern individual pixels.

FIG. 29(b) shows the same image, zoomed in by a factor of about 350%.

FIG. 29(c) shows a portion of the same image, zoomed in further by a factor of about 200%.

FIG. 30(a) to (c) show substantially the same images as those of FIG. 29(a) to FIG. 29(c), rendered on the same display device, again configured to a resolution of 2560×1440, but configured with 125% scaling for text and apps.

FIG. 30(a) shows what the resulting image fragment looks like, when seen from a relatively large distance at which the human eye does not discern individual pixels.

FIG. 30(b) shows the same image, zoomed in by a factor of about 350%.

FIG. 30(c) shows the same image, zoomed in further by a factor of about 200%.

FIG. 31 shows a flowchart of overlay methods according to embodiments of the present invention.

FIG. 32 shows a flowchart of overlay methods according to embodiments of the present invention.

FIG. 33 shows a flowchart of overlay methods according to embodiments of the present invention.

FIG. 34 shows a simplified high-level block diagram of software components and hardware components, situated in a computer system, which typically cooperate when performing a method according to the present invention

FIG. 35 shows an exemplary user-interface window as may be used by an overlay application according to the present invention.

FIG. 36 shows a schematic block diagram of another computer system according to an embodiment of the present invention, with a specific overlay application providing an overlay window with a movable object having a so called perforated bitmap. The line is movable in accordance with movements of the input device.

FIG. 37 is a schematic representation of a “Z-order” of four windows or image planes as may be used in the computer system of FIG. 36.

FIG. 38 shows a schematic block diagram of another computer system according to an embodiment of the present invention, with an overlay application providing an overlay window with a movable object in the form of a perforated cross, movable in accordance with movements of the input device.

FIG. 39 is a schematic representation of a “Z-order” of four windows or image planes as may be used in the computer system of FIG. 38.

FIG. 40 shows a schematic block diagram of another computer system according to an embodiment of the present invention, with an overlay application providing an overlay window with a movable object in the form of a horizontal line extending over the entire width of the screen, and movable in accordance with movements of the input device.

FIG. 41 is a schematic representation of a “Z-order” of four windows or image planes as may be used in the computer system of FIG. 40.

FIG. 42 shows a schematic block diagram of another computer system according to an embodiment of the present invention, with an overlay application providing an overlay window with a vertical line that defines a left region and a right region of the screen, and with a horizontal line that extends over the width of the left region, and is movable vertically in accordance with movements of the input device if the mouse cursor is in the left region, and which freezes if the mouse cursor is in the right region.

FIG. 43 is a schematic representation of a “Z-order” of four windows or image planes as may be used in the computer system of FIG. 42.

FIG. 44 shows a flowchart of another overlay method according to embodiments of the present invention.

FIG. 45 shows a schematic block diagram of a portable device such as e.g. an eReader or a smartphone, adapted for showing textual information overlaid by a semi-transparent line, according to an embodiment of the present invention.

FIG. 46 shows a schematic block diagram of another computer system according to an embodiment of the present invention, which can be seen as a variant of FIG. 21, where the computer system provides a graphical overlay image in the form of a so called “perforated texture bitmap”, overlaid by the display device.

FIG. 47 is a schematic representation of a “Z-order” of three windows or image planes as may be used in the computer system of FIG. 46, and on top of that, a fourth semi-transparent overlay window provided by the display device.

FIG. 48 shows a schematic block diagram of another computer system according to an embodiment of the present invention, which can be seen as a variant of FIG. 46, where the computer system provides a graphical overlay image in the form of a “non-perforated texture bitmap”, overlaid by the display device.

FIG. 49 is a schematic representation of a “Z-order” of three windows or image planes as may be used in the computer system of FIG. 48, and on top of that, a fourth semi-transparent overlay window provided by the display device.

FIG. 50 is a flowchart of another computer implemented method according to an embodiment of the present invention.

FIG. 51 is a flowchart of another computer implemented method according to an embodiment of the present invention.

FIG. 52 shows a schematic block diagram of a computer system according to an embodiment of the present invention. The computer system of FIG. 52(a) comprises a computer device running an overlay application for inverting the colors of at least a portion of the underlying image, said image being formed by the operating system in correspondence with the underlying stack of windows, as shown e.g. in FIG. 53.

In FIG. 52(a) only a portion of the screen is color inverted.

In FIG. 52(b) substantially the entire screen is color inverted, e.g. the entire screen area except the taskbar.

FIG. 53 is a schematic representation of a so called “Z-order” of five windows or image planes as may be used in the exemplary computer system of FIG. 52(a) and/or FIG. 52(b), when running a classical text editor application and an overlay application according to an embodiment of the present invention.

FIG. 54 is a high-level flowchart of a computer implemented method for substantially inverting the colors of at least a portion of the underlying image, according to an embodiment of the present invention, as can be implemented in the overlay application running on the computer device of the computer system of FIG. 52(a) and FIG. 52(b).

FIG. 55 shows an exemplary user interface window as may be used by the application running on the computer system of FIG. 52(a) and/or FIG. 52(b).

FIG. 56 and FIG. 57 show a first exemplary image to show the quality of the color inversion obtainable by the overlay application. FIG. 56 shows the original picture, FIG. 57 shows the picture being overlaid in a manner which causes color inversion.

FIG. 58 and FIG. 59 show a second exemplary image to show the quality of the color inversion obtainable by the overlay application. FIG. 58 shows the original picture, FIG. 59 shows the picture being overlaid in a manner which causes color inversion.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and may not be drawn to scale for illustrative purposes. The dimensions and the relative dimensions may not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “In an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In this document the term “alpha-blending” or “mixing” (of images or bitmaps) are used as synonyms. In the context of graphical overlay, there is an upper image (having a higher Z-order) and a lower image (having a lower Z-order). The mixing can be done in hardware and/or software, and is based on a parameter called “alpha-blending value” α, which refers to the level of mixing the two images, where α=0% means that the original image is not mixed with the overlay image” (or that the overlay image is fully transparent), and where α=100% means that the resulting pixel value is that of the overlay image (or that the overlay image is fully opaque) except for fully transparent pixels. The alpha-blending value may be expressed on a scale from 0 to 255, where α=255 corresponds to α=100% and α=0 corresponds to α=0%. Alpha-blending can for example be used to fade-in or fade out a graphical image. In the context of the present invention there is also a second parameter involved in the mixing, referred to as “TransparentColorValue”. If a pixel of the overlay image has this predefined (false color or pseudo-color) value, this pixel is treated as “fully transparent”. Fully transparent pixels are typically used for example when showing a rectangular image with rounded edges and/or rounded corners. Alpha-blending and “fully transparent pixels” are both well known in the art.

When in the present invention reference is made to “a color” of a pixel, not only the tint is meant (e.g. red or blue or green or yellow), but also its intensity or brightness, unless otherwise specified or clear from the context.

When in the present invention reference is made to “a color expressed in R,G,B values”, what is meant is a color value as can be represented by a set of color components, for example by a set of (R,G,B) values, representative of a red, a green and a blue color component value, each having a value in the range from 0 to 255. Pure black is represented by (0, 0, 0) and pure white is represented by (255, 255, 255). The R and G and B values are equal for a grayscale pixel.

With “pixel intensity” or “brightness” or “luminance” of a pixel represented by a set of (R,G,B)-values is meant a value L approximately equal to L=R*0.3+G*0.6+B*0.1 or approximately equal to R*3/8+G*5/8+B*1/8, or other formulas known in the art.

Where in the present invention reference is made to a black, gray or white pixel, what is meant is a pixel having a color, when expressed in R,G,B values, of which the R-value and G-value and B-value are equal. For example, a black pixel has RGB values (0, 0, 0), a white-pixel has RGB values (255, 255, 255) assuming an 8-bit representation is used.

In this document the term “color” of a pixel or “value” of a pixel refers to the set of color components, for example to a combination of an R, G and B-value. A black or white or gray pixel has equal values for its R, G and B components, and can thus be represented by the color values (x,x,x). For these pixels the single number x is also referred to as the “value” of the pixel.

In this document the expression “with color (R,G,B)” means “with a color as can be expressed in terms of Red, Green and Blue color components”, with red=R, green=G, blue=B, each on a scale from 0 to 255.

In this document, the terms “display” and “monitor” and “screen” are used as synonyms, unless explicitly mentioned, or unless the context clearly suggests otherwise. In the context of the present invention, the display usually is a single physical device.

In this document, the terms “chessboard pattern” and “checkerboard pattern” are used as synonyms.

In this document the term “perforated bitmap” means a bitmap containing a first plurality of “fully transparent” pixels and a second plurality of “other pixels”. In practice the first plurality of pixels has a predefined pseudo-color value which is recognized by a mixing unit (e.g. a software mixer or a graphics processor) so as to treat these pixels as fully transparent. The “other pixels” of the bitmap may all have the same color (monochrome), or may have different colors (e.g. extracted from a texture bitmap or forming a color gradient). The first and second plurality of pixels are preferably arranged in a pattern, e.g. in a chessboard pattern, as illustrated for example in FIG. 10 and FIG. 12 and FIG. 22 and FIG. 37.

With “on average” is meant “by spatial averaging” or “by time averaging”, or both “spatial averaging” and “time averaging”.

In this document, “the size, width or height of the screen” can refer to (i) the size, width and height of the pixel array of the screen (not the border around the pixel array), or can refer to (ii) the size, width and height of the so called “work area”, which is the same area as (i) minus the area occupied by the so called “taskbar”. The “work area” is also the area that will typically be occupied by an application when it is maximized.

In this document, the term “line” or “bar” are used as synonyms. They may refer to a (relatively small) “line segment” or “block” or to a rectangular region extending over substantially the full width or full height of the screen, or the full width or full height of the “work area” of the screen.

In this document, the terms “word processor” or “text editor” should not be interpreted too narrow, because many so called word processors (such as e.g. Microsoft Word) also have drawing capabilities. Likewise, the term “spreadsheet” or “worksheet” should not be interpreted too narrow, because many so called worksheet applications, e.g. Microsoft Excel, also have graphical capabilities.

In this document, the expression “the overlay window is configured in click-through mode” or “the overlay window is configured in pass-through mode” means that the overlay window is configured in such a way that events from input devices (such as e.g. a mouse, a keyboard, a touchpad, etc.) are sent by the operating system to one or more underlying application windows or to objects thereof, despite the higher Z-order of the overlay application. This applies inter alia to events caused by a button press or a button release or a button click or a scroll event of a mouse-wheel, and to movements. In the context of the present invention, the overlay application typically comprises one window configured in click-through mode, but preferably also a second, mainly opaque window (optionally with fully transparent pixels), with user interface elements.

In this document, the expression “the overlay window is configured in non-click-through mode” means that the overlay window is “not configured in click-through mode”.

In this document, the term “work area” refers to a portion of the pixel area of a screen, namely the area that will be occupied by the application 705 in case it is maximized. In a Microsoft Windows environment, the “work area” means the entire pixel area except the so called “taskbar”, which is typically located at the bottom of the screen, but may also be located elsewhere.

In this document, the expression that “a bitmap contains semi-transparent pixels” typically means that the bitmap does not consist of only fully transparent pixels, (thus contains at least one color pixel and optionally one or more fully transparent pixels), and is located in a window that is configured to be semi-transparent with an alpha-transparency in the range from 1% to 99%, but other manners of providing a bitmap with semi-transparent pixels may also be used.

The present invention relates to a method of providing a graphical overlay, and to a computer program product adapted for performing such a method when being executed on a computer system, and to a computer system comprising such a computer program product.

The present invention will be explained in more detail for the example of a Microsoft Windows desktop PC running a version of “Microsoft Windows” as the O/S (for example Windows XP or Windows NT or Windows 10 or Windows 12 or later Windows versions having the same or similar functionality with respect to functions relevant for the present invention, such as alpha-blending and overlaying), and running one or more applications selected from the group consisting of: a web browser application, a spreadsheet application, a PDF document viewer, a PDF document editor, a text viewer and a text editor; but the invention is not limited thereto, and can also be used on other computing devices, such as for example an Apple Computer, or on portable devices such as smartphones, running respective operating systems and applications.

Referring to the Figures,

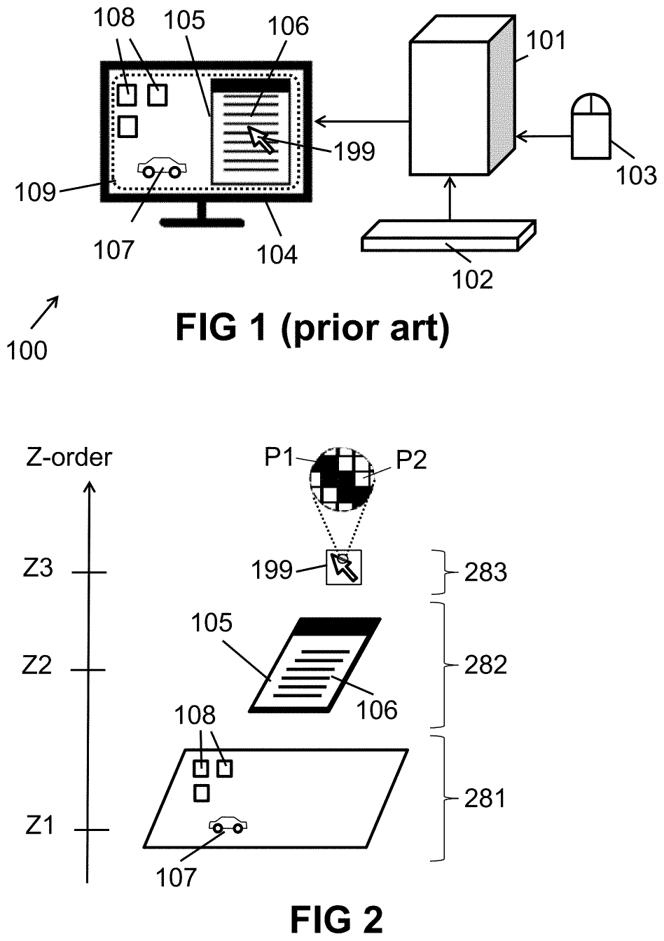

FIG. 1 shows a schematic block diagram of a classical computer system 100 comprising a computer device 101 connected to a keyboard 102 and a mouse 103 as input devices, and to a monitor or display or screen 104 as output device. The computer device 101 further typically comprises storage components (e.g. in the form of flash memory or one or more hard disks) storing software (executable machine instructions), in particular, an operating system, device drivers, and one or more applications. The computer device 101 further comprises at least one central processing unit CPU configured for executing program instructions of a multi-tasking operating system with a graphical user interface GUI (for example “MICROSOFT WINDOWS 10” available from Microsoft Corporation of Redmond, Wash., US), and one or more software applications such as a text viewer or a text editor (e.g. Microsoft Word or Notepad or WordPad) and/or a PDF document viewer (e.g. Adobe Acrobat Reader) and/or a PDF document editor (e.g. Nuance Power PDF), and/or an internet browser (e.g. Microsoft Internet Explorer or Mozilla FireFox or Google Chrome), and/or other applications.

Input from the keyboard device 102 and mouse device 103 are typically handled by device drivers, configured for receiving information via respective input ports (e.g. a serial port or parallel port or USB port). Such computer systems and application programs and device drivers are known in the art.

In the specific example of FIG. 1, the computer device 101 generates a graphical image which is rendered on the display 104 as indicated by the rectangular area 109 (shown slightly offset from the display border for illustrative purposes). The graphical image comprises image portions related to a so called “desktop window” (in this example visible on the left side of the screen 104), and related to an application window (e.g. MS Word) showing a text document (in this example located on the right side of the screen 104). In the specific example of FIG. 1, the desktop window comprises a picture of a car 107 and three icons 108, each icon representing an application, but this is merely an example. Also shown is a so called “mouse pointer” 199 or “mouse cursor” which may assume different shapes, and which moves in accordance with movements of the mouse device 103, under control of the operating system.

FIG. 2 is a schematic representation of a possible “Z-order” of three windows or image planes 281, 282, 283 as may be used in the computer system of FIG. 1, to obtain the combined image 109 shown on the display 104 of FIG. 1. The first window 281 having the lowest Z-order Z1 is referred to as the “desktop window”, and is typically generated by the operating system. The second window 282 having a second Z-order Z2 higher than Z1 is associated with application 105, (in the example MS Word), and renders alphanumerical or textual information 106. The third window 283 having a Z-order Z3 higher than Z2 is referred to herein as the “mouse bitmap” 199. In the example the mouse bitmap 199 is represented by a relatively small window 283, e.g. having a rectangular shape of about 18×22 pixels, or a square shape with 32×32 pixels, comprising a plurality of first pixels P1 showing a white arrow with a black border, surrounded or partially surrounded by a plurality of second pixels P2 which are fully transparent pixels. The desktop image 281 and the application image 282 are usually opaque images. The three image planes 281, 282, 283 are combined in known manners, resulting in the combined image shown on the display 104. This combined image can for example be captured using a well known “print-screen” function.

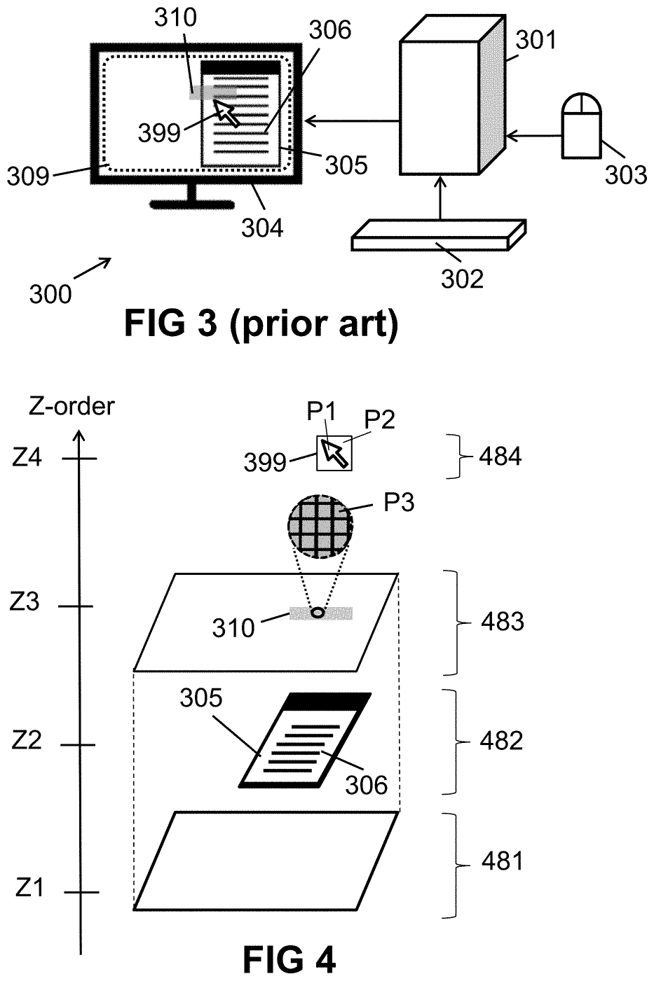

FIG. 3 shows a schematic block diagram of a computer system 300 which may have the same hardware configuration as the system 100 of FIG. 1. The system 300 has storage components storing executable instructions of an operating system with a graphical user interface (e.g. “Windows 10”) and a text editor application (e.g. MS Word), and having a specific overlay application known in the art as “LineReader” (at the moment of writing this document, downloadable from http://www.iconico.com/lineReader/). The overlay application shows a semi-transparent line 310 that follows movements of the mouse pointer 399. The line 310 can be used by a user to underline text fragments 306. In fact, “LineReader” also comes with a user interface, but that aspect is not relevant for the present invention, hence not shown or discussed further.

FIG. 4 is a schematic representation of a possible “Z-order” of four windows or image planes 481-484 as may be used in the computer system 300 of FIG. 3, to obtain the combined image 309 shown on the display 304 of FIG. 3. As far as known to the inventors, FIG. 4 is not publically available in the art, but is an assumed implementation.

The first window 481 at Z1 is referred to as the “desktop window”. The second window 482 at Z2 is associated with application 305, (in the example MS Word), and renders alphanumerical or textual information 306. A third window 483 is associated with the “LineReader” application and has Z-order Z3 higher than Z2 of the text editor application 305. The “mouse bitmap” or “mouse image plane” 399 is situated in window 484 having Z-order Z4 higher than Z3.

The desktop image 481 and the application image 482 are typically opaque images. The window 483 contains a small line or bar 310, and is configured in click-through mode and in semi-transparent mode with a configurable alpha-blending value, which allows to change the transparency level of the line or bar 310. Like in FIG. 2, the “mouse image plane” 484 has first pixels P1 showing a white arrow with a black border, at least partially surrounded by a plurality of second pixels P2 which are fully transparent pixels. The four image planes 481-484 are combined in known manners, resulting in the combined image 309 shown on the display 304. A portion of the bar is shown enlarged, to show that all pixels P3 of the line 310 have the same color, for example red or blue.

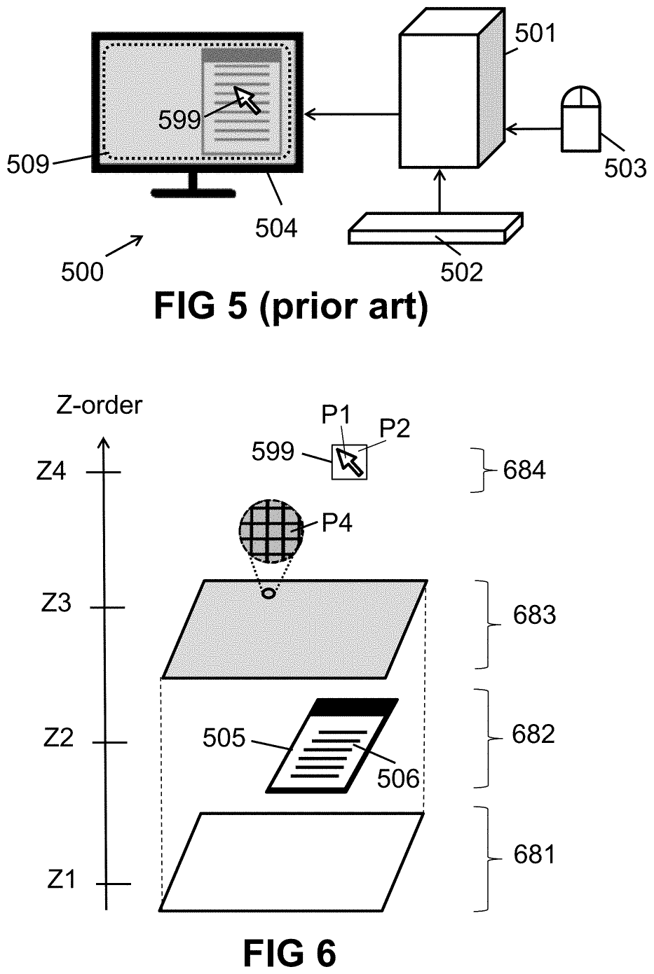

FIG. 5 shows a schematic block diagram of a computer system 500 similar to that of FIG. 1, when running an operating system O/S and two applications: a text editor and a specific overlay application known in the art as “F.Lux”, (at the moment of writing this document, downloadable inter alia from https://www.microsoft.com/en-us/store/p/flux/9n9kdphv9ljt), the latter showing a semi-transparent full screen overlay window, which according to the same website was created in 2008, which is almost a decade ago.

FIG. 6 is a schematic representation of a possible “Z-order” of four windows or image planes 681-684 as may be used in the computer system of FIG. 5, to obtain the combined image 509 shown on the display 504 of FIG. 5. As far as known to the inventors, FIG. 5 is not publically available in the art, but is an assumed implementation.

The first window 681 at Z1 is referred to as the “desktop window”. The second window 682 at Z2 is associated with application 505 (in the example MS Word), and renders alphanumerical or textual information 506. A third window 683 at height Z3 is associated with the “F.Lux” application and has Z-order Z3 higher than Z2 of the text editor application 505. The “mouse bitmap” or “mouse image plane” 599 is situated in window 684 having Z-order Z4 higher than Z3.

The desktop image 681 and the application image 682 are typically opaque images. As far as is known to the inventors of the present invention, the window 683 contains a monochrome bitmap with pixels P4 all having the same color. The window 683 is configured in click-through mode (i.e. the O/S sends all mouse events to underlying layers, in this example: to the desktop window 681 or to the text editor window 682, depending on the position of the mouse cursor) and is configured in semi-transparent mode with a configurable alpha-blending value. Like in FIG. 2, the “mouse image plane” 684 has first pixels P1 showing a white arrow with a black border, at least partially surrounded by a plurality of second pixels P2 which are fully transparent pixels. The four image planes 681-684 are combined in known manners, resulting in the combined image 509 shown on the display 504.

The computer system of FIG. 3 (with the “LineReader” application) may be helpful to a user when reading textual information on screen, but is not ideal when extracting information from tables, or when editing a worksheet.

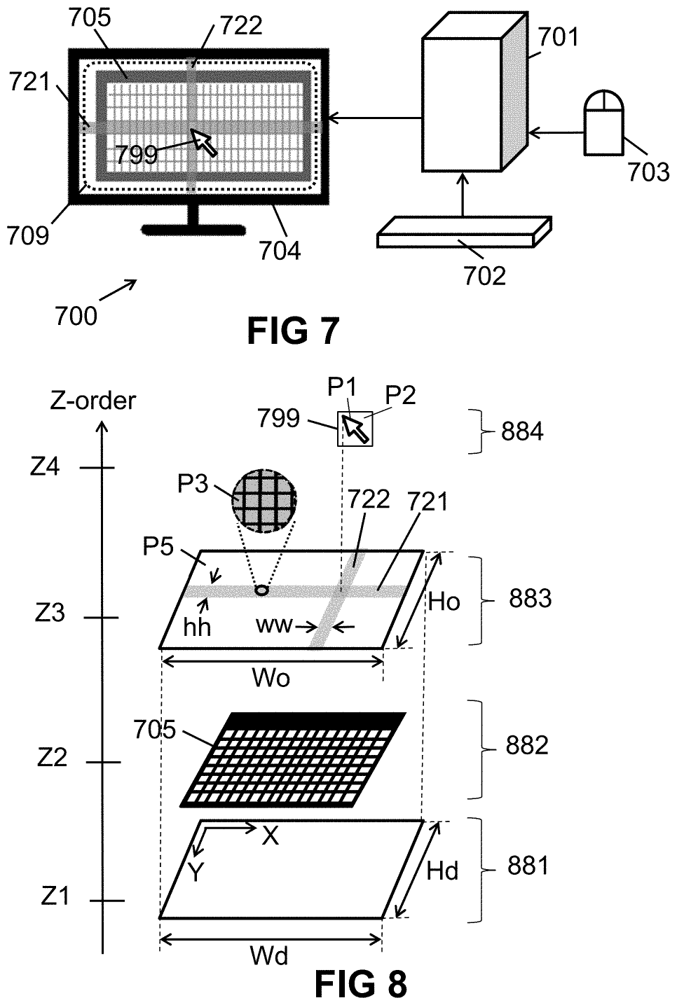

FIG. 7 shows a schematic block diagram of a computer system 700 according to an embodiment of the present invention. The computer system comprises a computer device 701, and a keyboard device 702 and a pointer device or position device 703 (e.g. a mouse device or a touchpad or a joystick) and a display 704 connected to said computer device 701.

The computer device 701 comprises a storage or a memory device (not shown) containing an operating system O/S with a graphical user interface GUI (for example Windows XP or Windows NT or Windows 10 or Windows 12 or later versions of Windows), and at least one application selected from the group consisting of: a web browser application, a spreadsheet application, a PDF document viewer, a PDF document editor, a text viewer and a text editor.

The computer device 701 further comprises an overlay application that shows a semi-transparent overlay window 883 comprising at least two semi-transparent elements: i) a horizontal line 721 or bar, and ii) a vertical line 722 or bar. The horizontal line 721 preferably extends over substantially the entire width Wo of the overlay window 883, which is preferably equal to the width Wd of the pixel area or of the work area of the screen. The vertical line 722 or bar preferably extends over substantially the entire height Ho of the overlay window 883, which is preferably equal to the height Hd of the pixel area or of the work area of the screen, irrespective of the actual size of any underlying application window 705 (e.g. MS Excel). The overlay application, even though it is configured in click through mode, makes sure that the horizontal line 721 and the vertical line 722 move in accordance with movements of the input device 703, or more specifically, that the horizontal line 721 moves in accordance with the Y-coordinate of the mouse pointer 799 and that the vertical line 722 moves in accordance with the X-coordinate of the mouse pointer 799. Preferably the horizontal line 721 and the vertical line 722 are positioned such that the mouse pointer 799 is located at least partially on both the horizontal line 721 and the vertical line 722, for example such that the tip of the mouse pointer 799 is located in or near the center of the rectangular crossing of the horizontal line 721 and the vertical line 722. Stated in simple terms, this embodiment provides an overlay application with a semi-transparent cross that moves along with the mouse pointer 799.

FIG. 8 is a schematic representation of a possible “Z-order” of four windows or image planes 881-884 as may be used in the computer system 700 of FIG. 7, to obtain the combined image 709 shown on the display 704 of FIG. 7.

The first window 881 at height Z1 is referred to as the “desktop window”. The second window 882 at Z2 larger than Z1 is associated with application 705, (in the example MS Excel), which typically presents alphanumerical and/or textual information organized in rows and columns. A third window 883 is associated with an overlay application according to an embodiment of the present invention, and has a Z-order Z3 higher than Z2 of the spreadsheet application 705. The “mouse bitmap” or “mouse image plane” 799 provided by the O/S with graphical user interface GUI is situated in window 884 at Z4 higher than Z3.

The desktop image 881 and the application image 882 are typically opaque images. The window 883 provides a substantially full-screen overlay configured in click-through mode and also configured in semi-transparent mode with a configurable alpha-blending value α (also referred to as “alpha transparency” or translucency) in the range from 5% to 95%, or from 10% to 90% or from 20% to 80%, or from 30% to 70%, where α=0% means that the line is completely transparent, and α=100% means that the line is completely opaque. The value of α should not be too low, because otherwise the cross is almost invisible, and is difficult to find. The value of α should not be too high, because otherwise the cross is almost opaque, and obscures the information underneath the cross. The skilled person and/or the user can find suitable values.

Preferably the overlay application also has another window (not shown in FIG. 7 and FIG. 8, but see for example FIG. 35 for an example) as a user interface. This user-interface window is then preferably located higher than Z3 of the click-through window 883. Preferably this user interface window allows to select several characteristics of the cross, such as for example: color, width of the lines forming the cross, and transparency level.

Referring back to FIG. 8, a major portion of the semi-transparent window 883 is occupied by fully transparent pixels P5. A minor portion of the semi-transparent window 883 is occupied by the movable horizontal line 721 and the movable vertical line 722. The lines 721, 722 may be implemented as pure rectangular regions, with or without a border (e.g. a black border), and with or without rounded edges, and with or without rounded corners, and with or without other characteristics. The lines 721, 722 may comprise monochrome pixels, or may comprise a color gradient. Preferably the color of both lines is the same, and adjustable or selectable. In preferred embodiments, the height hh of the horizontal line 721, and the width ww of the vertical line 722 are adjustable. The value of hh and ww are preferably the same (which simplifies the user settings), but that is not absolutely required. Like in FIG. 2, the “mouse image plane” 884 has first pixels P1 showing a white arrow with a black border, at least partially surrounded by a plurality of second pixels P2 which are fully transparent pixels. The stack of four image planes 881 to 884 are combined in known manners, resulting in the combined image 709 shown on the display 704.

This overlay application is ideally suited for finding a correct cell, because the horizontal line 721 and the vertical line 722 extend over the respective row headers and column headers. This allows a user to immediately see whether the mouse pointer is positioned on or over the correct cell, or not, without having to click on any column headers and/or row headers. This overlay application can be seen as an extremely useful add-on for spreadsheet applications, but can also be used when extracting information from tables presented on webpages. The tool is especially useful on high-resolution screens (having a resolution of at least 1920×1080 pixels).

The tool may drastically lower the cognitive burden of a user trying to find a particular cell, located at the crossing of a particular row (with a certain row header) and a particular column (with a certain column header). Without the overlay tool with the semi-transparent cross, many users first tentatively click on a cell in the vicinity of where they believe the target cell is probably located, and thereafter they verify whether the correct cell was selected, by starting from the selected cell (which is highlighted after clicking), and then moving his or her eyes horizontally towards the row headers while trying to stay in the same row as the selected cell, and if the row is not correct, clicking on the cell higher than or lower than the selected cell, and repeating the process, and then doing a similar check to verify whether the selected cell is located in the correct column by starting from the selected cell again, and moving his or her eyes upwards, towards the column headers, and if it turns out that the column is not correct, selecting a cell on the left or on the right of the selected cell, and optionally double checking the finally selected cell. This costs time, and is very error prone. Of course it is possible to use other ways, e.g. by panning, or by selecting a certain column by clicking on the column header, or by using “freeze panes” (a feature in Excel to block a certain number of rows and/or columns), but this also costs time, and introduces the risk of inadvertently changing the height of a row, or the width of a column etc. In contrast, with the overlay tool presented in FIG. 7, the user can simply move “the cross” so as to be positioned over the correct row header and column header, and then click to directly select the correct cell. In addition, the tool allows to quickly double-check the selected position by moving his or her eyes immediately to the row headers and column headers, without having to try to stay in the same row or the same column.

While no objective evaluation tests have been performed, it is expected that the overlay tool can help to improve performance and/or concentration for people working a lot with spreadsheets, and/or that the risk of extracting or inserting information from/into an incorrect cell is dramatically reduced.

The inventors of the present invention are of the opinion that it is not obvious or trivial to come to this solution, taking due account of the fact that more than 100 million people are using spreadsheets every day for almost two decades. If the solution proposed herein would be “obvious”, it would have been widely available already for many years.

Instead of providing a window 883 with fully transparent pixels P5 and two movable objects in the form of a horizontal line 721 and a vertical line 722, the same visual effect can also be implemented in other ways, for example by providing a window plane 883 with a full-screen bitmap having pixels with the color of “the cross” (e.g. red), and by locating on top of this full screen bitmap four other bitmaps, each extending from one of the four corners and having fully transparent pixels, and by adjusting the width and height of each of these four rectangles in accordance with the cursor position 799 or in accordance with movements of the pointer device 703, in order to emulate the cross as the region which is not overlaid by the four rectangular bitmaps; or in other suitable ways.

The computer system of FIG. 3 (with the “LineReader” application) may be helpful when reading textual information, but does not help to reduce eye strain caused by for example a bright white background. The computer system of FIG. 5 (with the “F.Lux” overlay application) may be helpful to reduce eye strain, but does not provide a line or bar to underline text. It would be nice to have a single overlay application offering both features at the same time.

As far as is known to the inventors, there is currently no single computer application tool available on the market providing an overlay that simultaneously (1) allows to reduce the brightness of a bright (e.g. white) background, and (2) that shows a semi-transparent line or semi-transparent cross that follows mouse movements. Initial experiments have shown that a mere combination of the overlay planes shown in FIG. 4 and in FIG. 6 does not yield acceptable results, as may be appreciated from FIG. 13(d) to FIG. 13(e), because of conflicting requirements. Indeed, in order for the text information of the underlying document to be easily readable (e.g. maintaining sufficient contrast), the transparency level of the third window 883 needs to be sufficiently high (e.g. T>=80% or α<=20% in FIG. 13(d) to FIG. 13(e)). At the same time, in order for the line to be easily recognizable while allowing text underneath the line to be readable, the transparency level of the third window 883 needs to be sufficiently low (e.g. T in the range from 30% to 70%). The exact numbers are debatable, but the skilled reader will agree (after implementing the above method on a computer) that no acceptable or attractive combination can be found, or at least that such solution is a severe compromise.

There exists a need for a method to simultaneously reduce the brightness of a bright background and show a semi-transparent line or semi-transparent cross that follows mouse movements. The combination should be achieved in such a way that (1) text information maintains good readability, not only text information being overlaid by the line, but also text information not being overlaid by the line, and (2) the semi-transparent line can be easily distinguished from the background, yet is sufficiently transparent for maintaining readability of the text underneath the line.

The present application addresses this need by providing both a high level of transparency (high T, low α) for the (e.g. full screen) bitmap, and at the same time a low level of transparency (low T, high α) for the line, by “perforating” the bitmap, for example as illustrated in FIG. 10 and FIG. 29. By a “perforated bitmap” is meant a bitmap having a first plurality of pixels P6 which are fully transparent (e.g. have a pseudo-color value), and having a second plurality of pixels P7 which have one or more real color values. The pixels P7 will be alpha-blended with underlying layers. As may be appreciated from FIG. 13(f) to FIG. 13(i) this combination provides functional results for almost all transparency levels from 5% to 95% and almost any color or intensity of the pixels P7, but a preferred result is achieved for transparency levels from about 30% to about 70%. Depending on the intended use, a user may configure the transparency level to a more preferred level.

The combination of the two features “semi-transparent line to underline textual information to lower cognitive burden” and the “semi-transparent bitmap to change the color temperature to reduce eye strain”, when combined create a technical challenge related to “how to combine a semi-transparent bitmap and a semi-transparent line such that the transparency level of the bitmap is higher than the transparency level of the line”. This presents a technical problem related to image overlaying, mixing of images, semi-transparency, and alpha-blending, which is a problem rooted in computer technology, and the solution proposed by the present invention (using a “perforated” bitmap) is also rooted in computer technology. This technology can be used for “easy reading textual information on screen with less eye strain”.

It is furthermore noted that it is not the overlay application that generates or renders textual or alphanumerical information, but the one or more underlying application(s), e.g. a text editor, a spreadsheet, a web-browser etc. Hence, the method of overlaying does not present “information”.

Even though the overlay application can be executed on a standard computer with a standard O/S (for example Windows 10 from Microsoft corporation), the solution proposed herein provides a technical effect related to two different transparency levels in a single semi-transparent window, which effect is not “standard” at all, and goes far beyond mere electrons flowing through a transistor. In addition, at least part of the functionality can be implemented in software on the Central Processing Unit(s) of the computer system, or at least part of the functionality can be implemented in a Graphics Processing Unit, when present in the computing device, in particular the alpha-blending operation, and/or time-multiplexing as will be described further when discussing FIG. 28.

FIG. 9 shows a schematic block diagram of a computer system 900 according to an embodiment of the present invention. The computer system 900 comprises a computer device 901, and a keyboard device 902 and a pointer device or position device 903 (e.g. a mouse device or a touchpad or a joystick or a stylus) and a display 904 connected to said computer device 901.

The computer device 901 comprises a storage device or a memory device (not shown) containing an operating system O/S with a graphical user interface GUI (for example Windows XP or Windows NT or Windows 10), and at least one application selected from the group consisting of: a web browser application, a spreadsheet application, a PDF document viewer, a PDF document editor, a text viewer and a text editor. Instead of being stored inside the computer device itself, the O/S and/or the at least one application may be downloadable from a server, e.g. via a network interface. (this also applies to other embodiments of the present invention).

The computer device 901 further comprises an overlay application that shows a semi-transparent overlay window 1083 comprising at least two semi-transparent elements: i) a so called perforated bitmap 930 occupying a major portion of the overlay window 1083, and ii) a block or a line 910 occupying only a minor portion of the overlay window 1083. The line 910 is movable in accordance with movements of the input device 903. Instead of being stored inside the computer device itself, the overlay application may be downloadable from a server, e.g. via a network interface.

The overlay window 1083 is configured in click through mode and in semi-transparency mode with a predefined or adjustable alpha-blending value α.

The bitmap 930 contains a first plurality of pixels P6 which are “fully transparent”, and a second plurality of pixels P7 having a color value that will be alpha-blended with the graphical image formed by the stack of underlying windows (in the example window 1081 and 1082). In preferred embodiments, the first plurality of pixels P6 are interleaved with the second plurality of pixels P7, in a checkerboard pattern, as shown in FIG. 10 (see also FIG. 29). Thus preferably 50% of the pixels are fully transparent, while the other 50% are semi-transparent. The effect of using this “perforated bitmap” is that the spatially averaged color of the bitmap has a seemingly higher level of transparency than would be the case without the perforation. In this way the apparent transparency of the bitmap 930 is made higher than that of the line 910, despite that both are associated to the same window 1083 having only a single alpha-blending value α.

As was the case for the overlay application of FIG. 7, also the overlay application of FIG. 9 typically comes with user-interface, which is rendered in a second, opaque window (not shown in FIG. 10 but see for example FIG. 35). In the embodiment of FIG. 10, the user-interface would typically allow a user to adjust the size (height and/or width) of the line 910, the transparency level α, the color of the pixels P3 of the line 910, the color of the second plurality of pixels P7.

The overlay application, even though one of its windows 1083 is configured in click through-mode, makes sure that the line 910 moves in accordance with movements of the input device 903. This can be accomplished for example by repeatedly requesting the position of the native mouse pointer 999 provided by the operating system (e.g. based on a timer, or based on polling).

Preferably the line 910 is positioned such that the mouse pointer 999 is located near the center of the line, but that is not absolutely required, and the mouse pointer can be slightly offset from this position, e.g. positioned above the line or below the line. Alternatively, the mouse pointer may also be positioned at or near the left end of the line, or at or near the right end of the line. In each case, the overlay application provides a semi-transparent line 910 that moves along with the mouse pointer 999, both of which are visible.

FIG. 10 is a schematic representation of a possible “Z-order” of four windows or image planes 1081-1084 as may be used in the computer system 900 of FIG. 9, to obtain the combined image 909 shown on the display 904 of FIG. 9.

The first window 1081 at Z1 is referred to as the “desktop window”. The second window 1082 at Z2 is associated with application 905 (in the example a text editor application, e.g. MS Word), and renders alphanumerical or textual information 906. A third window 1083 is associated with an overlay application according to an embodiment of the present invention, and has a Z-order Z3 higher than Z2 of the text editor application 905. The “mouse bitmap” 999 or “mouse image plane” is situated in window 1084 at Z4 higher than Z3.

The desktop image in the first window 1081 and the application image in the second window 1082 are typically opaque images. The window 1083 provides a substantially full-screen overlay configured in click-through mode and also configured in semi-transparent mode with a configurable alpha-blending value α. A minor portion of the overlay window 1083 is occupied by pixels P3 with the line color (e.g. red), a major portion is occupied by the “perforated bitmap”, in the example a bitmap having a first plurality of pixels P6 which are fully transparent pixels, and as second plurality of pixels P7 having a predefined constant color. It is noted that such a “perforated bitmap” can be implemented efficiently for example by first generating a small bitmap of for example 64×64 pixels (or 100×100 pixels or any other suitable size), and then copying and/or tiling this small bitmap into the substantially full-screen bitmap 1083, but other ways may also be used. In an alternative embodiment, this functionality may be implemented as a feature in GPU chips, thus requiring only minimal load of the central CPU of the computer device.

The line 910 may be implemented as a pure rectangular region, with or without a border (e.g. a black border), and with or without rounded edges, and with or without rounded corners, and with or without other characteristics (e.g. having a color gradient).

The overlay application of the computer system 900 is ideally suited for reading large amounts of text on screen. In particular, the overlay application can be used to alter the color (or color temperature) of the underlying graphical image, and/or its brightness, which may help to reduce eye strain, and provides a movable line 910 which a user can use to highlight or underline text shown in one or more underlying windows.

In particular embodiments, the color temperature may be altered so as to reduce the amount of blue light. In other embodiments, the color temperature may be altered so as to increase the amount of blue light.

Even though the same alpha-blending value α is used for the line 910 and for the bitmap 930, the bitmap 930 is more transparent than the line, when viewed from a distance at which the eye does not distinguish individual pixels, but spatially averages pixel information.

For completeness, it is noted that other “perforation patterns” were tested (for example where 4 out of 16 pixels are fully transparent, or 12 out of 16 pixels are fully transparent), but the chessboard pattern with 50% fully transparent pixels may be preferred as it appears to provide the best results in terms of least noticeable artefacts.

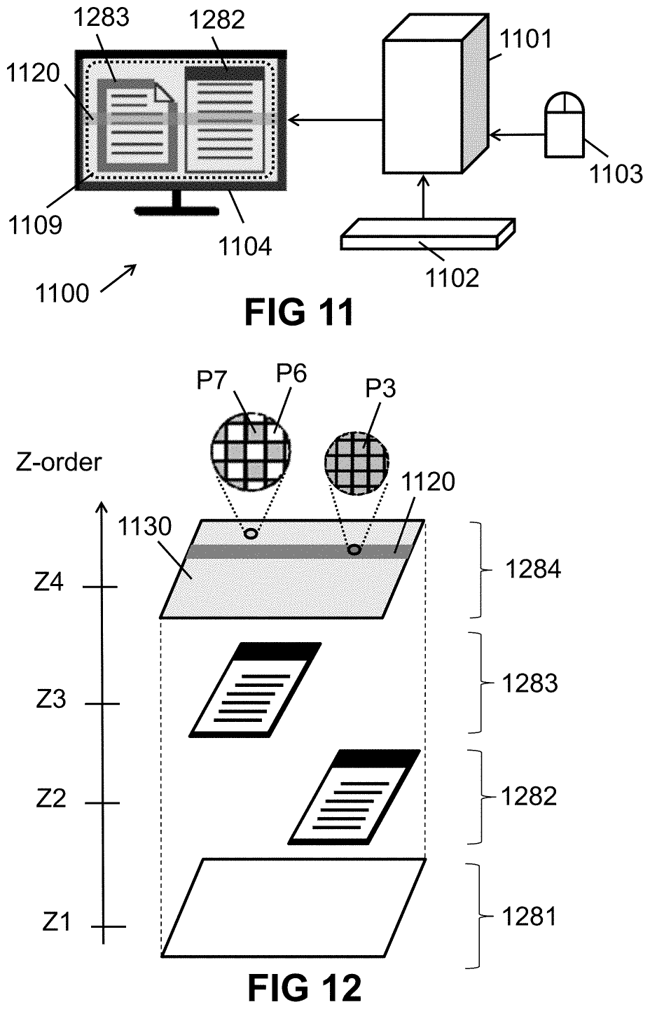

FIG. 11 shows a variant of the computer system of FIG. 9, where the semi-transparent line 1120 of the overlay application extends over substantially the full width of the screen (e.g. over the full width of the pixel area or the full width of the work area of the screen). This implies that the line 1120 only needs to follow vertical movements of the input device 1103, not horizontal movements.

In the example shown, two applications are showing textual information, for example a PDF document viewer on the left side of the screen, and a text editor window on the right side of the screen. This can be used for example when comparing two documents side-by-side, for example when proofreading a translation, where the source text is in the PDF document, and the target text is in the text document. In the example, the window 1282 at height Z2 presents information associated with the text editor application, and the window 1283 at height Z3 presents information associated with the PDF document viewer.

FIG. 12 is a schematic representation of a possible “Z-order” of four windows or image planes 1281-1284 as may be used in the computer system 1100 of FIG. 11, to obtain the combined image 1109 shown on the display 1104 of FIG. 11. The plane for the mouse cursor is not shown, and the plane for the user-interface window of the overlay application (if present) is not shown, in order not to overload the drawings. Preferably however, the color of the pixels P3 and of the pixels P7, and the transparency level α, and the height of the line 1120 are adjustable via a user interface, for example a user interface similar to the exemplary user interface of FIG. 35 without a scrollbar for selecting the width of the line.

FIG. 13 shows a plurality of exemplary screenshots. Each row shows a series of five images corresponding to an “alpha blending value” a of 100%, 80%, 60%, 40% and 20% respectively, corresponding to a “transparency value T” of the overlay window of 20%, 40%, 60%, 80%, 100% respectively, where α=100% or T=0% means that the overlay image is fully opaque (except for fully transparent pixels), and α=0% or T=100% means that the overlay image is fully transparent, and values from 1% to 99% or from 2% to 98% or from 5% to 95% means that the overlay image is semi-transparent, meaning that the overlay image pixels are proportionally mixed with the underlying image pixels (except for fully transparent pixels).

Each of the images shown in FIG. 13(a) to FIG. 13(e) contains a text fragment overlaid by two red lines with color (R,G,B)=(255, 0, 0). Two lines are used for illustrative purposes, to illustrate both “highlighting” and “underlining” of text in the same drawing.

In FIG. 13(a) each text fragment is overlaid by two lines of red color with (R,G,B)=(255, 0, 0). The remainder of the overlay window is fully transparent. This series of images show results similar to what would be obtained by the overlay application of FIG. 3. As can be appreciated, in order to provide a line well suited for highlighting and/or underlining without obscuring the underlying textual information, the transparency level should preferably be in the range from about 30% to about 75%. For lower values of T, the text becomes unreadable. For higher values of T, the line is barely visible. (it is noted that a proper evaluation should be done on a screen rather than on paper, but the paper version allows to understand the principles of the present invention).

In FIG. 13(b) each text fragment is overlaid by a semi-transparent bitmap containing only light grey pixels with (R,G,B)=(192, 192, 192), and in FIG. 13(c) each text fragment is overlaid by a semi-transparent bitmap containing only dark grey pixels with (R,G,B)=(64, 64, 64). These series of images show results similar to what would be obtained by the overlay application of FIG. 5. In order to maintain good readability of the underlying text, the transparency level T should preferably be at least about 85% (or α<=15%).

In FIG. 13(d) each text fragment is overlaid by a “mere combination” of the two red lines as in FIG. 13(a) and by a light gray bitmap as in FIG. 13(b), and in FIG. 13(e) each text fragment is overlaid by a “mere combination” of the two red lines as in FIG. 13(a) and by a dark gray bitmap as in FIG. 13(c).

As described above, if the transparency level T is very low (e.g. <30%), the line is not sufficiently transparent and obscures text underneath; if the transparency level T is medium (e.g. from about 30% to about 70% or about 75%), the line is well visible and sufficiently transparent, but the text is not easily readable; and if the transparency level T is too high (e.g. T>85%) the text is well readable, but the line is nearly invisible. Thus, none of these combinations provides a good solution for both the line and the bitmap.

In FIG. 13(f) each text fragment is overlaid by two red lines as in FIG. 13(a) and by a so called “perforated bitmap” as described above, where 50% of the pixels are fully transparent pixels P6 arranged in a chessboard pattern, and the other 50% of the pixels are light gray pixels P7 with (R,G,B)=(192, 192, 192). As can be appreciated from the drawings (but of course, one should evaluate this on a real screen), very acceptable results for both the line and the bitmap are obtained for transparency levels T from about 30% to about 75%.

In FIG. 13(g) each text fragment is overlaid by two red lines as in FIG. 13(a) and by a so called “perforated bitmap” as described above, where 50% of the pixels are fully transparent pixels P6 arranged in a chessboard pattern, and the other 50% of the pixels are dark gray pixels P7 with (R,G,B)=(64, 64, 64). Again, very acceptable results for both the line and the bitmap are obtained for transparency levels T from about 30% to about 75%.

In FIG. 13(h) each text fragment is overlaid by two red lines as in FIG. 13(a) and by a so called “perforated bitmap” as described above, where 50% of the pixels are fully transparent pixels P6 arranged in a chessboard pattern, and the other 50% of the pixels are black pixels P7 with (R,G,B)=(0, 0, 0). As can be appreciated, the text which is overlaid by the perforated bitmap quite surprisingly remains very well readable, despite that 50% of the bitmap pixels are pure black, thanks to the “perforation”.

In FIG. 13(i) each text fragment is overlaid by two red lines as in FIG. 13(a) and by a so called “perforated bitmap” as described above, where 50% of the pixels are fully transparent pixels P6 arranged in a chessboard pattern, and the other 50% of the pixels are white pixels P7 with (R,G,B)=(255, 255, 255). As can be appreciated, the text which is overlaid by the perforated bitmap quite surprisingly remains very well readable, despite that 50% of the bitmap pixels are pure white, thanks to the “perforation”.

As can be appreciated from all the screenshots in FIG. 13(f) to FIG. 13(i) it can be understood that the color of the non-fully transparent pixels P7 of the perforated bitmap can be varied over a wide range (from pure black to pure white), and is not critical for the readability of the underlying textual information.

Although the inventors do not wish to be bound by any theory, FIG. 14 and FIG. 15 may help to better understand the difference between mixing with a monochrome bitmap versus mixing with a perforated bitmap that contains 50% of fully transparent pixels. On the vertical axis the intensity (I) is shown, the horizontal axis is transparency T or alpha-transparency α, where α+T=100%.

FIG. 14(a) illustrates what happens with a graphical image containing text information containing Original Text pixels OT (black) with color (0, 0, 0) and Original Background pixels OB (white) with color (255, 255, 255) when being overlaid (mixed) with a monochrome bitmap (as in FIG. 6) containing 100% of black pixels with color (0, 0, 0), for various values of the transparency T or alpha-blending value α.

In general, the result of overlaying or mixing two bitmaps is a color with the following color components:

(Rm,Gm,Bm)=(R1,G1,B1)×(1−T)+(R2,G2,B2)×T [1]

where Rm,Gm,Bm are the color components of pixels of the resulting image (the mixed image), T is the transparency level, (R1,G1,B1) is the color of a pixel from the first (overlay) bitmap, and (R2,G2,B2) is the color of a pixel from the second (underlying) bitmap.

When mixing with a black monochrome bitmap, then (R1,G1,B1)=(0, 0, 0).

If T=100% then originally white background pixels OB (255, 255, 255) and originally black text pixels OT (0, 0, 0) remain unchanged after mixing.

If T=50% then originally white background pixels OB (255, 255, 255) become gray pixels MB (127, 127, 127) apart from rounding errors, and originally black text pixels remain black MT (0, 0, 0).

If T=0% then originally white background pixels OB (255, 255, 255) and originally black text pixels OT (0, 0, 0) both become black (0, 0, 0).

This is more or less visualized by the series of FIG. 13(c), except that in FIG. 13(c) the monochrome bitmap has pixels P4 with color (64, 64, 64) rather than (0, 0, 0).

FIG. 14(b) illustrates what happens with a graphical image containing text information containing Original Text pixels OT (black) with color (0, 0, 0) and Original Background pixels OB (white) with color (255, 255, 255) when being overlaid (mixed) with a monochrome bitmap (as in FIG. 6) containing 100% of white pixels with color (255, 255, 255), for various values of the transparency T or alpha-blending value α.

The same mixing formula [1] applies, but now (R1,G1,B1)=(255, 255, 255).

If T=100% then white pixels (255, 255, 255) and black pixels (0, 0, 0) remain unchanged after mixing.

If T=50% then white pixels (255, 255, 255) remain white (255, 255, 255), and black pixels (0, 0, 0) become gray pixels (127, 127, 127) apart from rounding errors.

If T=0% then white pixels (255, 255, 255) and black pixels (0, 0, 0) become (255, 255, 255).

This is more or less visualized by the series of FIG. 13(b), except that in FIG. 13(b) the monochrome bitmap has pixels P4 with color (192, 192, 192) rather than (255, 255, 255).

FIG. 15(a) illustrates what happens with a graphical image containing text information containing Original Text pixels OT (black) with color (0, 0, 0) and Original Background pixels OB (white) with color (255, 255, 255) when being overlaid (mixed) with a perforated bitmap (as in FIG. 10 or FIG. 12) containing 50% of fully transparent pixels P6, and 50% of black pixels P7 with color (0, 0, 0), for various values of the transparency T (or alpha-blending value α).

In general, the result of overlaying or mixing with a perforated bitmaps having 50% of fully transparent pixels P6 is:

(Rm,Gm,Bm)=(R1,G1,B1)×(1−T)+(R2,G2,B2)×T [2]
if the overlay-pixel is not fully-transparent, which is the case for the pixels P7,

(Rm,Gm,Bm)=(R2,G2,B2) [3]
if the overlay-pixel is fully-transparent, which is the case for the pixels P6, thus on average (if the number of pixels P6, P7 is 50% each):

(Rm,Gm,Bm)=50%*[(R1,G1,B1)×(1−T)+(R2,G2,B2)×T]+50%*(R2,G2,B2) [4]

where Rm,Gm,Bm are the color components of pixels of the resulting image (the mixed image), T is the transparency level, (R1,G1,B1) is the color of a pixel from the first (overlay) bitmap, and (R2,G2,B2) is the color of a pixel from the second (underlying) bitmap.

Specifically, when mixing with a perforated black bitmap having 50% fully-transparent pixels P6 and 50% of black pixels P7, then (R1,G1,B1)=(0, 0, 0).

If T=100% then white pixels (255, 255, 255) and black pixels (0, 0, 0) remain unchanged.

If T=50% then white pixels (255, 255, 255) become gray pixels (191,191,191) on average, and black pixels remain black (0, 0, 0).

If T=0% then white pixels (255, 255, 255) become gray pixels (127,127,127) 011 average, and black pixels (0, 0, 0) remain black (0, 0, 0).

This is more or less visualized by the series of FIG. 13(h), if the two lines are omitted.

FIG. 15(b) illustrates what happens with a graphical image containing text information containing Original Text pixels OT (black) with color (0, 0, 0) and Original Background pixels OB (white) with color (255, 255, 255) when being overlaid (mixed) with a perforated bitmap (as in FIG. 10) containing 50% of fully transparent pixels P6, and 50% of white pixels with color (255, 255, 255), for various values of the transparency T or alpha-blending value α.

The same formulas [2] to [4] apply.

When mixing with a perforated white bitmap having 50% fully-transparent pixels P6 and 50% of white pixels P7, then (R1,G1,B1)=(255, 255, 255).

If T=100% then white pixels (255, 255, 255) and black pixels (0, 0, 0) remain unchanged.

If T=50% then white pixels (255, 255, 255) remain white, and black pixels become (64, 64, 64) on average.

If T=0% then white pixels (255, 255, 255) remain white, and black pixels become gray pixels (127,127,127) on average.

This is more or less visualized by the series of FIG. 13(i), if the two lines are omitted.

Thus, FIG. 14 may help to understand what happens with black text on a white background when being overlaid by a monochrome (non-perforated) bitmap, as is the case for the movable object, and FIG. 15 may help to understand what happens with black text on a white background when being overlaid by a perforated bitmap.

The following paragraph explains what happens with black text on a white background when being overlaid by a red “line”. The same formula [1] applies, but now (R1,G1,B1) is (255,0,0).

### FIRST EXAMPLE

As a first example, the colors of the image fragment of FIG. 13(e) for T=80%, are calculated.

The original image comprises: black text (0, 0, 0) on a white background (255, 255, 255).

The overlay window comprises a (non-perforated) monochrome bitmap with black pixels (0, 0, 0), and a line with red pixels (255,0,0), and mixing is done with T set to 80%. Using formula [1], it can be calculated that:
white background pixels overlaid by the black overlay bitmap become: (204, 204, 204),
black text pixels overlaid by the black overlay bitmap become: (0, 0, 0),
white background pixels overlaid by the red line become: 80%*(255, 255, 255)+20%*(255, 0, 0)=(255, 204, 204), which is very hard to distinguish from (204, 204, 204),
the black text pixels overlaid by the red line become: 80%*(0, 0, 0)+20%*(255, 0, 0)=(51, 0, 0).

### SECOND EXAMPLE

As a second example, the colors of the image fragment of FIG. 13(h) for T=60%, are calculated.

The original image comprises: black text (0, 0, 0) on a white background (255, 255, 255).

The overlay comprises a perforated bitmap with 50% fully transparent pixels P6 and 50% of black pixels P7 (0, 0, 0), and a line with red pixels (255, 0, 0), and mixing is done with T set to 60%. Using formulas [1] to [5], it can be calculated that:
white background pixels overlaid by the perforated bitmap become (204, 204, 204) on average, namely (255, 255, 255) for pixels overlaid with fully transparent pixels P6, and (153, 153 ,153) for the pixels overlaid by a black pixel P7;
black text pixels overlaid by the black overlay bitmap become: (0, 0, 0),
white background pixels overlaid by the red line become: 60%*(255, 255, 255)+40%*(255, 0, 0)=(255, 153, 153), which can be easily distinguished from (204, 204, 204),
the black text pixels overlaid by the red line become: 60%*(0, 0, 0)+40%*(255, 0, 0)=(102, 0, 0).

Comparison of the first and second example (or the sample of FIG. 13(e) for T=80% and the sample of FIG. 13(h) for T=60%) learn that:
in both cases black text on a white background becomes (0, 0, 0) on an average background color of (204, 204, 204);
in the case of a non-perforated bitmap, text overlaid by the red line becomes (51, 0, 0) on (255, 204, 204) which text is well readable, but the line is very hard to distinguish from the background of (204, 204, 204), and therefore not very helpful for underlining purposes,
whereas in the case of the perforated bitmap, text overlaid by the red line becomes (102, 0, 0) on (255, 153, 153), which text is still very much readable, but in addition, the line can easily be distinguished from the average background of (204, 204, 204).

Tests have shown that (for the settings of FIG. 13(h), meaning: a perforated bitmap with 50% of fully-transparent pixels and 50% of pure black pixels, arranged in a chessboard-pattern), very good results are also obtained for many other line colors besides pure red, for example a black line with color (0, 0, 0), a blue line with color (0, 0, 255), a dark red line with color (128, 0, 0), a dark blue line with color (0, 0, 128), a dark green line with color (0, 50, 0), a dark teal line with color (0, 51, 102), a green line with color (0, 128, 0), etc., in fact for most relatively dark lines, but also for most relatively bright lines, e.g. a yellow line with color (255, 255, 0), a bright green line with color (0, 255, 0), a turquoise line with color (0, 255, 255), a light gray line of (192, 192, 192) etc. Preferably the line color can be selected by the user via a user-interface, allowing the user to select from a plurality of suitable colors which yield good results.

While the examples in FIG. 13 are provided for an overlay bitmap (perforated or not perforated) having black, dark gray, light gray or white pixels, the invention is not limited thereto, and the invention also works when these pixels are not grayscale pixels, but for example are bluish pixels or yellowish pixels (e.g. with color (81, 69, 44) or (83, 69, 40) or (86, 69, 35) etc.) or reddish pixels, or actually any other color. In this way the originally white background color can be transformed into a bluish or yellowish or reddish, . . . background, which may be more enjoyable to read. In particular, yellowish pixels tend to provide a paper-like view, especially when combined with a texture bitmap (see further), and bluish pixels tend to provide a sky-like or day like view, etc., both for the perforated bitmap and the non-perforated bitmap. This technique can for example also be used to reduce the “blue light” content emitted by the display, which according to some sources, may influence the sleep of the user.

FIG. 16 to FIG. 18 show three examples of a somewhat larger text fragment, allowing a better understanding of how a reader would see the textual information on a screen.

FIG. 16 is a screenshot of a text fragment extracted from U.S. Pat. No. 6,333,753B1, presented by a PDF viewer called “Nuance PDF Reader”, the document being scaled to 200% in the PDF viewer, rendered on a display having a native resolution of 3840×2160 pixels, configured at a resolution of 2560×1440 pixels, and the text and apps being scaled at 100% in Windows screen settings. FIG. 17 to FIG. 18 is a screenshot of the same text fragment, but overlaid by an overlay application according to the present invention.

FIG. 16 shows an exemplary text fragment containing black text on a white background. In fact, many applications do not render textual information as pure black pixels, but also use grayscale pixels, especially near the edges of the alphanumerical characters. This aspect is known, but is not particularly relevant for the present invention.

FIG. 17 shows the text fragment of FIG. 16 overlaid by an overlay window containing a blue line segment containing pixels having the color (R,G,B)=(0, 0, 255), and with the transparency level T of the overlay-window set to 50%. The transparency level T only has an influence on the transparency of the line, not on the fully transparent overlay pixels. Such image can probably also be obtained by the “LineReader” application, as discussed in FIG. 3 and FIG. 4.

FIG. 18 shows the text fragment of FIG. 16, overlaid by a method according to an embodiment of the present invention, as described in FIG. 9 and FIG. 10. The alpha-blending value is 50%, a minor portion of the overlay image being occupied by a blue line segment with color value before mixing of (R,G,B)=(0, 0, 255), a major portion of the overlay window being occupied by a perforated bitmap, this bitmap having 50% of pure transparent pixels P6 and 50% of gray pixels P7 with color value before mixing of (R,G,B)=(128, 128, 128) arranged in a 2×2 checkerboard pattern. As can be appreciated from FIG. 18, the resulting textual information is easy to read, the line can help the user to stay focused, and the line can easily be distinguished from the background.

However, the inventors went one step further, and also experimented with overlaying textures (perforated or not perforated). Tests have shown that overlaying with certain textures can transform a pure white background (which looks glossy) into a matte background, which may be much more enjoyable to read. In one experiment, a picture was taken of a “foggy sky”, a subpicture was extracted, a horizontal and vertical gradient was removed, the average color was adjusted, the contrast between the brightest pixels and the darkest pixels was adjusted, and the subpicture was tiled as a semi-transparent overlay over the screen, to yield surprisingly good results, in particular in that it seemingly removes the glossy white background of most text documents, and replaces it with a matte background, while the text remains surprisingly well readable.

If no semi-transparent line or cross is added in the overlay (e.g. for underlining text to be read, or for indicating the position of a cell in a table or spreadsheet), then good results can be obtained by choosing a relatively high transparency value (e.g. Tin the range from about 80% to 99% for a non-perforated bitmap, or T in the range from about 60% to 99% for a perforated bitmap).

If a line or cross is added in the overlay window, then it may be best to perforate the bitmap, as described above. Surprisingly, even with a 50% perforation, the texture pattern can be made quite visible, and aesthetically attractive results can be achieved. However, tests have shown that a single texture bitmap may not be suitable for all transparency levels, unless some modification is done to the pixel values. In both cases (perforated or not), the contrast of the texture bitmap is preferably adjusted or tuned as a function of the transparency level T or alpha-transparency level α of the overlay window.

In preferred embodiments, the transparency level T of the overlay window is selectable or adjustable by the user, and the contrast level of the texture bitmap is automatically adjusted as a first or second order polynomial of the transparency level T. The value of the contrast itself is not critical (it may typically vary from about 0.5 times an optimum value to about 2.0 times the optimal value), but it is important that this value is not fixed, but can be adjusted when the transparency of the overlay window is varied, otherwise the texture may be too pronounced and disturbing for the reader, or nearly invisible and looking nearly the same as a monochrome color overlay. Of course, it would also be possible to use multiple texture bitmaps in the overlay application, but that consumes more memory space, and can be avoided.

The inventors have found that good results, e.g. near-optimal results are obtained when the contrast is adjusted in such a way that the texture or pattern is barely visible, or slightly above “barely visible”. If the contrast level is chosen below this ideal value range, a white background is converted into a glossy (e.g. shiny plastic like) background without the texture or pattern being noticeable. If the contrast level is chosen above this ideal value range, the pattern or texture becomes dominant, and may distract the user. However, if the contrast level is chosen within the ideal value range, the pattern or texture will cause a small variation of the background color, which is seen or experienced as a texture or pattern or matte color, and even seems to increase the sharpness of the text characters underneath. The ideal value range may be different for each pattern bitmap, and is preferably also tunable by the user, in addition to the automatic adjustment related to the transparency value T.

FIG. 19 shows a schematic block diagram of a computer system 1900 according to an embodiment of the present invention, which can be seen as a variant of the computer system of FIG. 10 and the computer system of FIG. 12. Most of what has been described above is also applicable here, except that the overlay image of the computer system 1900 of FIG. 19 comprises at least two semi-transparent elements: i) a non-perforated line 1910, and ii) a “perforated texture bitmap” 1930. The line 1910 is movable in accordance with movements of the input device 1903.

The perforated texture bitmap can be derived from a predefined texture bitmap (see for example FIG. 27), by assigning to half of the pixel locations a pseudo-color value corresponding to a predefined fully-transparency value, these are the pixels P6, and by optionally changing the average color of the other pixels P8, optionally adjusting the contrast of the pixels P8, and optionally tiling said bitmap to fill the area of the overlay window 2083.

FIG. 20 is a schematic representation of a “Z-order” of four windows or image planes 2081-2084 as may be used in the computer system of FIG. 19.

FIG. 21 shows a schematic block diagram of another computer system 2100 according to an embodiment of the present invention, which computer system contains an overlay application for providing an overlay window comprising at least one semi-transparent object in the form of a so called “perforated texture bitmap” with a first plurality of fully transparent pixels P6 and a second plurality of opaque or semi-transparent pixels P8. This embodiment is a variant of the embodiment of FIG. 21 where the line 1910 is omitted.

FIG. 22 is a schematic representation of a “Z-order” of four windows or image planes 2281-2284 as may be used in the computer system of FIG. 21. As described above, the overlay application may also have a second, opaque user-interface window (not shown), where a user can select an average color of the pixels P8, and/or may adjust the alpha-transparency value α, and/or may manually adjust a contrast of the texture bitmap, and/or select a texture bitmap from a list of texture bitmaps.

FIG. 23 shows a schematic block diagram of another computer system 2300 according to an embodiment of the present invention, which computer system contains an overlay application for providing an overlay window comprising at least one semi-transparent object in the form of a so called “non-perforated texture bitmap” consisting of a plurality of semi-transparent pixels P8. This embodiment is a variant of the embodiment of FIG. 23 where the fully transparent pixels P6 are omitted.

FIG. 24 is a schematic representation of a “Z-order” of four windows or image planes 2481-2484 as may be used in the computer system 2300 of FIG. 23.

As can be appreciated from FIG. 14 and FIG. 15, embodiments with an overlay application with a perforated texture bitmap (illustrated in FIG. 21 and FIG. 22) for a transparency level T in the range from 0% to 100% on the one hand, and embodiments with an overlay application with a non-perforated texture bitmap (illustrated in FIG. 23 and FIG. 24) for a transparency level T in the range from 50% to 100% on the other hand, provide similar (spatially averaged) results. These embodiments are extremely useful for “converting” a shiny (e.g. plastic-like) background plane into a matt (e.g. paper like) background plane, which is more enjoyable to read.

FIG. 25 shows the text fragment of FIG. 16, overlaid by an overlay image using a transparency level T of 50% (or an alpha-blending value of 50%), a minor portion of the overlay image being occupied by a blue line segment (as in FIG. 16) and a major portion of the overlay window comprising a perforated texture bitmap, the bitmap having 50% of pure transparent pixels and the other 50% of pixels forming a texture bitmap with an average color value of (R,G,B)=(128, 128, 128). Thus, the resulting overlaid image has an average color of about (224, 224, 224). Comparison of FIG. 25 and FIG. 18 provides an example of the difference between an overlay with a perforated monochrome bitmap, and an overlay with a perforated texture bitmap. This overlay image can be created by the computer system 1900 of FIG. 19.

FIG. 26 shows an example of an overlay image as can be generated by the computer system of FIG. 23, using a non-perforated texture bitmap having an average color of about (61, 61, 61), and using a transparency level of T=80%, resulting in an average background color of the overlaid image of about (216, 216 ,216). Comparison of FIG. 26 and FIG. 25 demonstrates that using a perforated bitmap does not or does not significantly detoriate the image quality and thereby the readability of the textual information.

FIG. 27 shows the exemplary texture bitmap that was used to generate the image of FIG. 25, before color adjustment, contrast adjustment and perforation. In this example, the texture bitmap was a grayscale image, but the invention is not limited thereto, and colored texture images can also be used.

Experiments have shown that the texture bitmap can easily be transformed into another texture bitmap having a desired color (Rnew,Gnew,Bnew) by treating each of the color components individually, for example using the following formulas or equivalent formulas:

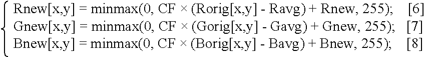

where Rnew[x,y] is the Red component of the pixel of the new texture bitmap at position (x,y); and Rorig [x,y] is the Red component of the pixel of the original texture bitmap at position (x,y); and CF is the Contrast Factor (CF=1 means: no contrast enhancement, CF<1 means decreasing the contrast, CF>1 means increasing the contrast); Ravg is the average Red color component, Gavg is the average Green color component, and Bavg is the average Blue color component of the original texture bitmap; and wherein “minmax(a,b,c)” is a function providing the result b clipped to the range from a to c, thus returning the value b unless b<a in which case a is returned, or unless b>c in which case c is returned. CF is a floating point number, but the result of each formula is converted to an integer value from 0 to 255 (also referred to as “byte”).

CF may be calculated using one of the following formula, or an equivalent formula:

CF=K+L×T; [9] or

CF=M+N×T+Q×(T×T) [10]

where K, L, M, N, Q are predefined constants, which may be dependent on the specific texture bitmap chosen, and T is the transparency level of the overlay window.

Stated in simple terms, these formulas can be used to shift a histogram of the pixel values of the texture bitmap upwards or downwards (for example from Ravg to Rnew), and can broaden or narrow the “width” of the histogram characteristic.

FIG. 28 schematically illustrates how overlaying with a “perforated bitmap”, for example a “perforated monochrome bitmap” or a “perforated texture bitmap”, which is repeatedly shifted back and forth over a distance of one single pixel, can be used for time-multiplexing or time-averaging, in addition to spatial averaging.

FIG. 28 (at time t1) shows a pattern consisting of four pixels, two of which pixels are fully transparent pixels P6, the other two pixels being color pixels that are opaque or will be alpha-blended. This pattern of 2×2 pixels is typically repeated (“tiled”) over the entire overlay bitmap.

FIG. 28 (at time t2) shows a pattern similar to that of FIG. 28 (at time t1), but wherein other pixel locations are fully transparent.

It is interesting to note that the pattern of FIG. 28 (at t2) can be obtained by a mere shift of the bitmap of FIG. 28 (at t1) by 1 pixel up, or 1 pixel left, or 1 pixel right, or 1 pixel down. Thus, if the overlay bitmap is deliberately chosen to be 1 pixel wider and/or 1 pixel higher than the width W and the height H of the overlay window, and if the overlay bitmap is shifted by 1 pixel position back and forth every frame, or every two frames, or every three frames, the underlying image is overlaid in a “time multiplexed manner”. If the multiplexing rate is sufficiently high (for example at least 15 Hz or at least 20 Hz or at least 25 Hz or at least 30 Hz), time-multiplexing may reduce visual artefacts caused by overlaying with the perforated bitmap. If the multiplexing rate is poor (for example less than 10 Hz), pixels at edges may seem to swirl.

It is also possible to use two separate bitmaps, each of size W×H, and alternatingly alpha-blending with one or the other bitmap, but such implementation would require more memory, and more time to create the two bitmaps, and is therefore not preferred.

FIG. 29 and FIG. 30 are added for completeness, to show that the principles described above still work, despite further image processing beyond the overlay application itself. Experiments have shown that the “screen resolution” and the “scaling factor” or “zoom factor” for text and apps selected in the computing device also influence how the final image will appear. Two specific examples are shown here, in FIG. 29(a)-(c) on the one hand, and FIG. 30(a)-(c) on the other hand. p FIG. 29(a) shows a screenshot of the same image as was used in FIG. 18 (with a perforated monochrome bitmap overlay), but with 2 lines, rendered on a display device having a native resolution of 3840×2160 configured at a resolution of 2560×1440, with a scaling factor (or zooming factor) for text and apps of 100%, as can for example be selected in the “screen resolution” dialog box in case of the Windows 10 operating system.

FIG. 29(b) shows the image of FIG. 29(a), zoomed in by a factor of about 350%. In this image, individual pixels can be distinguished. The checkerboard pattern becomes visible, but the text remains very well readable.

FIG. 29(c) shows a portion of the image of FIG. 29(b), zoomed in further by a factor of about 200%, hence in total zoomed in by a factor of about 700%. In this image the effect of overlaying with a perforated bitmap having 50% of fully transparent pixels, and 50% of semi-transparent pixels is clearly visible. It was quite surprising to the inventors that the individual pixels are not, or not significantly noticeable in FIG. 29(a), even though they are actually there.

FIG. 30(a) shows the same image of FIG. 29(a), rendered on a display device having a native resolution of 3840×2160 configured at a resolution of 2560×1440, but with a scaling factor (or zooming factor) for text and apps of 125%, as can for example be selected in the “screen resolution” dialog box in case of the Windows 10 operating system.

FIG. 30(b) shows the image of FIG. 30(a), zoomed in by a factor of about 350%. In this image, individual pixels can be distinguished, but the checkerboard pattern is less pronounced.

FIG. 30(c) shows a portion of the image of FIG. 30(b), zoomed in further by a factor of about 200%, hence in total zoomed in by a factor of about 700%. In this image the effect of overlaying with a perforated bitmap having 50% of fully transparent pixels, and 50% of semi-transparent pixels is no longer clearly visible, but instead, a pattern of 5 by 5 pixels seems to be added to the image, probably due to filtering related to the zooming, performed outside of the overlay application, but inside the computer device, since a screenshot can be taken.

Again, the individual pixels are not, or not significantly noticeable in FIG. 30(a), even though they are actually there. The text of FIG. 30(a) is very well readable, and the line is easily distinguishable from the background.

It seems to be a matter of taste which one of the two images, that of FIG. 29(a) or that of FIG. 30(a) is “the best”. The image of FIG. 29(a) seems somewhat sharper, that of FIG. 30(a) seems to have some “ripple” or “pattern” due to the combined effect of the perforation followed by filtering, which is also aesthetically attractive, as it gives the impression of a “matte” background. In each case, both images provide a text that is easily readable, both text on the background as well as text under the line, and in both cases the line is easily distinguishable from the background, and in both cases the average brightness of the white background is reduced, which may cause less eye strain.

Experiments with other scaling factors for text and apps (in particular 150%, 175%, 225%, 250%, 350%) show results similar to that of FIG. 30(a) to FIG. 30(c), while scaling factors of 200% or 300% tend to provide results similar to that of FIG. 29(a) to FIG. 29(c).

FIG. 31 shows a flowchart of a computer-implemented method according to some embodiments of the present invention. This method is performed by a computer system of FIG. 9, FIG. 11, FIG. 19, FIG. 21, FIG. 36 and FIG. 38.

In step 3101 an overlay window is provided.

The overlay window may be configured as an opaque window, meaning that this window can have non-transparent pixels and/or fully transparent pixels but not semi-transparent pixels.

Alternatively, the overlay window may be configured as a semi-transparent window having an alpha-transparency α in the range from 1% to 99% or from 2% to 98% or from 5% to 95%, meaning that his window can have fully transparent pixels and/or semi-transparent pixels but not completely opaque pixels.

In step 3102, at least one visible object is provided in said overlay window, the at least one visible object comprising a bitmap having a first plurality of pixels P6 which are fully transparent pixels, and a second plurality of pixels P7, P8 which are opaque pixels or semi-transparent pixels (thus not fully transparent pixels); and wherein the first plurality of pixels P6 and the second plurality of pixels P7, P8 are interleaved, for example arranged according to a checkerboard pattern.

In step 3103 the overlay window is configured in click-through mode.

Step 3103 may be performed before step 3102.

In an embodiment, the overlay window is configured as an opaque window, and the second plurality of pixels P7, P8 are opaque pixels.

In another embodiment, the overlay window is configured as a semi-transparent window, and the second plurality of pixels are semi-transparent pixels.

With “configured in click-through mode” is meant that the operating system O/S is informed that input messages (e.g. caused by mouse and keyboard events) are to be sent to one or more applications being overlaid or to components thereof, rather than to the overlay application itself. Or more correctly, if the overlay application contains for example two windows, one user-interface window which is not configured in click-through mode and another window configured in click-through mode, then the O/S will send mouse events to the user interface window if the mouse is present over the UI-window, and to the one or more underlaying applications if the mouse is present over the click-through window but not the user-interface window.

FIG. 32 shows a flowchart of a more specific method 3200 according to a preferred embodiment of the present invention. This method is performed by a computer system of FIG. 9, FIG. 11, FIG. 19, FIG. 36 and FIG. 38.

In step 3201 an overlay window is provided, and configured as a semi-transparent window having an alpha-transparency α in the range from 1% to 99% or from 2% to 98% or from 5% to 95% or from 10% to 90% or from 20% to 80% or from 30% to 70%.

In step 3202 at least one visible object (e.g. a horizontal line) is provided in the overlay window, occupying only a minor portion (e.g. less than 20% or less than 10%) of the area of the overlay window. For example, if the overlay window has a width W and a height H, the first object can for example be a short horizontal line having a length smaller than W/2 and a height smaller than H/10, thus occupying an area smaller than W×H/20; or can for example be a horizontal line extending over the entire width W of the overlay window, and having a height smaller than H/10, thus occupying an area smaller than W×H/10.

In step 3203 a bitmap, or an object with a bitmap is provided, which bitmap has a first plurality of pixels P6 which are fully transparent, and a second plurality of pixels P7, P8 having a color value to be alpha blended with pixels of one or more underlying windows. The second plurality of pixels P7 may all have the same colour (perforated monochrome bitmap), or they may have different colours. The colors may form a color gradient, or may form a texture bitmap. The first and second plurality of pixels are interleaved, for example according to a fixed pattern, for example a chessboard pattern. The bitmap may be located on top of the visible object.

In step 3204 the overlay window is configured as a so-called click through window. The operating system will send input events such as mouse clicks and mouse movements to the one or more underlying windows (or to the desktop window).

In step 3205, position information X,Y of a so-called “mouse pointer” or “mouse cursor” is obtained, for example in the form of screen coordinates. The mouse cursor position can for example be requested from the operating system, for example in the case of the Windows O/S using the function “GetCursorPos”. It is an advantage to use these coordinates because it allows to align or position the at least first visible object relative to the mouse cursor. Alternatively, movement information or displacement information dx, dy can be obtained from the operating system in the form of raw input messages, for example by configuring the Operating System to send raw input messages, and by configuring the overlay application to receive and process raw input messages. This aspect is explained in more detail in patent application BE2017/5895, filed by the same applicant on 4 Dec. 2017, with title “METHOD AND DEVICE AND SYSTEM FOR PROVIDING DUAL MOUSE SUPPORT”, which document is incorporated herein by reference in its entirety, and is further referred to herein as the co-pending “dual mouse application”. In case of conflict between the present application and the co-pending application, the present document prevails.

In step 3206 a position of the at least one visible object (e.g. the X and Y-position of a short horizontal line, or the Y-position of a large horizontal line) are adjusted in accordance with the obtained mouse cursor position X,Y or in accordance with the movement or displacement information dx,dy.

In case of a small or large cross, the mouse cursor position is preferably located at or near the crossing of the horizontal and vertical line. In case of a small horizontal line, the mouse cursor can be located at the left end or at the right end or in the middle of the horizontal line, or in any other suitable position.

Step 3205 and step 3206 are repeated, for example triggered by a timer event having a period in the range from 1 ms to 200 ms, for example in the range from 2 ms to 100 ms, for example equal to about 5 ms or about 10 ms, or about 16.7 ms (60 Hz), or about 20 ms or about 25 ms or about 30 ms or about 40 ms or about 50 ms or about 100 ms or about 150 ms. This value is not critical. The smaller this value, the faster the overlay application reacts to mouse movements, but the more processing power is required inter alia for drawing the at least one object at intermediate positions during movement of the input device. The skilled person can find a suitable trade-off between fast response time and a reasonable amount of processing power. The overlay application may allow the user to select between at least two predefined values.

FIG. 33 shows a flowchart of another method 3300 according to an embodiment of the present invention. This method is performed by the computer system of FIG. 7 and the computer system of FIG. 38.

In step 3301 an overlay window is provided.

The overlay window may have a bitmap filling substantially the entire area of the window with fully transparent pixels (as shown in FIG. 7 and in FIG. 38), or may comprise a perforated bitmap (as in FIG. 10 or FIG. 12) or a perforated texture bitmap (as in FIG. 20 and FIG. 22) or a non-perforated texture bitmap (as in FIG. 24).

In case the window comprises fully transparent pixels (as shown in FIG. 7 and FIG. 38), the overlay window 883, 3983 may be configured as opaque or as semi-transparent. In case the window comprises a perforated bitmap, the overlay window 883, 3983 is preferably configured as semi-transparent. Preferably the alpha-transparency of the semi-transparent window is a value α in the range from 1% to 99% or from 2% to 98% or from 5% to 95% or from 10% to 90% or from 20% to 80% or from 30% to 70%.

In step 3302 a first visible and movable object is provided in the overlay window having the form of a horizontal line 721, 3821 occupying only a minor portion (e.g. less than 20% or less than 10%) of the area of the overlay window. The horizontal line preferably extends over the entire width of the overlay window, which itself preferably extends over the entire pixel area of the screen, or over the entire work area of the screen.

In step 3303 a second visible and movable object is provided in the overlay window having the form of a vertical line 722, 3822 occupying only a minor portion (e.g. less than 20% or less than 10%) of the area of the overlay window. The vertical line preferably extends over the entire height of the overlay window, which itself preferably extends over the entire pixel area of the screen, or over the entire work area of the screen.

Together the horizontal line and the vertical line form a cross. If the window comprises a bitmap, the lines are located on top of said bitmap, so that they are visible. In the embodiment of FIG. 7, the horizontal line 721 and the vertical line 722 are monochrome lines, for example having a red or blue or black or purple or yellow color, or any other color. In this case, the overlay window is preferably configured as semi-transparent, so that text under the lines 721, 722 is visible. In the embodiment of FIG. 38, the horizontal line 3821 and the vertical line 3822 contain a perforated bitmap. In this case the overlay window 3983 can be configured as semi-transparent or may contain fully transparent pixels.

In step 3304 the overlay window is configured as a so-called click through window, so that the operating system will send keyboard and mouse events to the underlying window(s), despite that the overlay window lies on top of it/them, having a higher Z-order.

In step 3305, position information X,Y of a so-called “mouse pointer” or “mouse cursor” is obtained, for example in the form of screen coordinates.

Alternatively, movement information related to movements of the pointer device can be obtained from the operating system using raw input messages, in which case the processing of the raw input messages and the actual update of the position of the visual object(s) is preferably decoupled from each other, for example as explained in more detail in the co-pending “dual mouse application”.

In step 3306 the position of the movable objects (e.g. the X coordinate of the vertical line, and the Y-position of the horizontal line) are adjusted in accordance with the obtained mouse cursor position X,Y or in accordance with the movement information.

The native mouse cursor position is preferably located at or near the crossing of the horizontal and vertical line.

Step 3305 and step 3306 are repeated, for example using a timer interrupt with a period in the range from 1 ms to 200 ms, for example in the range from 2 ms to 100 ms, for example equal to about 5 ms or about 10 ms, or about 16.7 ms (60 Hz), or about 20 ms or about 25 ms or about 30 ms or about 40 ms or about 50 ms or about 100 ms or about 150 ms.

FIG. 34 shows a simplified high-level block diagram as a possible representation of the software components and hardware components situated in a computer system which typically cooperate when performing a method according to embodiments of the present invention, but it is explicitly pointed out that the present invention is not limited to this implementation, and other implementations may be used as well. The main purpose of this block-diagram is to show a possible implementation of an embodiment implemented in a Windows-compatible computer.

FIG. 34 shows an overlay application 3474 and an operating system or O/S 3460 (for example “MICROSOFT WINDOWS 10” available from Microsoft Corporation of Redmond, Wash., US), a graphics accelerator 3425, output interfaces 3480, a display 3492, an input interface 3410, an input pointing device 3401, and a bitmap generator 3420. Other components include, within O/S 3460, input device drivers 3466 and Graphics API (Application Programming Interface) 3440.

FIG. 34 is very similar to FIG. 8 of U.S. Pat. No. 6,333,753(B1) incorporated herein by reference in its entirety, but especially FIG. 8 thereof and the corresponding description. Since many aspects are already known, they need not be explained in full detail again.

The main similarities of the block diagram 3400 of this document, and the block diagram of FIG. 8 of U.S. Pat. No. 6,333,753(B1) are:

the internal functioning of the video back-end components, the graphics API 3440, and the graphics accelerator 3425 and the output interfaces 3480 can be largely similar to those of the prior art, e.g. the way how “fully transparent pixels” are processed, and the way how alpha-blending is performed.

The main differences between the block diagram 3400 of this document, and the block diagram of FIG. 8 of U.S. Pat. No. 6,333,753(B1) are:

the present invention does not require a mouse with touch sensors, and therefore does not require special device drivers 3466. Instead, classical device drivers, such as for example a standard USB mouse driver can be used;

the overlay application 3474 of the present invention does not use animated “fade-in” and “fade-out”. Optionally, however, “time-multiplexing of the perforated bitmap” may be used as described above (FIG. 28), in which case, a time-multiplex component 3415 is used, which can send new position information of the shifted perforated and/or textured bitmap, for example each frame, or every two frames, or every three frames, or every four frames. The timing is preferably synchronized with the frame rate; in the present invention, the bitmap generator 3420 may generate one or more stationary and/or movable objects, such as for example a small horizontal line, or a small cross (e.g. comprising a small horizontal line and a small vertical line), or a large horizontal line (e.g. extending over the entire width of the overlay window), or a large cross (e.g. comprising a large horizontal line preferably extending over the entire width, and a large vertical line preferably extending over the entire height);

although not shown in FIG. 34, the present invention preferably also provides a user-interface window, an example of which is shown in FIG. 35. The user-interface window is typically implemented as a second, mainly opaque window (it may comprise fully transparent pixels), preferably located (in Z-order) between the overlay window and the mouse cursor plane. Via this user-interface window, the user can for example set or select or change dimensions and/or a color of the horizontal line (pixels P3), and/or set or select the desired transparency level T (or alpha-transparency value α), and/or set or select a color of monochrome pixels (P7) of the overlay bitmap, and/or set or select an average color of pixels of texture pixels (P8), etc. This user-interface window is not configured in click-through mode, because it needs to be able to receive mouse clicks and/or keyboard input, and its area is typically reduced, e.g. minimized during normal use of the graphical overlay application.

Although not shown in FIG. 34, besides the overlay application 3474, the computer device typically also executes one or more application programs, such as for example a word processor, a PDF viewer, a web-browser, a spreadsheet, etc.

The input positioning device 3401, for example a mouse or a touchpad is connected via leads 3403 to input interface 3410, for example a USB-input interface, which processes and/or routes signals from the input device to input device drivers 3466 that form a component within O/S 3460. The device drivers 3466 interpret the signals produced by the pointing device 3401 and, in response, generates appropriate events. In particular, the O/S moves a mouse pointer or mouse cursor in accordance with movements of the device 3401, and passes these events to an application (e.g. a text processor or web browser), since the overlay application 3474 is configured in click-through mode or “pass through mode”.

Bitmap Generator 3420 may Comprise:
a horizontal line generator 3422 for generating at least one horizontal line or bar having a predefined or adjustable shape (e.g. rectangular with sharp edges or with rounded edges) and size (e.g. width and height) and position and look (e.g. as a monochrome bitmap, or having a color gradient, or as a perforated bitmap);
a vertical line generator 3424 for generating at least one vertical line or bar having a predefined or adjustable shape (e.g. rectangular with sharp edges or with rounded edges) and size (e.g. width and height) and position and look (e.g. as a monochrome bitmap, or having a color gradient, or as a perforated bitmap);
a background bitmap generator 3426 for generating a relatively large bitmap, preferably occupying the entire area of the overlay window, for example as a monochrome bitmap (similar to FIG. 6), or as a perforated bitmap having 50% of fully transparent pixels P6 and 50% of monochrome pixels P7 (as in FIG. 10 and FIG. 12), or as a perforated bitmap having 50% of fully transparent pixels P6 and 50% of texture pixels P8 (as in FIG. 20 and FIG. 22), or as a bitmap with 100% fully transparent pixels P5 (as in FIG. 8, FIG. 37 and FIG. 39), or as a bitmap with 100% texture pixels P8 (as in FIG. 24). One or more of these objects may be generated on the fly, optionally with the help of a Graphics API 3440, and/or with the help of a graphics accelerator 3425.

As explained above, in case a semi-transparent window is used as the (first) overlay window, the transparency level T thereof is preferably chosen in the range from 30% to 75% (or the alpha-blending value is preferably chosen in the range from 25% to 70%), such that underlying document objects are well visible (although optionally somewhat darkened or textured) through the overlay window.

In case time-multiplexing is used, (which is entirely optional), the time multiplexing module or process 3415 will issue instructions, preferably one such instruction for every N display frames, (N preferably being equal to 1 or 2 or 3 or 4), to shift the perforated bitmap back and forth over a number of pixels, preferably an odd number of pixels, e.g. 1 pixel up/down or 1 pixel left/right, such that a particular pixel of the underlying document object is alternatingly overlaid by a fully transparent pixel or by a semi-transparent pixel. These instructions will be issued, as schematically represented by line 3430 and/or line 3413 to O/S 3460, which, in turn, may pass these instructions to Graphics API 3440 and ultimately to graphics accelerator 3425.

If a graphics accelerator is not used, then, as symbolized by line 3455, Graphics API 3440 can provide graphics output directly to output interfaces 3480 (specifically a standard video card, not shown, therein) which, in turn, will generate appropriate video signals and apply those signals, via leads 3486, to display 3492. In this instance, computer system 3400 would need to be sufficiently fast to implement the appropriate graphics capabilities, that would have been provided by accelerator 3425, in software.

Although alpha-transparency capability is supported by a wide variety of currently existing graphics accelerators, this capability can be readily simulated in software, in a well-known manner, by conventional 2-D (two-dimensional) or 3-D (three-dimensional) graphics APIs, such as D3D (which is a 3-D graphics API produced by Microsoft Corporation as a component of a WINDOWS operating system, WINDOWS being a registered trademark of Microsoft Corporation), OpenGL (which is currently available in the art) or GDI (which historically is only a 2-D low-level graphics processing layer currently produced by Microsoft Corporation and also incorporated as a standard component of a WINDOWS operating system).

In a variant of the block-diagram of FIG. 34, the overlay application does not request the position of the native cursor position of the operating system, but further comprises a raw input message handler configured for processing raw input messages provided by the operating system, and is adapted for extracting displacement information dx, dy from said event messages, and for moving at least one movable object, and for optionally overruling the native cursor position of the O/S. Although not relevant for understanding the present invention, this aspect is described in more detail in the co-pending “dual mouse application”.

The bitmap generator 3420 may generate one or more image data structures, which can be one or more bitmaps or a set of commands in a language such as Display Postscript or Quickdraw. Regardless of the details, the image data structure must contain sufficient information that it can be rasterized (if not already a bitmap) at the display resolution or otherwise processed for viewing on the display.

FIG. 35 shows an exemplary user-interface window as may be used by an overlay application according to an embodiment of the present invention. This user interface window may be shown as a second, opaque window, on top of the “first” overlay window 883, 1083, 1284, 2083, 2283, 2483, 3783, 3983, or may for example be shown as a very small object (e.g. a rectangular object with a bitmap containing a logo of the overlay application, or with a text field containing the name of the overlay application, and having a size smaller than 150×30 pixels, e.g. smaller than 100×30 pixels), or may be minimized in the taskbar. The overlay application may be adapted for enlarging the user-interface window when the mouse hovers over said bitmap with the logo. In this way the user-interface window is easily reachable, while not occupying a lot of space on the screen.

FIG. 36 shows a schematic block diagram of another computer system 3600 according to an embodiment of the present invention, with a computer device 3601 having an overlay application for providing an overlay window 3783 with a movable object 3610 having a perforated bitmap. The line 3610 is movable in accordance with movements of the input device 3603. This embodiment offers the advantage that the overlay window 3783 can be opaque with most pixels being fully transparent pixels, and still the effect of a semi-transparent line 3610 can be obtained. Such embodiment may be particularly useful in computing devices not having alpha-blending capabilities, such as for example eReader devices.

FIG. 37 is a schematic representation of a “Z-order” of four windows or image planes 3781 to 3784 as may be used in the computer system 3600 of FIG. 36.

FIG. 38 shows a schematic block diagram of another computer system 3700 according to an embodiment of the present invention, with a computer device 3801 having an overlay application for providing an overlay window 3983 with a movable object in the form of a perforated cross. The cross is composed of a horizontal line 3821 and a vertical line 3822, and is movable in accordance with movements of the input device 3803.

FIG. 39 is a schematic representation of a “Z-order” of four windows or image planes 3981-3984 as may be used in the computer system 3800 of FIG. 38.

FIG. 40 shows a schematic block diagram of another computer system 4000 according to an embodiment of the present invention, with an overlay application providing an overlay window 4184 with a movable object in the form of a horizontal line 4020, preferably extending over the entire width of the screen.

The overlay window 4184 is preferably configured as a semi-transparent window, preferably with an alpha transparency in the range from 5% to 95%, or from 30% to 70%, although that is not absolutely required, and the window 4184 can also be configured as opaque, in which case the pixels P5 would be fully transparent pixels.

The overlay window 4184 comprises a semi-transparent line with pixels P3. A major advantage of this overlay application is that the line can be used to highlight or underline corresponding text fragments in two different applications, for example a PDF source text to be translated positioned on the left side of the screen 4004, and an MS-Word target text containing the translated text on the right of the screen 4004. The line 4020 helps to quickly regain context when switching back and forth between the two documents, for example during proofreading, thereby significantly lowering the cognitive burden of the proofreader.

Since the overlay application is configured in click-through mode, the mouse 4099 can be used to click or drag or scroll anywhere on the screen. In particular, it allows the PDF document to be moved slightly upwards or downwards (e.g. by dragging or scrolling) to keep the text fragments therein aligned with corresponding text fragments of the Word-document.

The overlay application makes sure that the Y-coordinate of the line 4020 moves in accordance with the Y-coordinate of the mouse-cursor 4099, The Y-coordinates may be identical, or may be slightly offset, such that the line appears slightly above or slightly below the mouse cursor.

FIG. 41 is a schematic representation of a “Z-order” of five windows or image planes 4181-4185 as may be used in the computer system of FIG. 40.

The embodiment of FIG. 40 and FIG. 41 can be seen as a variant of the embodiment of FIG. 38 and FIG. 39 or as a variant of the embodiment of FIG. 7 and FIG. 8.

In a variant (not shown) of the embodiment of FIG. 40 and FIG. 41, the line 4020 contains a perforated bitmap (as in FIG. 37), or contains a color gradient (vertical or horizontal), or contains a texture bitmap.

FIG. 42 shows a schematic block diagram of another computer system 4200 according to an embodiment of the present invention, with an overlay application providing an overlay window 4384 comprising a vertical line 4240 that defines a left region and a right region of the screen 4204, and a horizontal line segment 4260 that extends over the width of either the left region or the right region.

The overlay window 4384 is preferably configured as a semi-transparent window, preferably with an alpha transparency in the range from 5% to 95%, or from 30% to 70%, although that is not absolutely required, and the overlay window 4384 can also be configured as opaque, in which case the pixels P5 would be fully transparent pixels.

The horizontal position of the vertical line 4240 may be predefined, e.g. substantially in the middle of the overlay window 4384, or may be selectable via a user interface, but preferably is configurable by dragging the line with the mouse cursor 4299. The latter is not obvious if the overlay window 4384 is configured in click-through mode, but is possible for example by dynamically configuring the overlay window 4384 in click-through mode or not in click-through mode, depending on whether the native mouse cursor is present over the vertical line 4240.

The overlay application is configured to update the vertical position Y of the horizontal line segment 4260 in accordance with the position of the mouse cursor 4299 or movements of the pointer device or position device, e.g. mouse device 4203, but only if the mouse cursor is located in the left region (i.e. on the left side of the vertical line 4240). When the mouse is present in the right region (i.e. on the right side of the vertical line 4240) the horizontal line segment 4260 keeps its position (also referred to herein as “freezes”).

A major advantage of this overlay application is that the line segment 4260 can be used to highlight or underline text fragments in a document to be translated (e.g. a PDF document located on the left side of the vertical line 4240), while working (with the keyboard 4202 and the pointer device, e.g. mouse device 4203) in a text editor located on the right side of the vertical line 4240. The line segment 4260 helps to quickly regain context when switching back and forth between the two documents, for example during translation, thereby significantly lowering the cognitive burden of the translator.

This overlay application can also be used by proofreaders, using the line segment 4260 to underline or highlight text fragments (by moving the mouse cursor to the left every line or every few lines of source text), and then moving the mouse cursor to the right region, and using the mouse cursor 4299 for hovering over the target text, and optionally for editing or correcting the latter.

FIG. 43 is a schematic representation of a “Z-order” of five windows or image planes 4381-4385 as may be used in the computer system of FIG. 42.

In a variant (not shown) of the embodiment of FIG. 42 and FIG. 43, the line segment 4260 contains a perforated bitmap (as in FIG. 37), or contains a color gradient (vertical or horizontal), or contains a texture bitmap.

In a variant of the embodiment of FIG. 42 and FIG. 43, the line segment 4260 is located on the right side of the vertical line 4240, and is movable if the mouse cursor or pointer 4299 is located on the right of the vertical line 4240, and freezes if the mouse cursor or pointer is located on the left side of the vertical line 4240. This embodiment is deemed particularly suitable for left-handed people.

FIG. 44 shows a flow-chart of a method as may be performed by the computer system 4200 of FIG. 42 and FIG. 43. FIG. 44 shows a computer implemented method 4400 for overlaying a graphical image in a computing device 4201, the method comprising the steps of:
a) providing 4401 an overlay window 4384, preferably as a semi-transparent window;
b) providing 4402 a first visible object in the form of a vertical line 4240;
c) providing 4403 a second visible object in the form of a horizontal line segment 4260 located either on the left side or the right side of the vertical line 4240;
   repeatedly performing the following steps:
d) obtaining 4404 position information X,Y of a mouse pointer or mouse cursor 4299;
e) testing 4405 whether the mouse cursor or pointer 4299 is located on or over the vertical line 4240, and if the outcome of the test is positive continue with step f), otherwise continue with step h);
f) if the overlay window is not already configured in non-click-through mode, configuring 4406 the overlay window 4384 in non-click-through mode (meaning: not in click-through mode, but in a mode wherein the operating system will send keyboard and mouse events to the overlay window or objects thereof, rather than to underlying applications, if the mouse is positioned over the overlay window);
g) testing if a mouse button is pressed down, and if the outcome of this test is true, dragging the vertical line; and going back to step d);
h) if the overlay window is not already configured in click-through mode, configuring 4408 the overlay window 4384 in click-through mode;
i) adjusting a position of the horizontal line segment 4260, if the mouse cursor or pointer 4299 is located on the same side of the vertical line 4240 as the horizontal line segment 4260, and freezing the horizontal line segment 4260 if the mouse cursor 4299 is located on the opposite side of the vertical line 4240, and going back to step d).

This embodiment provides a line segment 4260 that “freezes” when the mouse cursor is moving or is located on the right side of the vertical line 4240, and that “moves along with the mouse cursor” when the mouse cursor 4299 is located or is moving on the left side of the vertical line 4240, and vice versa. Moreover, this embodiment allows to drag the vertical line 4240 in a very intuitive way. This embodiment is particularly suitable for translators and proofreaders not using a CAT-tool (Computer Aided Translation tool), or verifying a translation outside of the CAT-tool.

It is noted that there was a requirement to allow the position of the vertical line to be selectable or configurable, and since this configuration requires user interaction, the logical place to implement this functionality is in the user-interface window, because that window is capable of receiving keyboard and mouse events. The inventors however came to the idea that it would be easier and more intuitive for the user if the vertical line could be dragged, but that was not possible because the vertical line is implemented in the window which is configured in click-through mode. Trying to find a solution to allow dragging anyway, the inventors experimented with dynamically changing the “click-through” functionality of the overlay window, not knowing, let alone expecting whether this would work at all, and work reliably. The experiments surprisingly showed that it is indeed possible to dynamically change the click-through mode of a window depending on the position of the mouse cursor, moreover depending on whether the native mouse cursor is located over the area of the vertical line. At least this aspect is not trivial.

In a variant of the method of FIG. 44, the line segment 4260 is located on the right side of the vertical line 4240, and is movable if the mouse cursor or pointer 4299 is located on the right of the vertical line 4240, and freezes if the mouse cursor or pointer is located on the left side of the vertical line 4240. This embodiment is deemed especially useful for left-handed translators and proofreaders and writers.

FIG. 45 shows a mobile device, such as e.g. an eReader or a smartphone device, comprising a touchscreen, and running an app or application that shows textual information, for example in the form of an eBook, or a web-browser. The textual information is overlaid by a line 4510 allowing a user to underline or highlight text information he or she is reading. The line 4510 may be implemented in an overlay window associated with an overlay application or as part of the Operating system running on the device, or may be implemented as part of the app or application itself, e.g. the eBook reader or web-browser app.

In an embodiment, the line 4510 is a semi-transparent line created in an overlay window having an alpha-transparency in the range from 1% to 99% or from 2% to 98% or from 5% to 95%, preferably in the range from 30% to 70%. The line 4510 may contain a plurality of monochrome pixels (as in FIG. 8), or may contain a color gradient (not shown), or may contain a texture.

In another embodiment, the line 4510 is formed by or comprises a bitmap comprising a first plurality of fully transparent pixels P6 and a second plurality of opaque or semi-transparent pixels P7, which are interleaved so as to make the line seem semi-transparent, referred to herein as a “perforated bitmap”. In case the pixels P7 are opaque pixels, no alpha-blending is required, yet the line does not completely obscure underlying textual information.

The line 4510 may be automatically movable, e.g. based on a timer. Preferably the speed is configurable or adjustable via a user-interface (not shown).

The line 4510 may be movable by means of dragging, in manners known per se in the art, based on a user contacting the screen with his or her finger, and then moving the finger.

The line can help the reader to stay concentrated when reading, despite distraction.

In an embodiment where the line 4510 extends over substantially the entire width of the display of device 4500, the reader application or overlay application only needs to adjust the vertical position (Y) of the line relative to the screen, in accordance with movements of the user on the touchscreen.

In an embodiment where the line 4510 extends over only a fraction (e.g. less than 50%) of the width of the display of device 4500, the reader application or overlay application may be adapted for adjusting both a horizontal position X and a vertical position Y of the line, in accordance with movements of a users finger on the touchscreen.

FIG. 46 shows a schematic block diagram of another computer system 4600 according to an embodiment of the present invention, which can be seen as a variant of FIG. 21, where the computer system 4600 provides a graphical overlay image 4784 in the form of a so called “perforated texture bitmap”, overlaid by the display device 4604.

In this embodiment, the computer device 4601 generates the image planes 4781 to 4783, and provides corresponding image data to the display device 4604, as a classical computer would do, but the display device, rather than merely rendering said computer data on a display panel, overlays said image data with an overlay image 4784 stored in the display device, and renders the result.

Display devices are well known in the art, in particular stand-alone LCD display devices or stand-alone LCD monitors. Such a display device mainly includes three parts: an application processor, a memory device which includes a frame buffer, and a display device which includes a display controller and a display panel. The application processor is responsible for drawing and generating an image frame, and for storing the generated image frame in the frame buffer in the memory device. The frame buffer is used to store data of pixels on a display screen. The display controller is mainly responsible for reading the data of the pixels from the frame buffer, and sequentially writing the data of the pixels into logic circuits on the display panel that are corresponding to the pixels. In a process of displaying an image by the display system, the application processor continuously generates a new image frame, and sends the image frame to the frame buffer.

In the context of the present invention, the application processor is adapted for providing an overlay image 4784 over said computer image, the overlay image being a “perforated texture bitmap” as explained above. In other words, this bitmap 4730 comprises or consists of a first plurality of pixels P6 which are fully transparent pixels, and a second plurality of pixels P8 which are semi-transparent pixels, which pixels P6 and P8 are interleaved, for example arranged in a regular pattern, preferably a checkerboard pattern. The actual step of overlaying may comprise alpha-blending pixels of the computer pixels with corresponding pixels of the perforated texture bitmap.

The perforated texture bitmap may be a predetermined bitmap, built-in the display device, or preferably, is a downloadable image, or shown on the computer device, and captured by the display device upon user request, for example initiated by a press on a button of the display device (not shown), and then stored in a non-volatile memory of the display device for further use. But other means for downloading the texture bitmap are also contemplated, for example using an USB interface for inserting a memory stick, or using a wireless link, for example a Bluetooth link for making a wireless communication with the computer device, in which case the computer device is preferably provided with a special application for selecting and sending a texture bitmap to the display device.

Optionally the display device is further adapted for scaling and/or resizing and/or tiling and/or perforating the texture bitmap, although the perforation can also be implemented implicitly by only alpha-blending a subset of the pixels, for example one pixel out of every two pixels according to the checkerboard pattern.

Preferably there are at least four or five alpha blending levels, for example corresponding to a mixing of 0/4=0%, 1/4=25%, 2/4=50%, 3/4=75% and 4/4=100%. More preferably there are at least eight or nine alpha-blending levels, for example corresponding to a mixing of 0/8=0%, 1/8, 2/8, 3/8, 4/8, 5/8, 6/8, 7/8 and 8/8=100%.

Optionally the display device is further adapted for adjusting the transparency level and/or the color and/or the contrast of the texture bitmap, for example using any or all of the formulas [6] to [10], based on a predefined color and/or contrast level, which may be provided by a user to the display device using one or more buttons on the display device, or using said special application for configuring the display device using said wireless connection, e.g. Bluetooth connection.

Optionally the processor is further adapted for repeatedly adjusting a position of the texture bitmap such that pixels of the underlying graphical image are overlaid by a fully transparent pixel of the first plurality of pixels P6 at a first moment in time t1, and are overlaid by a semi-transparent pixel P8 of the second plurality of pixels at a second and optionally third and fourth moment in time t2, t3, t4, for example as explained above, when discussing FIG. 28.

Rather than physically shifting the texture bitmap back and forth over a horizontal or vertical distance of for example one pixel each frame, and rather than storing a perforated bitmap, the processor may be adapted for combining the step of “perforating” and “time multiplexing” at the same time, when generating the image to be stored in the frame buffer, for example by doing as follows:

i) at even moments in time (t2, t4) copying computer image data from the input buffer at pixel locations X,Y for which the sum of the row index X and the column index Y is odd, and by alpha-blending computer image data from the input buffer with corresponding pixel data from the texture bitmap at pixel locations X,Y for which the sum of the row index X and the column index Y is even; and

ii) at odd moments in time (t3, t5) copying computer image data from the input buffer at pixel locations X,Y for which the sum of the row index X and the column index Y is even, and by alpha-blending computer image data from the input buffer with corresponding pixel data from the texture bitmap at pixel locations X,Y for which the sum of the row index X and the column index Y is odd.

While this solution requires a special display device, it provides several advantages: this solution may reduce eye-strain for users, especially when the computer image contains a bright image. It is a further advantage of this solution that it can transform the look of a pure white image into a textured image, for example a paper-like image, which may be aesthetically more enjoyable to read. It is an advantage that the display device performs the alpha blending rather than the CPU of the computer device, hence the CPU-load is not influenced by this overlay. Finally, it an advantage of using a “perforated bitmap” rather than a “non-perforated bitmap” because this requires less processing power, since only a subset of the pixels, for example only 50% of the pixels of each frame, needs to be alpha-blended, while the other pixels can be passed without alpha-blending.

FIG. 47 is a schematic representation of a “Z-order” of three windows or image planes as may be used in the computer system of FIG. 46, and on top of that, a fourth semi-transparent overlay image is provided by the display device.

FIG. 48 shows a schematic block diagram of another computer system according to an embodiment of the present invention, which can be seen as a variant of FIG. 46, where the computer system provides a graphical overlay image in the form of a “non-perforated texture bitmap”, overlaid by the display device. Everything mentioned in relation to FIG. 46 and FIG. 47 is also applicable here, except that all pixels of the texture bitmap would need to be alpha blended with the pixels of the computer image.

FIG. 49 is a schematic representation of a “Z-order” of three windows or image planes as may be used in the computer system of FIG. 48, and on top of that, a fourth semi-transparent overlay image provided by the display device 4804.

Referring now to FIG. 50 and FIG. 51.

As already discussed in the background section, the tool F.Lux provides a semi-transparent graphical overlay application using a bitmap, in particular a yellowish monochrome bitmap, the color of which is adjusted dynamically over time. While this tool may be helpful to reduce eye strain, the tool has several limitations, for example:

(1) the overlay does not take into account the actual underlying images provided by the underlying applications. Indeed, the inventors found that in order to reduce eye strain, some images need to be darkened more than others, in particular, applications providing a window with a pure white background (such as MS Paint or MS Word or MS PowerPoint) should be darkened more than applications providing a gray background. Unfortunately F.Lux does not take this into account. A user may be able to manually adjust, but this is cumbersome.

(2) many computer-users take a screenshot now and then (e.g. using the “Print-Screen” button on the keyboard), but when F.Lux is running, the colors of such a screenshot are not the true colors of the original image stack associated with the underlying applications, but is colored yellowish or orange. A user desiring to take a screenshot could temporarily de-activate F.Lux in order to take a screenshot, and then re-activate F.Lux, but this is time-consuming, but what's worse, when F.Lux is deactivated, he or she is presented with the original images which are typically much brighter, and may cause eye strain.

The inventors of the present invention came to the idea of addressing these problems by providing the computer implemented method 5000 shown in FIG. 50 and the computer implemented method 5100 of FIG. 51 respectively.

FIG. 50 is a flowchart of a computer implemented method 5000 for overlaying a graphical image in a computing device, which can be seen as a variant of the computing device 2300 of FIG. 23 and FIG. 24. The method comprises the steps of:

a) providing 5001 a semi-transparant overlay window having an alpha-transparency value α, and comprising a first bitmap bmp1. The first bitmap may be a monochrome bitmap where all pixels have the same color, or may be a perforated monochrome bitmap, or may be a texture bitmap, or may be a perforated texture bitmap, or another suitable bitmap.

The method further comprises a loop where the following steps are repeated:

b) taking 5002 a screenshot, thereby obtaining a second bitmap bmp2;

c) determining 5003 at least one characteristic of the second bitmap bmp2;

d) adjusting 5004 the alpha-transparency value α of the overlay window and/or adjusting one or more pixel values of the first bitmap bmp1, based on said at least one determined characteristic.

The first bitmap may be a monochrome bitmap.

The first bitmap may contain a color gradient.

In an embodiment, step d) comprises: determining an average intensity and/or a maximum intensity and/or an intensity histogram of the pixels of the second bitmap bmp2; and step e) comprises: adjusting the alpha-transparency level α such that the average intensity or the maximum intensity or the intensity histogram satisfies a predefined criterium.

In an embodiment, step d) comprises determining average color component values Ravg, Gavg, Bavg and/or color component histograms of the pixels of the second bmp2; and step e) comprises: adjusting one or more pixel values of the first image bmp1 such that the average color component or the color component histogram satisfies a predefined criterium.

Better results (in terms of less eye strain) can be achieved if also the brightness of the room is taken into account. In such an embodiment step d) further comprises: determining a brightness value indicative of a brightness in a room in which the computing device performing the overlay method is located, and the adjustment of step e) further takes into account said brightness value. This brightness value may for example be obtained from a light sensor, or may be derived from an image taken by a webcam, or in any other suitable way.

In a particular embodiment, especially suitable for people working with two documents or working on two different displays, step a) further comprises: providing at least one vertical line or bar in said first bitmap bmp1 for defining at least two regions comprising a first region and a second region; and step c) comprises determining at least a first characteristic of the first region and a second characteristic of the second region; and step e) comprises: adjusting one or more pixel values of the first region such the first characteristic satisfies a first predefined criterium, and adjusting one or more pixel values of the second region, such that the second characteristic satisfies a second criterium.

In a variant of this method, each of the left and right region may be further split by means of a horizontal movable line or bar, resulting in four different regions. Preferably each of these regions of the first bitmap is monochrome, meaning that the first region has pixels with color value (R1, G1, B1), where the value of R1, G1 and B1 are determined based on the graphical content of the images underlying the first region, the second region has pixels with color values (R2, G2, B2) where the value of R2, G2 and B2 are determined based on the graphical content of the images underlying the second region, etc. These regions may be perforated or not perforated. Alternatively, the first region contains pixels extracted from a first texture bitmap, having a first average color and a first contrast ratio which is derived depending on at least one characteristic of the image(s) underlying the first region, the second region contains pixels extracted from a second texture bitmap, having a second average color and a second contrast ratio, etc. The skilled person having the benefit of the present disclosure can easily think of other variants.

It is also contemplated that the screenshot can be further analysed, for example to detect the presence of alphanumerical characters, and their size, and/or the presence of a monochrome background surrounding these characters, and adjusting characteristics of a texture overlay bitmap based thereon, for example to create a texture bitmap with a sufficiently low contrast so that it does not negatively influence the readability of the characters, and has a sufficiently high contrast so that it is noticeable by the user, and creates for example a paper-looking effect, or a matt looking background.

FIG. 51 is a flowchart of a computer implemented method 5100 for overlaying a graphical image in a computing device, which can be seen as a variant of the computing device 2300 of FIG. 23 and FIG. 24. The method comprises the steps of:

a) providing 5101 a semi-transparent overlay window having an alpha-transparency value α in the range from 1% to 99%, and comprising a first bitmap bmp1. The first bitmap may be a perforated or not-perforated monochrome bitmap, or may be a perforated or not-perforated texture bitmap, or a bitmap with a gradient based on only two color values.

b) taking 5002 a screenshot, thereby obtaining a second bitmap bmp2;

c) calculating a third bitmap bmp3 so as to compensate the effect of the graphical overlay, based on said first bitmap bmp1 and said second bitmap bmp2 and said alpha-transparency value α.

It is noted that in case the overlay application not only contains a bitmap, but also contains one or more movable objects such as for example a horizontal line or a vertical line, it is possible to either maintain these visible objects in the captured image, or to also compensate for these objects thereby virtually removing these objects from the captured image. Whether or not to remove the movable objects may be a predefined setting, or may be configurable by a user, for example in the user-interface window.

Optionally the method further comprises step d) of: storing 5104 the third bitmap bmp3 to a non-volatile memory (e.g. on a memory stick) or on a storage device (e.g. a hard disk drive or a network drive), optionally after format conversion (e.g. BMP to PNG) and/or after image compression (e.g. lossless or lossy JPEG compression).

Optionally the method further comprises step e) of: copying 5105 the third bitmap bmp3 to a clipboard of an operating system running on said computing device (for example: MS Windows 10 or a later version having the same or similar functionality). This function is comparable to the “print-screen” button found on many keyboards, but with the additional benefit of compensating for the alpha-blending. In this way a user suffering from eye strain can “work” on his computer, and can even take screenshots without having to de-activate the overlay image. This is a huge advantage for such users, both because of reduced eye strain, and because of time saved.

In order to perform the compensation, use can be made of the following set of formulas, or an equivalent set of formulas:

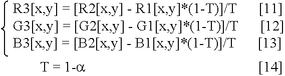

wherein R1,B1,G1 are color components of a pixel at a location (x,y) of the first bitmap bmp1 being overlaid, and wherein R2,G2,B2 are color components of a pixel at a location (x,y) of the second bitmap bmp2 taken as the screenshot, and wherein R3,G3,B3 are color components of a pixel at a location (x,y) of the third bitmap bmp3, and wherein a is the alpha-transparency value, and T is a transparency value, both expressed as a floating point number in the range from 0.01 to 0.99.

In case the first bitmap is “perforated”, the formulas [11] to [14] only need to be applied in case the pixel of the first bitmap is not fully transparent.

FIG. 52 to FIG. 59 illustrate another aspect of the present invention, referred to herein as the “inverted color” function or “color inversion “function. As described in the background section, one of the problems underlying the present invention is that bright images (e.g. caused by a text editor or PDF document viewer or a website with a white background) can cause eye strain, especially to people working many hours in front of a computer screen.

While this problem is already addressed above (e.g. by providing a perforated or non-perforated relatively dark semi-transparent overlay), the inventors also came to the idea of providing an overlay that substantially inverts the colors, in the sense that bright pixels are transformed into dark pixels, and vice versa. Indeed, a window with a “command-prompt” (also known as a DOS-box) typically causes much less eye-strain than most modern windows applications, because most of the screen is black, except for some white characters.

It is noted that the Windows Operating System already has a “Enhanced Contrast” mode, but there are several disadvantages with the existing implementation provided by the Operating System. For example, this function is not easy to find for an average user, because multiple menus need to be passed, which makes it impractical to be switched ON and OFF on a regular basis (e.g. every few minutes). Secondly, the Enhanced Contrast mode of the Windows O/S only works with a full screen, not a partial screen. This is a pity, because professional users may be working with multiple applications at the same time (especially on a computer with a multi-tasking operating system and a large monitor), but may not want to invert the colors of all applications. The user may for example want to invert the colors of a right portion of the screen where a text editor is located, but not the colors of a left portion of the screen, where for example a drawing program is located. Third, when working in a text document, the user may want to change the font color of certain characters, and/or may want to mark some text portions in yellow or green background color, but this is very difficult if the colors are inverted over the entire screen.

The inventors had the desire to provide a “color inversion” function in an overlay application, but realised that the overlay application does not have access to the data of the “underlying image”. The overlay application can take a screenshot, but that would not yield the underlying image data, but a mixture of the underlying image data and the overlay window. It would be possible to temporarily disable the overlay function (e.g. by making the overlay window fully transparent), nd to take a screenshot of the underlying image, and then provide an opaque overlay image with the inverse image and maintain this image for a predefined period, and this would work for a stationary image, but does not work well if the underlying image is changing, as is typically the case if a user is working at the computer device (e.g. editing a text document, reading or replying to emails, etc.). Moreover, temporarily disabling the overlay would typically cause a bright flash, which is extremely annoying. For these and other reasons, it was believed to be impossible to implement a color inversion function in the overlay application without causing a flash.

In order to avoid the bright flash, the inventors came to the idea of not temporarily disabling the semi-transparent overlay, and to try to provide a color inversion based on the pixel data obtained from the screenshot. Tests were performed wherein a screenshot was taken, and depending on the pixel values of the screenshot, the overlay image was adjusted. More specifically, if the screenshot pixel had a value (R,G,B), the corresponding pixel in the overlay image was assigned a value of (255-R, 255-G, 255-B). Unfortunately, this technique did not provide a stable image, but the pixel values drifted away.

It did not work, until the inventors came to the idea of calculating the pixel values for the overlay image, not only based on the pixel values of the screenshot image, but by also taking into account the pixel values of the (previous) overlay image. More specifically, the inventors came to the idea to use formula [1] mentioned above to reverse the alpha-blending operation, in order to calculate or rather estimate the pixel values of the underlying image (referred to herein as “unmixed” pixel values). The idea was that, once these “unmixed pixel values” are known, they can be inverted, resulting in the new “target pixel values”, and based on these target pixel values, suitable “mask pixel values” (values of the overlay bitmap) could then be calculated or estimated which would result in these target values. It could not be predicted that this idea would work, especially when taking into account that in order to “overrule” the underlying pixel values (since a bright pixel needs to become black, and a black pixel needs to become bright after alpha-blending), the transparency level T needs to be relatively small (e.g. smaller than 20%), but it was unclear whether that would still allow to detect the underlying pixel data in the screenshot with sufficient accuracy, especially for image data where quantization errors are highly visible.

Thus, the inventors started experimenting. Formula [1] mentioned above, is repeated here as formula [15], for convenience.

(Rm,Gm,Bm)=(R1,G1,B1)×(1−T)+(R2,G2,B2)×T [ 15]

For the “inverse color” feature, the (Rm,Gm,Bm) values are those obtained by the screenshot and are renamed as (Rmix,Gmix,Bmix), and the values (R2,G2,B2) are the values of the underlying image and are renamed here as (Rorig,Gorig,Borig), and the values (R1,G1,B1) are those of the overlay image and are renamed here as (Rmask, Gmask, Bmask).

Thus formula [15] can be rewritten as the following set of equations:

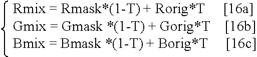

where each of Rmix, Gmix, Bmix, Rmask, Gmax, Bmask, Rorig, Gong and Borig—are values in the range from [0 . . . 255], and T is a value in the range from 0.0 to 1.0, or more precisely is a value in the discrete set ranging from 0/256 to 255/256. The inventors came to the idea of estimating the original values (or calculating the un-mixed values) by using the following set of formulas:

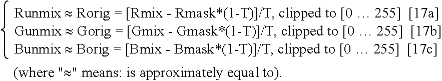

In order to speed-up the calculations, integer arithmetic was used, and instead of multiplications and divisions, shift-operations were used. In order to do so, the value of T was selected to be a power of 2 divided by 256. More in particular, in preferred embodiments, T=16/256 or T=32/256.

The next step is determining the target values of the “inverted pixels”. A simple formula for converting white pixels (value 255) into black pixels (value 0) and vice versa is given by the following set of functions:

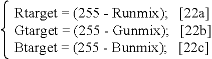

but it is explicitly pointed out that the present invention is not limited to these particular functions. In fact, any set of three monotonically decreasing functions providing values in the range from 0 to 255 (or a subset thereof), for arguments in the range from 0 to 255, are considered to provide “a color inverted image”. As an example, the following set of functions may form a suitable set:

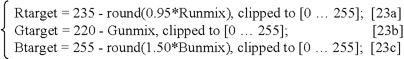

In this particular example, all functions are linear functions with a negative slope, but the present invention is not limited thereto, and non-linear functions can also be used, as long as they are monotonically decreasing for arguments in the range from [0 to 255].

Once the target values are determined as a function of the unmixed values, the mask values for obtaining these target values (after mixing with the semi-transparent window containing these mask pixels) can then be calculated from the following formula (in analogy with formula [1], which is rewritten as follows (after replacing Rorig by Runmix, Gorig by Gunmix and Bong by Bunmix):

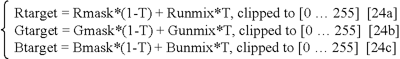

or solving tor the mask values:

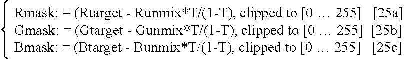

These formulas provide excellent results, but are computationally expensive.

Searching for faster solutions, further experiments were performed, and it was surprisingly found that excellent results were also obtained if the mask values were simply set equal to the target values of Eq[22a-c], as can be expressed by the following set of equations:

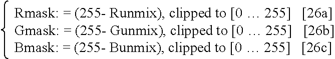

This was very surprising because earlier tests where the mask values were set equal to (255-R, 255-G, 255-B) where (R,G,B) are the values from the screenshot pixels, did not provide a stable image. But setting the mask values to (255-Runmix, 255-Gunmix, 255-Bunmix) where Runmix, Gunmix and Bunmix are obtained from formula [17] does provide very good results.

Excellent results were also obtained for the following set of equations:

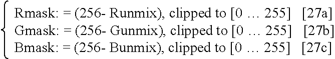

Further experiments learned however that for some picture content (e.g. a picture with a smooth gradient), some artefacts in the form of oscillations occurred. More in particular, a relatively small set of pixels were toggling between two values and also the corresponding mask values to these pixels were toggling between two values. Further investigation learned that this is probably due to rounding errors and/or quantization effects. This problem can be solved in several ways, for example by adding pseudo-random noise, or by detecting that a particular pixel is oscillating (by comparing subsequent screenshots), etc., or by quantizing the mask values, or by assigning specific mask values for particular unmixed values, or combinations hereof. The skilled person can easily find a solution for these specific values by doing routine experiments, and solving them in a straightforward manner.

Referring now to the Figures.

FIG. 52(a) shows a schematic block diagram of a computer system 5200 according to an embodiment of the present invention. The computer system of FIG. 52(a) contains a computing device 5201 and a screen or monitor, e.g. an LCD display device. The computing device 5201 may be further connected to a keyboard 5202 and a mouse 5203. The computing device 5201 comprises at least one processor running a Multi-Tasking Operating System (e.g. a Windows version from Microsoft Corporation, or a version of Macintosh O/S, e.g. Sierra or High-Sierra, or Linux or any other suitable operating system). The computing device 5201 shown in FIG. 52(a) and FIG. 52(b) is running at least one application that presents information, e.g. a text editor or a spreadsheet application or an internet browser or a PDF reader, etc. The computing device 5201 further comprises an overlay application for implementing an overlay method capable of substantially inverting the colors of at least a portion of the image being overlaid.

In the example shown in FIG. 52(a), the overlay application is adapted for “color inverting” a central region of the screen 5204. This size and position of this region may be predetermined, or may be configurable by the user. The size and position of the region may be defined by a frame, or by an upper horizontal line segment 5244, and a lower horizontal line segment 5246, and a left vertical line segment 5240 and a right vertical line segment 5242. These line segments are preferably movable in a similar manner as explained in FIG. 44 (by temporarily configuring the overlay window in “non-click-through” mode if the mouse is moving over the respective line segments), such that the line segments can be dragged. The overlay application is adapted for performing a method as illustrated in FIG. 54.

And advantage of this overlay application is that it allows to “darken” a portion of the screen for reducing eye-strain, and it does so in a very particular manner, namely by inverting colors. This is especially useful for converting the look & feel of applications showing textual information as relatively dark characters on a relatively bright background, such as (unfortunately most) text editor applications, email-applications, webpages, PDF document viewers, etc.

FIG. 52(b) shows the same computer system 5200, but running another overlay application (working substantially in full-screen mode), or running the same overlay application, but configured differently. More in particular, the overlay application running on the computer device of FIG. 52(b) is adapted for generating a full-screen overlay image (or full-screen except for a minor portion at the top of bottom, e.g. for the taskbar) that inverts the entire screen content. The algorithm or operations performed on the pixel data may be exactly the same as in FIG. 52(a), but as can be appreciated, if the image is for example 4.0 times larger, it typically takes about 4 times longer to process the image. This means that the frequency at which the mask can be updated is reduced by a factor of about 4.0.

To get an idea about the performance, experiments were performed on a (relatively slow) laptop computer with a 64 bit Operating System (Windows 10), having a 2.00 GHz AMD processor and 8 GB RAM, with AMD Radeon R34 Graphics. The overlay application was configured to perform “inverse color mode”.

It took about about 160-200 ms to perform one iteration (including taking a screenshot, and calculating and applying a new mask) for inverting an area of about 1920×1020 pixels. (full screen minus taskbar).

It took about 90-130 ms to convert about ½ screen (960×1020 pixels), and it took about 50-90 ms to convert about ¼ screen (960×510 pixels).

Thus on this (relatively slow) laptop computer, the full-screen image can be color-inverted (or color-converted) by the overlay-application about 4 to 5 times per second, the half-screen image can be inverted about 7 times per second, and the quarter screen image can be updated about 10 times per second. While the latency of about 200 ms may be annoying to some users, other users will appreciate the reduced eye strain, especially when working in text documents.

Experiments were also performed on another (relatively fast) laptop computer, with a 64-bit Windows 10 Operating system, with an Intel IS processor running at 2.3 GHz, and 8 GB RAM, but more performant graphics capabilities. On this computer it took only about 55-65 ms to color-invert a full screen picture (of 1920×1040 pixels) in the overlay application, and it only took about 25 to 35 ms to color invert a half-screen picture. On this computer, latency is not an issue, and such performance can be considered as “almost real time”.

FIG. 53 is a schematic representation of a so called “Z-order” of five windows or image planes 5381, 5382, 5383, 5384, 5385 as can be used in the computer system of FIG. 52(a) and FIG. 52(b).

In the example, the first window 5381 at height Z1 is called the desktop window, and is provided by the operating system.

The second window 5382 is provided (in this example) by a text application typically having a white background and black characters. One of the black pixels is shown in enlarged view.

The third window 5383 at height Z3 is provided by the overlay application according to the present invention. The window shown here comprises two horizontal line segments 5344, 5346 and two vertical line segments 5340, 5342, and a bitmap bmp1 located in a region defined by these line segments, but the present invention is not limited thereto, and for example a single horizontal line (e.g. to implement mode 5506 of FIG. 55), or a single vertical line (e.g. to implement mode 5502 or mode 5504 of FIG. 55), or a single horizontal line segment and a single vertical line segment (e.g. to implement mode 505 or mode 5507 of FIG. 55) can also be used.

The window 5383 is configured as a semi-transparent window, preferably with a transparency value in the range from 5% to 45%, preferably with transparency level T equal to T=16/256=1/16=6.25% or T=32/256=1/8 =12.5%. Or stated in other words, with an alpha transparency a equal to (1−T) in the range from 55% to 95%, preferably with an alpha-transparency value α equal to α=15/16=93.75% or α=7/8=87.5%.

As described above, the overlay application dynamically adjusts the pixels of the bitmap bmp1 (also referred to as “the mask”), such that the pixels located under this bitmap are substantially inverted, and it does so “on the fly”, meaning that, if the underlying image changes, the mask automatically changes. Why such functionality may be relatively easy to implement in an operating system which has access to the original image data located below the overlay application, this is not at all trivial for an overlay application, inter alia because the overlay application does not have access to the underlying image.

Apart from the mathematics described above, the working of the overlay application configured for performing “color inversion” can be understood by way of an example. Consider for example the black pixel 5301 of the second window 5382. The idea is to overrule the black pixel content by overlaying this pixel location with a bright pixel located in the bitmap bmp1 (also called the mask). The skilled person will understand that, even though the dark pixel is still partly visible (e.g. about 6% or about 13%), the brightness of the bright pixel on top largely overrules the black value, because the pixels of the overlay window 5383 have a larger weighting factor (e.g. about 94% or about 87% respectively) than those of the text editor window 5382 if T is set equal to 1/16 or 1/8 respectively. It is pointed out that the principle of “inverting colors by overruling the underlying color by the opposite color using a stronger weight factor” is relatively easy to understand, but it was much harder to understand and even believe let alone predict that it was possible to detect the underlying image with sufficient accuracy to allow color-inversion, by taking a screenshot and reverse alpha blending, knowing that the relevant information is only present for about 6% or about 13% of the image, and this is barely visible (but becomes slightly visible when typing text in the text document, or when scrolling a text document, for example). Tests have demonstrated however that this is exactly the case, and the results are much better than expected, not only for text or menus of typical desktop applications, but even for graphics, as will be shown by way of example in FIG. 56 to FIG. 59.

The fourth window 5384 is a user-interface window optional provided by the overlay application. If present, it is preferably located above the third window 5383 and is preferably configured as a non-click-through window.

The fifth window 5383 is a cursor plane, which is preferably provided by the operating system.

FIG. 54 is a flowchart of a computer implemented method performed by an overlay application according to an embodiment of the present invention, as can be used in the computer system of FIG. 52(a) or FIG. 52(b), and is capable of “color-inverting” the underlying image generated by the operating system. The method comprises the following steps:

a) providing 5401 a semi-transparent overlay window 5383 comprising a bitmap bmp1 (or mask) with a plurality of semi-transparent pixels, and having a transparency level (T) in the range from 5% to 45% (or an alpha-transparency value (a) in the range from from 55% to 95%);

b) configuring 5402 the overlay window in “click-through mode”, in order to allow keyboard input and mouse inputs to be sent to the underlying window, rather than being interpreted by the overlay window;

Repeatedly performing the following steps:

c) taking 5403 a screenshot, thereby obtaining a second bitmap bmp2;

d) updating the pixel values of the first bitmap bmp1 (or mask), such that the color value of the pixels underlying the overlay window are substantially inverted when being alpha-blended by the graphical overlay.

The first bitmap bmp1 may occupy the entire area of the window 5383, or only a portion thereof, for example as defined by the screen borders and/or one or two horizontal line segments and/or one or two vertical line segments. Preferably the first bitmap bmp1 occupies at least 20% or at least 40% or at least 60% or at least 80% or at least 90% of the size of the overlay window 5383. Preferably at least 90% or all of the pixels of the first bitmap bmp1 are semi-transparent (i.e. not fully-transparent).

FIG. 55 shows an exemplary user interface window as may be used by the application running on the computer system of FIG. 52(a) and/or FIG. 52(b). In the particular example shown in FIG. 56, the user can enable color inversion by checking the checkbox 5601, and the user can select which part of the screen is to be color-inverted, for example when clicking on button 5502 the first bitmap bmp1 is configured to occupy the left half of the screen, when button 5503 is clicked, the first bitmap bmp1 is configured to occupy substantially the entire screen (preferably without the windows taskbar area), and when button 5504 is clicked, the first bitmap bmp1 is configured to occupy the right half of the screen.

The other six buttons (including button 5505, 5506, 5507) show other portions of the screen to be overlaid with a reduced height. Once one of these predefined bitmaps bmp1 is shown, its size and/or position can be changed by dragging one or more of the horizontal and/or vertical line segments, as shown e.g. in FIG. 52(a) and FIG. 52(b).

FIG. 56 and FIG. 57 show an exemplary image to show the surprisingly good quality of the color inversion obtainable by the overlay application. The pictures show a portion of the well known “Paint” application, holding a color gradient picture. FIG. 56 shows the original picture (without color inversion), FIG. 57 shows this picture after color inversion by an overlay application according to an embodiment of the present invention. The value of T was equal to 32/256 or 1/8 in this example.

FIG. 58 and FIG. 59 show another exemplary image to show the surprisingly good quality of the color inversion obtainable by the overlay application. The pictures show a portion of an image taken from a web-browser showing dummy text, known as “Lorem Ipsum”. FIG. 58 shows the original picture (without color inversion), FIG. 59 shows this picture after color inversion by an overlay application according to an embodiment of the present invention. The value of T was equal to 32/256 or 1/8 in this example.

FINALLY,

While individual features are explained in different drawings and in different embodiments of the present invention, it is contemplated that features of different embodiments can be combined, as would be obvious to the skilled person, when reading this document.

Although all embodiments are shown with a desktop computer and a mouse and a keyboard, other computing devices and/or other input devices can also be used. For example, the mouse device can be substituted with other devices that provide the same or similar function and control, such as a pointer device, a track ball or joystick or touchpad or stylus.

While the invention is described primarily for the Windows operating system from Microsoft Corporation, the invention is not limited thereto, and can for example also be used on an Apple Computer with Apple Computer's Macintosh OS, or on a smartphone, or on an eReader, or other devices having an operating system with a graphical user interface.

The present invention discloses several embodiments, which may be listed as follows:
E1) a computer implemented method of overlaying with a vertical line to split the screen, and with a horizontal line which moves or freezes, referred to as the “frozen line”.
   This can be summarized as follows: A computer implemented method for overlaying a graphical image, comprising: a) providing an overlay window; b) providing a vertical line; c) providing a horizontal line located on the left or right side of the vertical line; repeatedly: d) obtaining position information of a mouse cursor; e) testing whether the mouse cursor is located on the vertical line, and if so, continue with step f), otherwise continue with step h); f) configuring the overlay window in non-click-through mode; g) testing if a mouse button is pressed, and if so, dragging the vertical line; and going to step d; h) configuring the overlay window in click-through mode; i) adjusting a position of the horizontal line. The vertical line splits the screen, and can be dragged. The horizontal line moves or freezes, depending on which side the mouse cursor is moving.
E2) a computer implemented method of overlaying with a “perforated bitmap”.
   This can be summarized as follows: A computer implemented method for overlaying a graphical image in a computing device, comprising the steps of: a) providing an overlay window; b) providing at least one visible object in said overlay window, the at least one visible object comprising a bitmap having a first plurality of pixels which are fully transparent pixels, and a second plurality of pixels being opaque pixels or semi-transparent pixels; the first plurality of pixels P6 and the second plurality of pixels being interleaved, for example in a chessboard pattern; c) configuring the overlay window in click-through mode. The object movable in accordance with mouse movements.
E3) a computer implemented method of overlaying with a “large cross”.
   This can be summarized as follows: A computer implemented method for overlaying a graphical image in a computing device, the method comprising the steps of: a) providing an overlay window; b) providing an elongated horizontal visible object; c) providing an elongated vertical visible object in said overlay window; d) configuring the overlay window in click-through mode; repeatedly f) obtaining position information X,Y of a mouse pointer or obtaining movement information dx,dy from the at least one pointer device; repeatedly g) adjusting a position of the first and second visible object based on said obtained position information or using said movement information. The cross may be semi-transparent, and may extend over the entire height and width of the screen. Use of this overlay application as an add-on for spreadsheet applications for highlighting alphanumerical information and/or for extracting information from tables.
E4) a computer implemented method for overlaying with a “texture bitmap”.
E5) a computer implemented method for overlaying in a dynamic manner, taking into account visual aspects (e.g. color and/or brightness) of the underlying applications, referred to as “automatic adjustment”, for example “automatic darkening”.
   This can be summarized as follows: A computer implemented method for overlaying a graphical image in a computing device, the method comprising the steps of: a) providing a semi-transparent overlay window having an alpha-transparency value α in the range from 1% to 99% and comprising a first bitmap; repeatedly performing the following steps: b) taking a screenshot, thereby obtaining a second bitmap; c) determining at least one characteristic of the second bitmap; e) adjusting the alpha-transparency value of the overlay window and/or adjusting one or more pixel values of the first bitmap, based on said at least one determined characteristic. The overlay method may further comprise a vertical bar to define different regions which may be individually adjusted, depending on the image content underneath said regions.
E6) a computer implemented method for overlaying while allowing a screenshot to be taken, which screenshot is compensated for the graphical overlay, referred to as “compensated screenshot”.
   This can be summarized as follows: A computer implemented method for overlaying a graphical image in a computing device, the method comprising the steps of: a) providing a semi-transparent overlay window having an alpha-transparency value α in the range from 1% to 99%, and comprising a first bitmap; b) taking a screenshot, thereby obtaining a second bitmap; c) calculating a third bitmap so as to compensate the effect of the graphical overlay, based on said first bitmap and said second bitmap and said alpha-transparency value α; d) optionally storing the third bitmap in a non-volatile memory or a storage device; e) optionally copying the third bitmap to a clipboard of the operating system.
E7) a computer implemented method of overlaying for substantially “inverting the colors” of the underlying image.
   This can be summarized as follows: A computer implemented method of overlaying a graphical image in a computing device, the method comprising the steps of: a) providing a semi-transparent overlay window comprising a first bitmap with a plurality of semi-transparent pixels and having a transparency level in the range from 5% to 45%; b) configuring the overlay window in click-through mode; Repeatedly performing the following steps: c) taking a screenshot, thereby obtaining a second bitmap; d) updating the pixel values of the first bitmap, such that the color values of the pixels of the bitmap underlying the overlay window are substantially inverted. A computer program product for performing this method. A computer device comprising computer executable instructions for performing this method. A computer system comprising such computer device.
E8) a computer device for performing any of the computer implemented methods E1) to E7).
E9) a computer system comprising a computer device E8).
E10) a computer program product for performing any of the computer implemented methods E1 ) to E7),
E11) a portable device (e.g. eReader) with an overlay with a semi-transparent line.
   This can be summarized as follows: A portable computing device comprising: a touchscreen; at least one processing unit and a first memory for storing computer executable instructions; said instructions being configured for generating a graphical image containing textual information and for showing that graphical image on said touchscreen; said instructions being further configured for generating a line or an elongated object overlaying said textual information; wherein the line or the elongated object contains a plurality of semi-transparent pixels having a transparency-level from 5% to 95%, or wherein the line or elongated object contains a first plurality of fully transparent pixels and a second plurality of opaque or semi-transparent pixels, which are interleaved; said instructions being further configured for sensing a contact position on the touchscreen, and for adjusting a position of the line accordingly. For example an eReader device showing textual information overlaid by a semi-transparent line.
E12) a display device for overlaying with a perforated bitmap,
E13) a display device with a movable object looking semi-transparent by time-multiplexed overlay.

It is furthermore explicitly pointed out that embodiments of the present invention can be combined in any suitable way, for example:
embodiment E2 “perforated bitmap” can be combined with embodiment E5 “automatic darkening” or with E6 “compensated screenshot”;
embodiment E3 “large cross” can be combined with embodiment E5 “automatic darkening” or with embodiment E6 “compensated screenshot”;
embodiment E4 “texture bitmap ” can be combined with embodiment E5 “automatic darkening” or with embodiment E6 “compensated screenshot”;
embodiment E2 “perforated bitmap” or embodiment E4 “texture bitmap” can be combined with embodiment E7 “inverted colors”, for example for different portions of the screen;
   just to name a few.

It is furthermore explicitly pointed out that embodiments of the present invention can be combined with embodiments of the co-pending “dual-mouse application” in any suitable way.

For example, by adding to embodiments of the present invention a second pointer device and the associated features for obtaining “dual mouse support”, as described in said co-pending application. Or for example, by adding to embodiments of the present invention a special hub and/or a special display device and/or a special video adapter.

Some of these combined embodiments may be particularly suitable for translators, or proofreaders, or technical writers, or patent attorneys, or other professional users, spending many hours in front of a computer screen, and often switching back and forth between different documents, because the cognitive burden related to re-acquiring current context after said switching back and forth between documents may be lowered considerably thanks to the multiple visible objects movable by the two (or more) pointer devices, and because eye strain related to a bright background light can also be reduced.

1.-63. (canceled)

64. A computer implemented method for overlaying a graphical image in a computing device having a processor, the method comprising the steps of:
a) the processor providing a semi-transparent overlay window having an alpha-transparency value (α) in the range from 1% to 99%, and comprising a first bitmap (bmp1);
b) the processor taking a screenshot, thereby obtaining a second bitmap (bmp2);
c) the processor calculating a third bitmap (bmp3) for substantially compensating the effect of the graphical overlay, based on said first bitmap (bmp1) and said second bitmap (bmp2) and said alpha-transparency value (α).

65. The computer implemented method according to claim 64, further comprising step d) of:
d) the processor storing the third bitmap (bmp3) to a non-volatile memory or to a storage device.

66. The computer implemented method according to claim 65, wherein the step d) of storing the third bitmap (bmp3) to the non-volatile memory or to the storage device is performed after format conversion and/or after image compression of the third bitmap (bmp3).

67. The computer implemented method according to claim 64, further comprising step e) of:
e) the processor copying the third bitmap (bmp3) to a clipboard of an operating system running on said computing device.

68. The computer implemented method according to claim 64, wherein step c) comprises making use of the following set of formulas, or an equivalent set of formulas:
R3[x,y]=[R2[x,y]−R1[x,y]*(1−T)]/T, and
G3[x,y]=[G2[x,y]−G1[x,y]*(1−T)]/T, and
B3[x,y]=[B2[x,y]−B1[x,y]*(1−T)]/T, and
T=1−α,
wherein (R1,G1,B1) are color components of a pixel at a location (x,y) of the first bitmap (bmp1) being overlaid, and wherein (R2,G2,B2) are color components of a pixel at a location (x,y) of the second bitmap (bmp2) taken as the screenshot, and wherein (R3,G3,B3) are color components of a pixel at a location (x,y) of the third bitmap (bmp3), and wherein a is the alpha-transparency value, and T is a transparency value.

69. A computer device, comprising:
at least one central processing unit (CPU), and a first memory connected to the at least one central processing unit (CPU) for storing computer executable instructions therein;
the computer executable instructions comprising code fragments for performing an overlay method according to claim 64.

70. The computer device according to claim 69, further comprising a graphics processing unit (GPU) with alpha blending capabilities, and a second memory connected to the graphics processing unit (GPU) for storing graphical information therein.

71. The computer device according to claim 70, wherein the overlay code fragments are configured for making use of the graphical processor (GPU) for performing at least alpha-blending and/or time-multiplexing.

72. A computer system comprising:
a computer device according to claim 69;
at least one pointer device connected to the computer device, the pointer device being movable by a user, the computer executable instructions being further configured for receiving input data indicative of movements of the pointer device;
at least one display device connected to an output the computer device, for displaying the graphical image mixed with the overlay image.

73. A computer program product for providing a graphical overlay, the computer program product containing executable instructions for performing a method according to claim 64 when being executed on at least one central processing unit (CPU) of a computer device.
